(19) United States
(12) Patent Application Publication
(10) Pub. No.: US 2025/0254766 A1
(43) Pub. Date: Aug. 7, 2025

(54) Interlocking Device for Microwave Oven, Microwave Oven, and Household Appliance

(71) Applicants: Guangdong Midea Kitchen Appliances Manufacturing Co., Ltd., Foshan (CN); Midea Group Co., Ltd., Foshan (CN)

(72) Inventor: Shuaishuai WEI, Foshan (CN)

(21) Appl. No.: 19/178,664

(22) Filed: Apr. 14, 2025

Related U.S. Application Data
(63) Continuation of application No. PCT/CN2023/097844, filed on Jun. 1, 2023.

(30) Foreign Application Priority Data
Jun. 1, 2022 (CN) 202210623213.4
Jun. 1, 2022 (CN) 202221378727.X
Jun. 1, 2022 (CN) 202221380636.X

(51) Int. Cl. H05B 6/64

(52) U.S. Cl. CPC H05B 6/6417

(57) ABSTRACT

An interlocking device for a microwave oven includes a first door hook, an interlocking bracket provided with a plurality of switch components, a first lever mounted at the interlocking bracket and rotatable to trigger at least one of the plurality of switch components, a second lever mounted at the interlocking bracket and located at a rear side of the first lever in a door-closing direction, and a shielding component provided at a avoidance gap formed between the first lever and the interlocking bracket. The shielding component is movable between a first position where the avoidance gap is shielded by the shielding component and a second position where the avoidance gap is exposed. The second lever is rotatable to trigger at least one of the plurality of switch components. The shielding component is positioned at the first position when a door is opened.

### CROSS-REFERENCE TO RELATED APPLICATIONS

This application is a continuation application of International Application No. PCT/CN2023/097844, filed on Jun. 1, 2023, which claims priority of Chinese Patent Application Nos. 202210623213.4, 202221378727.X, and 202221380636.X, filed on Jun. 1, 2022, the entire disclosures of which are incorporated herein by reference.

### FIELD

The present disclosure relates to the field of microwave oven technologies, and more particularly, to an interlocking device for a microwave oven, a microwave oven, and a household appliance.

### BACKGROUND

In some related arts, a micro switch is triggered by rotating a lever. However, there is a risk of the lever being driven to rotate and being inadvertently triggered by foreign objects such as fingers or thin rods, and there is also a risk of a disorder in a micro switch triggering sequence.

### SUMMARY

Embodiments of the present disclosure provide an interlocking device for a microwave oven. The interlocking device can effectively prevent a second lever from being inadvertently triggered by foreign objects such as fingers, reduce a risk of safety hazards such as electric shock, and achieve orderly triggering of a corresponding switch component.

Embodiments of the present disclosure provide an interlocking device for a microwave oven. The interlocking device can restore its normal door-closing state without dismantling and overhauling the entire machine when a first lever is abnormally triggered. The operation is very convenient, which improves user experience.

Embodiments of the present disclosure provide a microwave oven with the above interlocking device.

Embodiments of the present disclosure provide a household appliance.

An interlocking device for a microwave oven according to embodiments of the present disclosure includes a first door hook, an interlocking bracket, a first lever, a second lever, and a shielding component. The interlocking bracket is provided with a plurality of switch components. The first lever is mounted at the interlocking bracket. An avoidance gap is formed between the first lever and the interlocking bracket. The first lever is rotatable to trigger at least one of the plurality of switch components. The second lever is mounted at the interlocking bracket and located at a rear side of the first lever in a door-closing direction. The second lever is rotatable to trigger at least one of the plurality of switch components. The shielding component is provided at the avoidance gap. The shielding component is movable between a first position where the avoidance gap is shielded by the shielding component and a second position where the avoidance gap is exposed. The shielding component is positioned at the first position when a door is opened; and the shielding component is adapted to move to the second position during a movement of the first door hook in the door-closing direction, allowing the first door hook to sequentially drive the first lever and the second lever to rotate.

In the interlocking device for the microwave oven according to the embodiments of the present disclosure, by providing the shielding component, the shielding component is movable between the first position where the avoidance gap is shielded by the shielding component and the second position where the avoidance gap is exposed. Moreover, the shielding component is positioned at the first position when the door is opened, and therefore the foreign objects such as the fingers cannot inadvertently trigger the second lever through the avoidance gap. Thus, the risk of electric shock and microwave leakage caused by operation of the microwave oven when the door is opened. In this way, safety of using the microwave oven is improved. During the closing of the door, the shielding component moves to the second position, at which time the first door hook can drive the second lever to rotate through the avoidance gap. Further, since the second lever is located at the rear side of the first lever, the corresponding switch components can be triggered in an orderly manner to avoid a disorder of a triggering sequence. In this way, service life of the microwave oven is improved.

In addition, the interlocking device for the microwave oven according to the above-described embodiments of the present disclosure may further have the following additional technical features.

According to some embodiments of the present disclosure, the interlocking bracket has a first guide groove. The first guide groove at least partially extends away from the second lever in the door-closing direction. The shielding component includes a shielding block and a guide block. The shielding block is configured to shield the avoidance gap. The guide block is connected to the shielding block and movably disposed in the first guide groove.

According to some embodiments of the present disclosure, the first lever has a second guide groove. The shielding block is movably disposed in the second guide groove. The first door hook is adapted to abut against at least one of the first lever and the shielding block to drive the first lever to rotate and the shielding component to move towards the second position.

According to some embodiments of the present disclosure, the first guide groove includes a first horizontal groove section, a second horizontal groove section, and an inclined groove section connecting the first horizontal groove section and the second horizontal groove section. The first horizontal groove section is located at a side of the second horizontal groove section close to the second lever. The guide block is positioned in the first horizontal groove section when the door is opened; and the guide block is positioned in the second horizontal groove section when the door is closed.

According to some embodiments of the present disclosure, the first lever includes a first drive arm and a second drive arm. The second drive arm is located at a side of the first drive arm facing away from the second lever in the door-closing direction; the first door hook is adapted to abut against the first drive arm to drive the first lever to rotate, and the avoidance gap is formed between the first drive arm and the interlocking bracket.

According to some embodiments of the present disclosure, the shielding component is movably disposed at the first drive arm in a length direction of the first drive arm.

According to some embodiments of the present disclosure, a predetermined gap is formed between the second drive arm and the interlocking bracket in a state where the at least one switch component is triggered by the first lever, allowing the first door hook to move to a position between the first drive arm and the second drive arm through the predetermined gap.

According to some embodiments of the present disclosure, the second lever includes a first cooperation portion and at least one second cooperation portion. The first door hook is adapted to abut against the first cooperation portion to drive the second lever to rotate. The at least one second cooperation portion is configured to trigger at least one of the plurality of switch components. In the door-closing direction, the second cooperation portion is positioned at a side of the first cooperation portion facing away from the first lever, and the shielding component is positioned at a side of the first cooperation portion close to the first lever.

According to some embodiments of the present disclosure, the second lever further includes a first rotary arm provided with the first cooperation portion and a second rotary arm provided with the second cooperation portion. The interlocking bracket has a mounting space. An avoidance recess is formed at a side wall of the mounting space. The first rotary arm is located in the avoidance recess. The first cooperation portion extends into the mounting space. The first door hook is adapted to extend into the mounting space.

According to some embodiments of the present disclosure, the interlocking bracket includes a first baffle partially blocking a communication opening between the avoidance recess and the mounting space.

According to some embodiments of the present disclosure, the interlocking bracket has a mounting space. The second rotary arm is located in the mounting space. A second baffle is disposed in the mounting space. At least part of the second baffle extends in the door-closing direction and is located between a rotary shaft of the second lever and the first door hook.

According to some embodiments of the present disclosure, the interlocking bracket has a mounting space. The second rotary arm is located in the mounting space. A third baffle is disposed in the mounting space and located at a side of the second rotary arm close to the first door hook.

An interlocking device according to embodiments of the present disclosure includes a first door hook, an interlocking bracket, and a first lever. The interlocking bracket is provided with a switch component. The first lever is rotatably mounted at the interlocking bracket and configured to trigger the switch component by rotating about a rotation axis of the first lever in a first direction. The first lever includes a first drive arm and a second drive arm that are arranged in an opposite direction to the first direction. A predetermined gap is formed between the second drive arm and the interlocking bracket in a state where the at least one switch component is triggered by the first lever, allowing the first door hook to move to a position between the first drive arm and the second drive arm through the predetermined gap.

In the interlocking device according to the embodiments of the present disclosure, the predetermined gap is formed between the second drive arm and the interlocking bracket when the switch component is triggered by the first lever. Therefore, the first door hook can move to the position between the first drive arm and the second drive arm through the predetermined gap when the first lever is abnormally triggered, allowing the microwave oven to restore its normal door-closing state, without dismantling and overhauling the entire machine. In this way, use cost can be effectively reduced. Moreover, the first door hook can drive the first lever to rotate and reset in the opposite direction to the first direction through the door opening action again, and therefore it is convenient to open and close the door smoothly and repeatedly afterwards. The whole process is very convenient, which greatly improves the user experience.

In addition, the interlocking device according to the above-described embodiments of the present disclosure may further have the following additional technical features.

According to some embodiments of the present disclosure, the interlocking bracket has a mounting space. The first drive arm and the second drive arm are located in the mounting space. The predetermined gap is formed between at least one side of the second drive arm along the rotation axis of the first lever and an inner wall of the mounting space.

According to some embodiments of the present disclosure, in the rotation axis direction of the first lever, the second drive arm has a thinned region on at least one side surface of the second drive arm. The predetermined gap is formed between the thinned region and the inner wall of the mounting space.

According to some embodiments of the present disclosure, the thinned region has an inclined surface facing towards the inner wall of the mounting space. The inclined surface extends towards the inner wall of the mounting space in a door-closing movement direction of the first door hook.

According to some embodiments of the present disclosure, an end of the first door hook has a thickness gradually decreasing in the door-closing movement direction of the first door hook.

According to some embodiments of the present disclosure, the first door hook has an inclined side surface facing towards the second drive arm in a thickness direction of the first door hook. The inclined side surface extends away from the second drive arm in the door-closing movement direction of the first door hook.

According to some embodiments of the present disclosure, at least one of the first door hook and the second drive arm is made of plastic.

According to some embodiments of the present disclosure, the switch component includes a first micro switch, a second micro switch, and a monitoring switch; and the interlocking device further includes a second lever rotatably mounted at the interlocking bracket. The second lever includes a first rotary arm provided with a first cooperation portion and a second rotary arm provided with a second cooperation portion and a third cooperation portion. The first rotary arm and the second rotary arm are sequentially arranged around a rotation axis of the second lever in a second direction. The first door hook is adapted to move in a door-closing direction to abut against the first drive arm to drive the first lever to rotate in the first direction and trigger the monitoring switch, and then abut against the first cooperation portion and drive the second lever to rotate in the second direction, allowing the third cooperation portion to trigger the second micro switch after the first micro switch is triggered by the second cooperation portion.

According to some embodiments of the present disclosure, the interlocking bracket has a mounting space. An avoidance recess is formed at a side wall of the mounting space. The first rotary arm is located in the avoidance recess. The first cooperation portion extends into the mounting space. The first door hook is adapted to extend into the mounting space.

According to some embodiments of the present disclosure, the interlocking bracket includes a first baffle partially blocking a communication opening between the avoidance recess and the mounting space.

According to some embodiments of the present disclosure, the interlocking bracket has a mounting space. The second rotary arm is located in the mounting space. A second baffle is disposed in the mounting space. At least part of the second baffle extends in the door-closing direction and is located between a rotary shaft of the second lever and the first door hook.

According to some embodiments of the present disclosure, the interlocking bracket has a mounting space. The second rotary arm is located in the mounting space. A third baffle is disposed in the mounting space and located at a side of the second rotary arm close to the first door hook.

According to some embodiments of the present disclosure, an angle of the first cooperation portion and the second cooperation portion relative to the rotation axis of the second lever is a; and an angle of the second cooperation portion and the third cooperation portion relative to the rotation axis of the second lever is β, in which α>β.

According to some embodiments of the present disclosure, a spacing between the first cooperation portion and the rotation axis of the second lever is smaller than a spacing between the second cooperation portion and the rotation axis of the second lever and smaller than a spacing between the third cooperation portion and the rotation axis of the second lever.

A microwave oven according to embodiments of the present disclosure includes a body, a door mounted at the body, and the interlocking device according to the embodiments of the present disclosure. The first door hook is mounted at the door; and the interlocking bracket is mounted at the body.

A household appliance according to embodiments of the present disclosure includes a door, an interlocking bracket, and a damping assembly. The door has a door hook. The door hook has a first inclined guide surface at a tip of the door hook. The door is movably connected to the interlocking bracket. The damping assembly is mounted at the interlocking bracket. The damping assembly includes a damper and a drive lever. The drive lever is rotatably connected to the interlocking bracket and the damper and includes a latching arm. The latching arm has a second inclined guide surface at a side surface of the latching arm. The first inclined guide surface is cooperatively connected to the second inclined guide surface during closing of the door, allowing the latching arm to be latched to the door hook after the tip of the door hook bypasses the latching arm.

In the above-described household appliance, the first inclined guide surface is cooperatively connected to the second inclined guide surface during the closing of the door, allowing the latching arm to be latched to the door hook after the tip of the door hook bypasses the latching arm. In this way, a forced door-closing structure design is realized. When the drive lever is abnormally triggered, it is not necessary to disassemble the machine for maintenance, and users can manually force the door closed to restore the normal operation of the household appliance.

In some embodiments, the first inclined guide surface is parallel to the second inclined guide surface.

In some embodiments, the side surface of the latching arm having the second inclined guide surface faces towards the interlocking bracket.

In some embodiments, the door hook has a depression. A part of the latching arm is located in the depression when the latching arm is latched to the door hook.

In some embodiments, the interlocking bracket has an interlocking bracket groove. A position of the interlocking bracket groove corresponds to a position of the second inclined guide surface.

In some embodiments, the drive lever further includes a trigger arm spaced apart from the latching arm, a micro switch is mounted at the interlocking bracket, and the micro switch is triggered by the trigger arm when the door is closed in place.

In some embodiments, the trigger arm has a receiving groove. The receiving groove has a rotation space formed at a top of the receiving groove and a swing space formed at a bottom of the receiving groove; and the damping assembly includes a swing block. The swing block has an end rotatably received in the rotation space and another end received in the swing space. The swing space is configured to provide a space for rotation of the drive lever. The damper is rotatably connected to the swing block.

In some embodiments, the damping assembly includes an elastic component. The elastic component and the drive lever are respectively located at two opposite sides of the interlocking bracket. The interlocking bracket has a through hole. The drive lever is connected to the elastic component through the through hole. The elastic component is configured to drive the drive lever to accelerate rotation of the drive lever to allow the drive lever to drive the door to accelerate.

In some embodiments, the elastic component includes a first elastic member and a second elastic member, and the drive lever is provided with a connection portion. Each of the first elastic member and the second elastic member is connected to the connection portion. An acute angle is formed between the first elastic member and the second elastic member.

In some embodiments, the door hook includes a second door hook and a first door hook. The first door hook has the first inclined guide surface at a tip of the first door hook. The household appliance includes an inclined block and a third elastic member that are mounted at the interlocking bracket. The third elastic member abuts against a bottom of the inclined block. The inclined block has a third inclined guide surface at a top of the inclined block. The third inclined guide surface is inclined upwards towards an interior of the interlocking bracket along a vertical plane. A tip of the second door hook abuts against the third inclined guide surface during the closing of the door to allow the inclined block to descend and compress the third elastic member. The inclined block is latched to the second door hook under an action of the third elastic member when the tip of the second door hook extends across the third inclined guide surface.

Additional aspects and advantages of the embodiments of present disclosure will be provided at least in part in the following description, or will become apparent in part from the following description, or can be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings.

FIGS. 1 and 2 are schematic partial structural views of a microwave oven according to some embodiments of the present disclosure, in which a door is opened.

FIG. 3 is a schematic partial structural view of a microwave oven according to some embodiments of the present disclosure, in which a door is opened.

FIGS. 4 and 5 are schematic partial structural views of a microwave oven according to some embodiments of the present disclosure, in which a guide block moves to an inclined groove section.

FIGS. 6 and 7 are schematic partial structural views of a microwave oven according to some embodiments of the present disclosure, in which a door is closed.

FIG. 8 is a schematic partial structural view of FIG. 6, in which a cover is not shown.

FIG. 9 is a schematic partial structural view of a microwave oven according to some embodiments of the present disclosure, in which a door is closed.

FIG. 10 is a partial structural right view of a microwave oven according to some embodiments of the present disclosure, in which a drive lever is abnormally triggered.

FIGS. 11 to 13 are schematic partial structural views of a bracket body, a first lever, a connector, a buffer, an elastic component, and a shielding component according to some embodiments of the present disclosure.

FIGS. 14 and 15 are schematic structural views of a second lever and a bracket body according to some embodiments of the present disclosure.

FIGS. 16 and 17 are schematic structural views of an inclined block, a driver, and a bracket body according to some embodiments of the present disclosure.

FIGS. 18 and 19 are schematic structural views of a door, a first door hook, and a second door hook according to some embodiments of the present disclosure.

FIG. 20 is a schematic structural view of a first lever, a connector, and a shielding component cooperating with each other according to some embodiments of the present disclosure.

FIGS. 21 to 24 are schematic structural views of a first lever according to some embodiments of the present disclosure.

FIGS. 25 and 26 are schematic structural views of a shielding component according to some embodiments of the present disclosure.

FIGS. 27 to 29 are schematic structural views of a second lever according to some embodiments of the present disclosure.

FIGS. 30 and 31 are schematic structural views of a bracket body according to some embodiments of the present disclosure.

FIGS. 32 and 33 are schematic structural views of a cover according to some embodiments of the present disclosure.

FIGS. 34 and 35 are schematic structural views of a connector according to some embodiments of the present disclosure.

FIGS. 36 and 37 are schematic structural views of a first door hook and a second door hook according to some embodiments of the present disclosure.

FIG. 38 is a schematic structural view of an inclined block according to some embodiments of the present disclosure.

FIG. 39 is a schematic partial structural view of a microwave oven according to some embodiments of the present disclosure, in which a door is opened and a cover is not shown.

FIG. 40 is a partial structural left view of a microwave oven according to some embodiments of the present disclosure, in which a door is opened.

FIG. 41 is a schematic partial structural view of a microwave oven according to some embodiments of the present disclosure, in which a door is opened.

FIG. 42 is a partial structural right view of a microwave oven according to some embodiments of the present disclosure, in which a first door hook is just in contact with a first lever.

FIG. 43 is a schematic enlarged structural view of part A in FIG. 42.

FIG. 44 is a partial structural right view of a microwave oven according to some embodiments of the present disclosure, in which a connector is in contact with a drive surface.

FIG. 45 is a schematic enlarged structural view of part B in FIG. 44.

FIG. 46 is a partial structural right view of a microwave oven according to some embodiments of the present disclosure, in which a first door hook is just in contact with a first cooperation portion.

FIG. 47 is a schematic enlarged structural view of part C in FIG. 46.

FIG. 48 is a schematic partial structural view of a microwave oven according to some embodiments of the present disclosure, in which a door is closed and a cover is shown

FIG. 49 is a schematic enlarged structural view of part D in FIG. 48.

FIG. 50 is a partial structural left view of a microwave oven according to some embodiments of the present disclosure, in which a door is closed.

FIG. 51 is a schematic partial structural view of a microwave oven according to some embodiments of the present disclosure, in which a first door hook moves in a door opening direction.

FIG. 52 is a partial structural right view of a microwave oven according to some embodiments of the present disclosure, in which a first lever is abnormally triggered.

FIGS. 53 to 55 are schematic structural views of a bracket body, a second lever, a connector, a buffer, and an elastic component according to some embodiments of the present disclosure.

FIGS. 56 and 57 are schematic structural views of a driver, an inclined block, and a bracket body according to some embodiments of the present disclosure.

FIGS. 58 and 59 are schematic structural views of a second lever and a bracket body according to some embodiments of the present disclosure.

FIGS. 60 and 61 are schematic structural views of a connector according to some embodiments of the present disclosure.

FIGS. 62 to 64 are schematic structural views of a second lever according to some embodiments of the present disclosure.

FIGS. 65 to 67 are schematic structural views of a first lever according to the present disclosure.

FIG. 68 is a cross-sectional view taken along line E-E in FIG. 67.

FIGS. 69 and 70 are schematic structural views of a bracket body according to some embodiments of the present disclosure.

FIG. 71 is a cross-sectional view taken along line F-F in FIG. 70.

FIGS. 72 and 73 are schematic structural views of a cover according to some embodiments of the present disclosure.

FIG. 74 is a partial structural right view of a microwave oven according to some embodiments of the present disclosure.

FIG. 75 is a cross-sectional view taken along line G-G in FIG. 74.

FIG. 76 is a cross-sectional view taken along line H-H in FIG. 74.

FIG. 77 is a rear view of a first lever according to the present disclosure.

FIGS. 78 to 80 are schematic partial structural views of a household appliance according to some embodiments of the present disclosure.

FIG. 81 is a schematic enlarged view of part IV in FIG. 80.

FIGS. 82 and 83 are schematic partial structural views of a household appliance according to some embodiments of the present disclosure.

FIGS. 84 and 85 are schematic structural views of a drive lever according to some embodiments of the present disclosure.

FIG. 86 is a cross-sectional view taken along A-A in FIG. 85.

FIG. 87 is a schematic partial structural view of a door according to some embodiments of the present disclosure.

FIG. 88 is a cross-sectional view taken along B-B in FIG. 87.

FIG. 89 is a schematic partial structural view of a household appliance according to some embodiments of the present disclosure.

FIG. 90 is a cross-sectional view taken along C-C in FIG. 89

FIG. 91 is a cross-sectional view taken along D-D in FIG. 89.

FIGS. 92 and 93 are schematic structural views of an interlocking bracket according to some embodiments of the present disclosure.

FIG. 94 is a schematic partial structural view of a household appliance according to some embodiments of the present disclosure.

Reference numerals: microwave oven 1000; interlocking device 100; door 200; first door hook 11; second door hook 12; interlocking bracket 20; monitoring switch 201; first micro switch 202; second micro switch 203; mounting space 204; avoidance recess 205; first limit portion 21; bracket body 22; third through hole 221; cover 23; first through hole 231; second through hole 232; second limit portion 24; first baffle 25; second baffle 26; third baffle 27; first lever 30; first drive arm 31; second drive arm 32; fourth cooperation portion 33; elastic component 34; connection portion 35; drive surface 36; recess 37; hook 38; thinned region 39; second lever 40; first rotary arm 41; first cooperation portion 45; second rotary arm 42; second cooperation portion 44; third cooperation portion 46; door-closing buffer assembly 50; buffer 51; connector 52; avoidance notch 521; driver 53; inclined block 54; predetermined gap 55; first inclined surface 56; second inclined side surface 57; avoidance gap 61; shielding component 62; shielding block 621; guide block 622; first guide groove 63; first horizontal groove section 631; second horizontal groove section 632; inclined groove section 633; second guide groove 64; household appliance 100a; door hook 11a; first inclined guide surface 111a; depression 101a; bracket groove 201a; micro switch 21a; monitoring switch 22a; secondary switch 23a; damping assembly 30a; damper 31a; drive lever 32a; latch arm 321a; second inclined guide surface 322a; trigger arm 323a; receiving groove 324a; rotation space 325a; swing space 326a; connection structure 327a; swing block 33a; first elastic member 41a; second elastic member 42a; third elastic member 43a; inclined block 50a; third inclined guide surface 51a.

### DETAILED DESCRIPTION OF THE EMBODIMENTS

The embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the accompanying drawings are illustrative only, and are intended to explain rather than limiting the present disclosure.

In the description of the present disclosure, it is to be understood that, terms such as “center,” “longitudinal,” “lateral,” “length,” “width,” “thickness,” “over,” “below,” “front,” “back,” “left,” “right,” “vertical,” “horizontal,” “top,” “bottom,” “in,” “out,” “clockwise,” “counterclockwise,” “axial,” “radial,” “circumferential,” etc., is based on the orientation or position relationship shown in the accompany drawings, and is only for the convenience of describing the present disclosure and simplifying the description, rather than indicating or implying that the associated device or element must have a specific orientation, or be constructed and operated in a specific orientation, and therefore cannot be understood as a limitation on the present disclosure.

In the description of the present disclosure, “first characteristic” and “second characteristic” may include one or more of these characteristics; “plurality of” means two or more than two; a first characteristic “on” or “under” a second characteristic refers to the first characteristic and the second characteristic may be direct or via their another characteristic indirect mountings, connections, and couplings; and the first characteristic “on”, “above”, “over” the second characteristic may refer to the first characteristic is right over the second characteristic or is diagonal above the second characteristic, or just refer to the horizontal height of the first characteristic is higher than the horizontal height of the second characteristic.

An interlocking device 100 for a microwave oven 1000 and a microwave oven 1000 having the interlocking device 100 according to embodiments of the present disclosure will be described below with reference to the accompanying drawings.

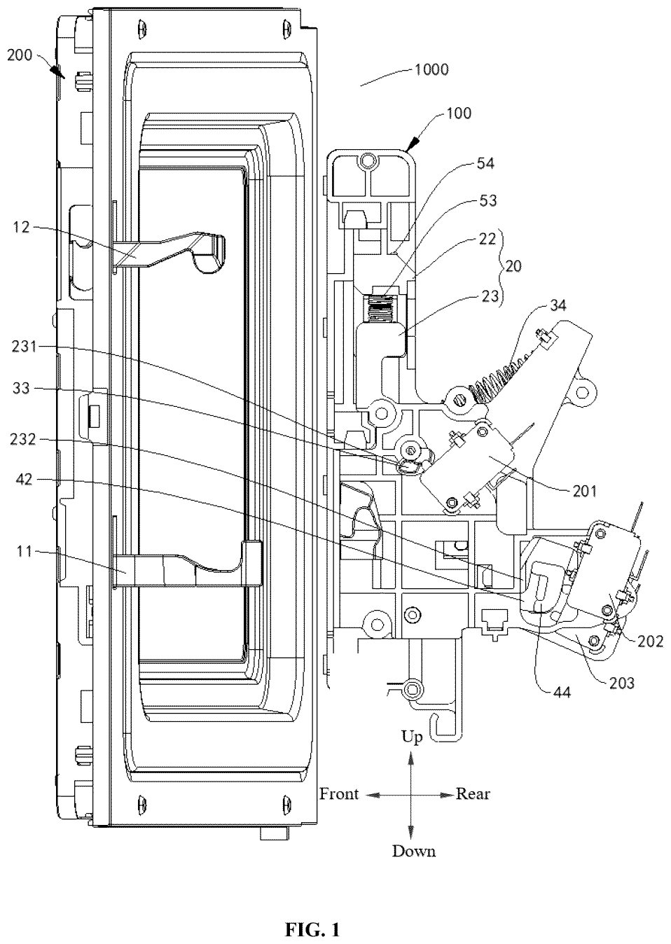

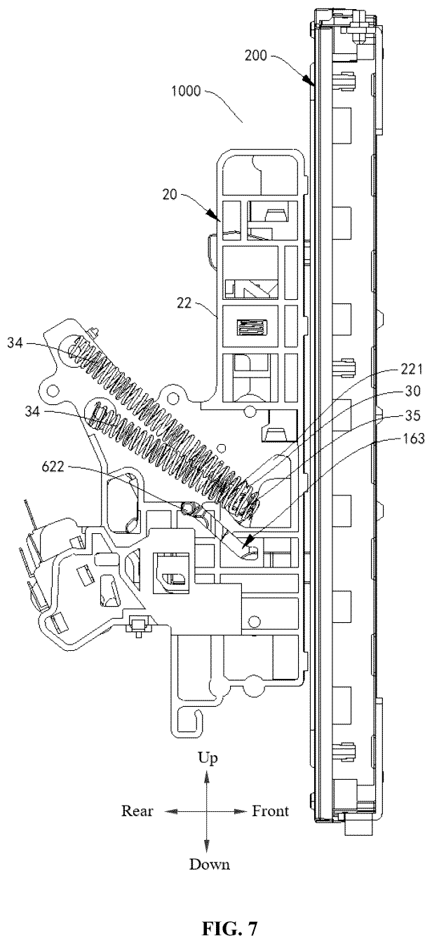

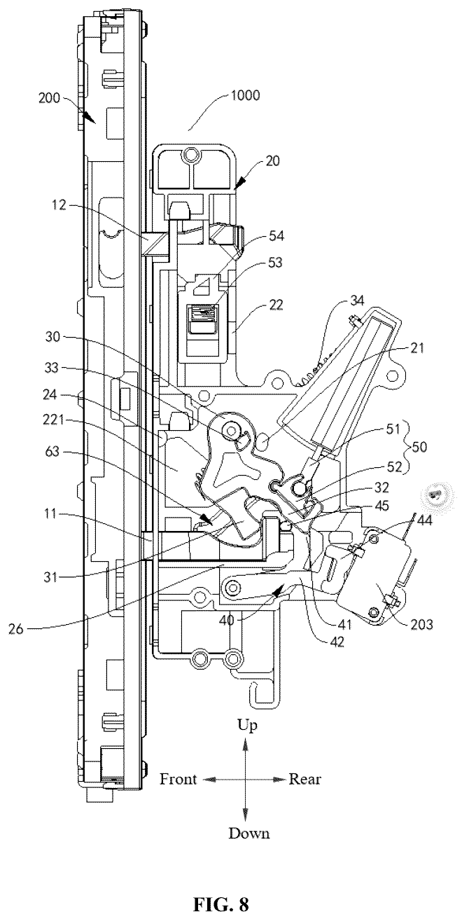

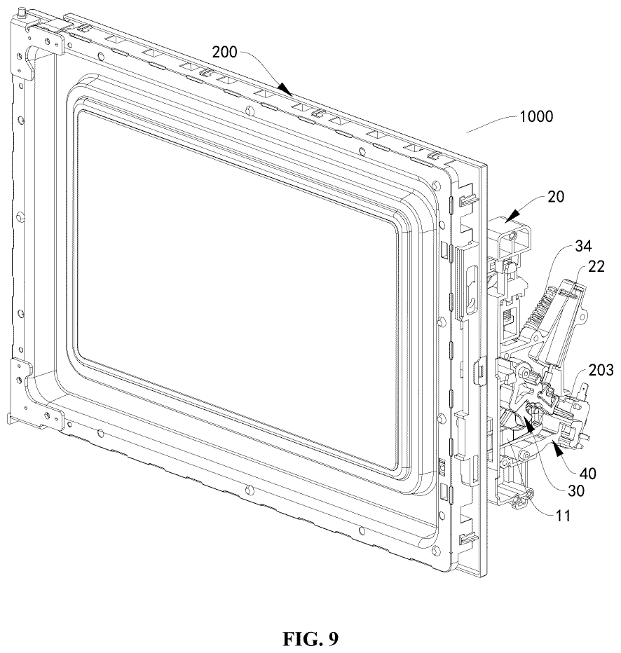

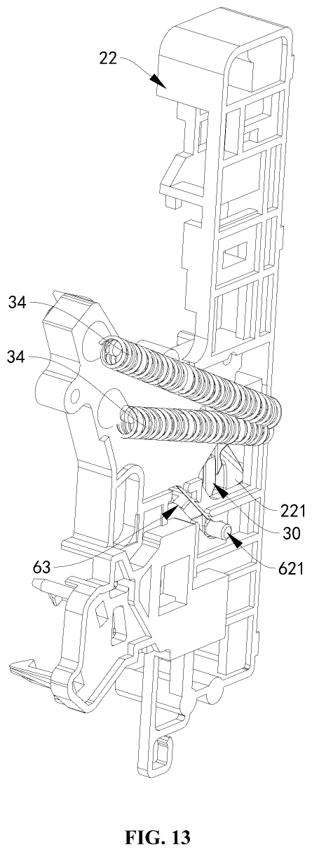

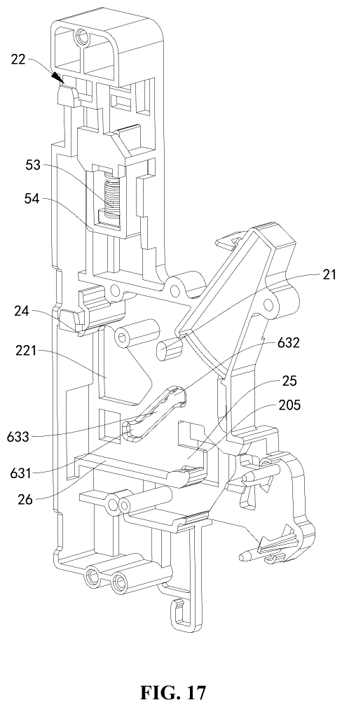

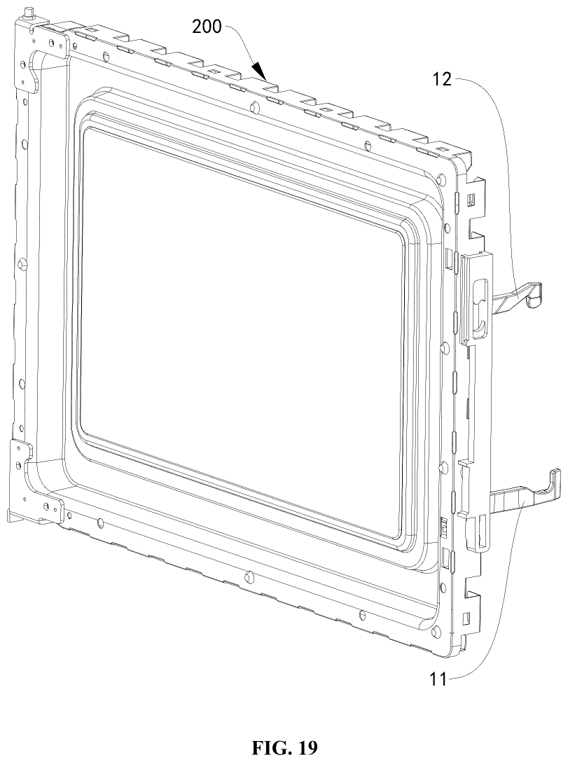

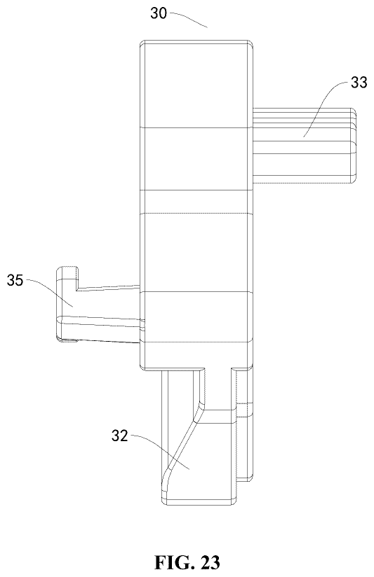

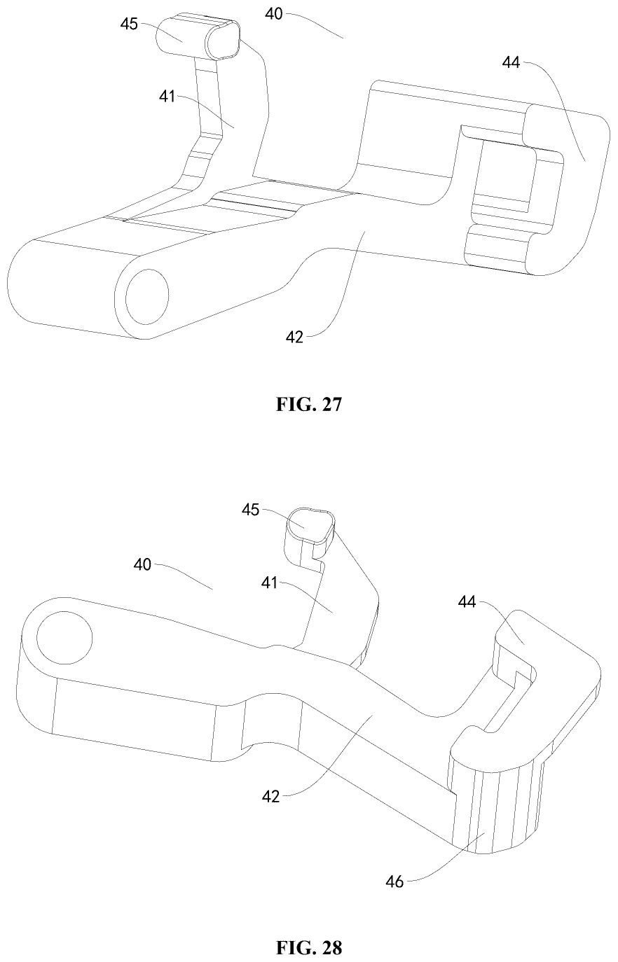

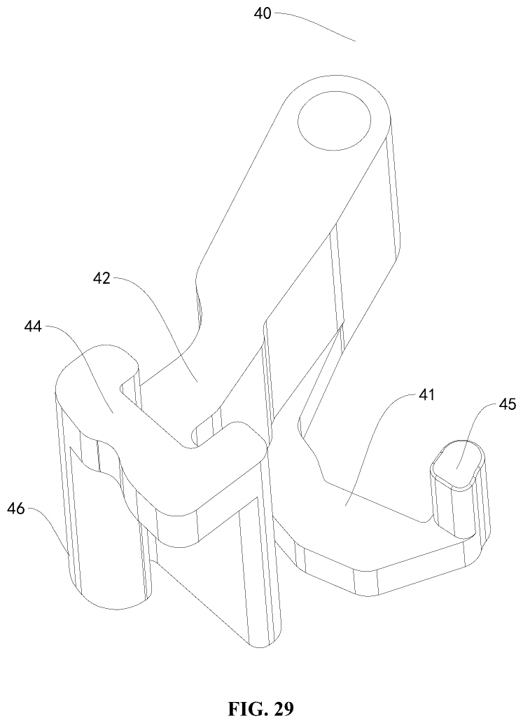

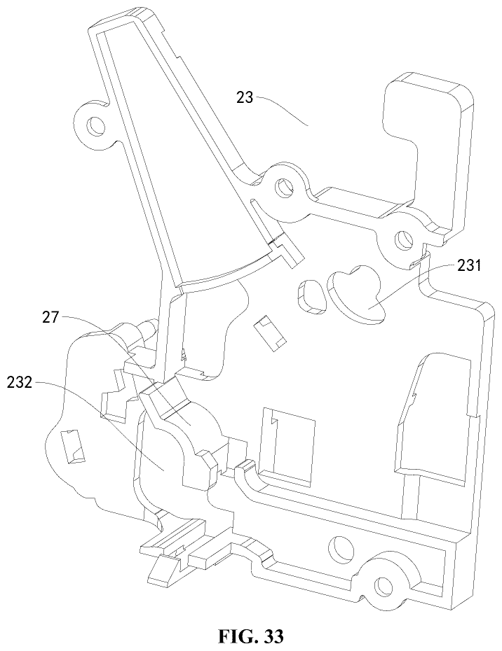

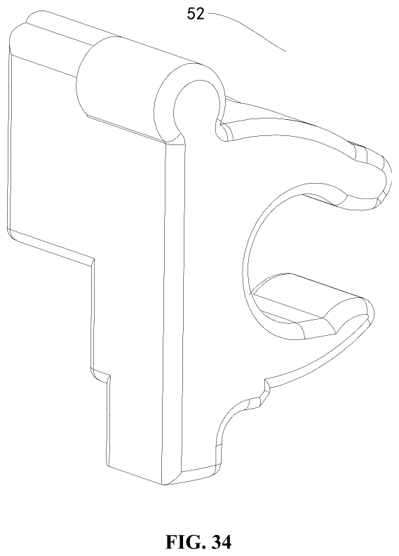

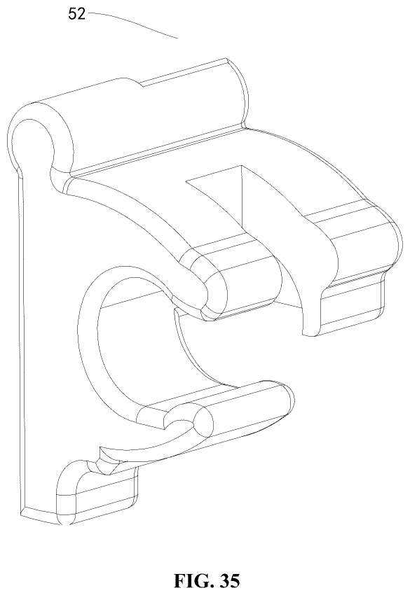

Referring to FIGS. 1 to 38, a microwave oven 1000 according to embodiments of the present disclosure may include a body, a door 200, and the interlocking device 100 for the microwave oven 1000 according to the embodiments of the present disclosure. The door 200 is mounted at the body, for example, which is rotatably mounted at the body, to realize opening and closing of a containing chamber of the body, and to realize switching of the door 200 between an opened state and a closed state. The interlocking device 100 can realize a corresponding function based on the state switching of the door 200.

The interlocking device 100 for the microwave oven 1000 according to the embodiments of the present disclosure may include a first door hook 11, an interlocking bracket 20, a first lever 30, and a second lever 40.

In some embodiments of the present disclosure, as shown in FIGS. 1, 8, 9, 36, and 37, the first door hook 11 may be mounted at the door 200 to move relative to a body as the door 200 is opened and closed. The interlocking bracket 20 is mounted at the body, and therefore the first door hook 11 can cooperate with the interlocking bracket 20 and the components at the interlocking bracket 20 during a movement of the first door hook 11 relative to the body.

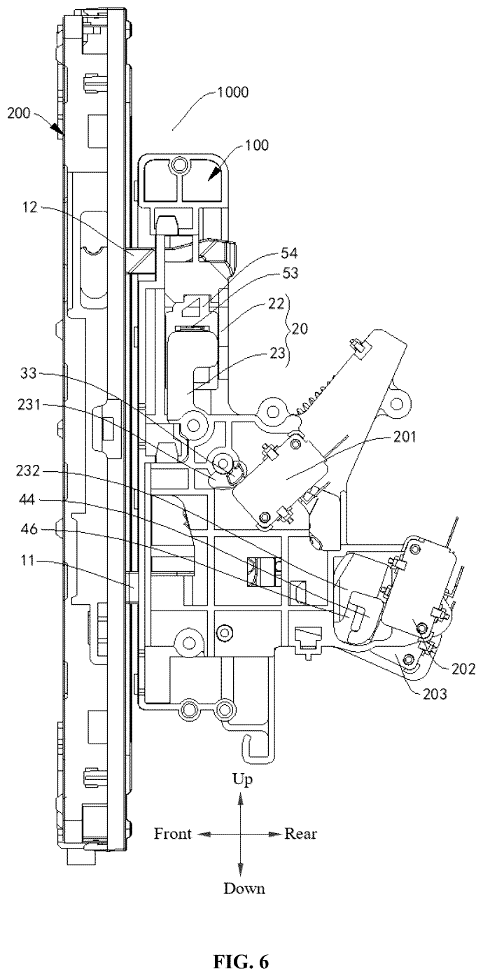

In some embodiments of the present disclosure, as shown in FIGS. 1 and 6, the interlocking bracket 20 may be provided with a plurality of switch components. For example, the interlocking bracket may be provided with three switch components, including a monitoring switch 201, a first micro switch 202, and a second micro switch 203. The monitoring switch 201, the first micro switch 202, and the second micro switch 203 may be sequentially triggered to ensure that the microwave oven 1000 can be powered on and operate normally.

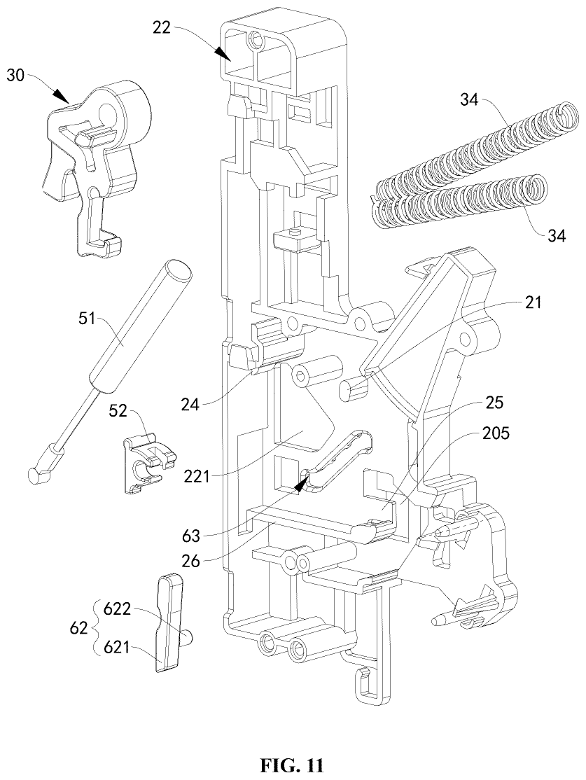

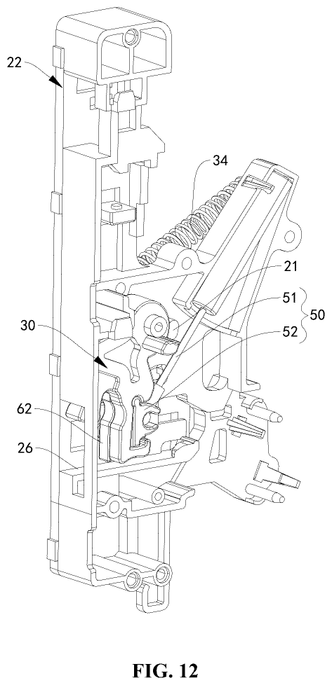

In some embodiments of the present disclosure, as shown in FIGS. 11 and 12, the first lever 30 may be mounted at the interlocking bracket 20, and the first lever 30 is rotatable to trigger at least one switch component. For example, the first lever 30 may trigger the monitoring switch 201 by rotating. Moreover, as shown in FIGS. 12 and 24, an avoidance gap 61 is formed between the first lever 30 and the interlocking bracket 20. For example, in some embodiments, a thinned region may be formed at a side of the first lever 30, and therefore the avoidance gap 61 is formed at the thinned region when the first lever 30 is mounted at the interlocking bracket 20. The first door hook 11 is movable and passes through the avoidance gap 61 during closing of the door, to drive the second lever 40.

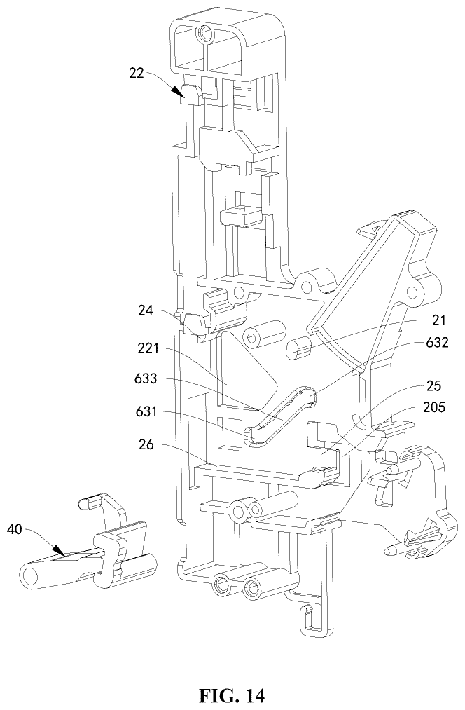

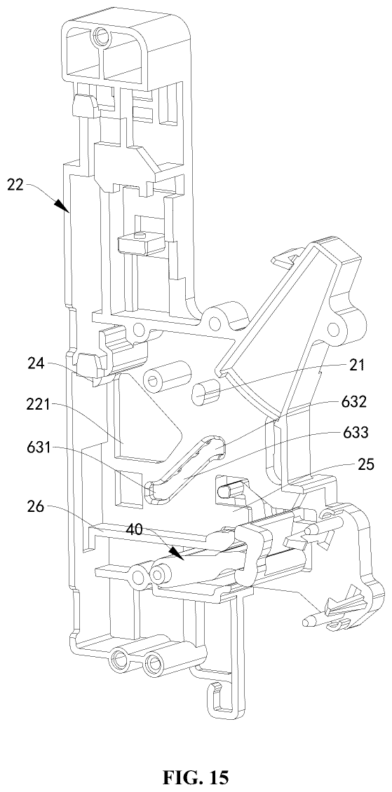

In some embodiments of the present disclosure, as shown in FIGS. 14 and 15, the second lever 40 may be mounted at the interlocking bracket 20 and located at a rear side of the first lever 30 in a door-closing direction. Therefore, the first door hook 11 may be first in contact with the first lever 30 when moving in the door-closing direction to drive the first lever 30 to rotate, and thus to trigger the monitoring switch 201. Then, the first door hook 11 continues to move in the door-closing direction and passes through the avoidance gap 61 to be in contact with the second lever 40 to drive the second lever 40 to rotate. The second lever 40 is rotatable to trigger at least one switch component. For example, the second lever 40 can sequentially trigger the first micro switch 202 and the second micro switch 203 by rotating to ensure orderliness of triggering the switch components, and closing of the door 200 can be jointly confirmed by the closing of the monitoring switch 201, the first micro switch 202, and the second micro switch 203. Thus, reliability of confirming the closing of the door 200 is improved.

In some related arts, a micro switch is triggered by rotating a lever, but there is a risk of the lever being driven to rotate and being inadvertently triggered by foreign objects such as fingers or thin rods, and there is also a risk of a disorder in a micro switch triggering sequence.

In the present disclosure, a shielding component 62 is further included. As shown in FIGS. 12, 25, and 26, the shielding component 62 may be disposed at the avoidance gap 61 and movable between a first position where the avoidance gap 61 is shielded by the shielding component 62 and a second position where the avoidance gap 61 is exposed. That is, the avoidance gap 61 can be shielded or exposed, and it is possible to switch between the two states with the movement of the first door hook 11. In some embodiments of the present disclosure, the shielding component 62 is positioned at the first position when a door is opened. In this case, the shielding component 62 can shield the avoidance gap 61, which can effectively prevent the foreign objects such as the fingers from inadvertently triggering the second lever 40 and causing a safety hazard, such as electric shock or microwave leakage. During the movement of the first door hook 11 in the door-closing direction, the first door hook 11 can exert a direct or indirect force on the shielding component 62 in the door-closing direction, to move the shielding component 62 to the second position. That is, the avoidance gap 61 can be exposed from the shielding component 62, and then the first door hook 11 can drive the second lever 40 to rotate through the avoidance gap 61. Therefore, the first door hook 11 can sequentially drive the first lever 30 and the second lever 40 to rotate. In this way, the orderliness of triggering the corresponding switch components is realized, avoiding poor contact between the first door hook 11 and the second lever 40 as well as a disorder in the triggering sequence.

In the interlocking device 100 for the microwave oven 1000 according to the embodiments of the present disclosure, by providing the shielding component 62, the shielding component 62 is movable between the first position where the avoidance gap 61 is shielded by the shielding component 62 and the second position where the avoidance gap 61 is exposed. Moreover, the shielding component 62 is positioned at the first position when the door is opened, and therefore the foreign objects such as the fingers cannot inadvertently trigger the second lever 40 through the avoidance gap 61. Thus, the risk of the electric shock and the microwave leakage caused by operation of the microwave oven 1000 when the door is opened is effectively reduced. In this way, safety of using the microwave oven 1000 is improved. During the closing of the door, the shielding component 62 moves to the second position, at which time the first door hook 11 can drive the second lever 40 to rotate through the avoidance gap 61, and the second lever 40 is located at the rear side of the first lever 30. Thus, the corresponding switch components can be triggered in an orderly manner to avoid the disorder of the triggering sequence. In this way, service life of the microwave oven 1000 is improved.

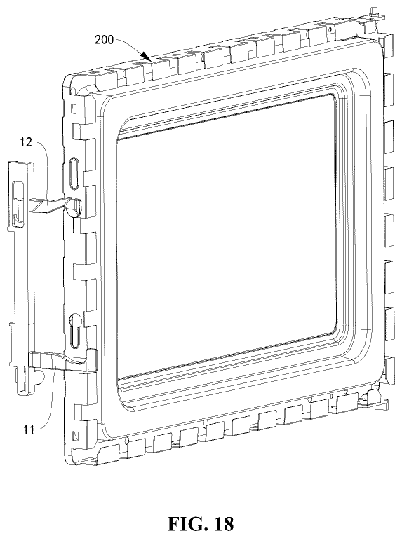

In addition, in some embodiments, the door 200 of the microwave oven 1000 may further include a second door hook 12. For example, as shown in FIGS. 18, 19, 36, and 37, the first door hook 11 is a lower door hook, the second door hook 12 is an upper door hook, and the lower door hook is disposed at a lower side of the upper door hook. In other exemplary embodiments of the present disclosure, the door 200 of the microwave oven 1000 may further include a third door hook or more door hooks, and the plurality of door hooks are vertically arranged at intervals. In some embodiments where the door 200 of the microwave oven 1000 includes a plurality of door hooks, two switch components are indirectly triggered through the engagement between the first door hook 11 and the second lever 40, thereby ensuring orderliness of opening and closing of the two switch components.

The first door hook 11 may be a fixed door hook, that is, it is fixed relative to the door 200. Therefore, a position and a structure of the first door hook 11 remain stable in the process driving the first door hook 11 by the second lever 40 to rotate, to avoid affecting the orderly triggering of the micro switches due to a change of the position of the first door hook 11. The second door hook 12 and the third door hook and other door hooks may be fixed door hooks or movable door hooks, for example, they may be door hooks rotatably or movably mounted at the door 200.

Since the interlocking device 100 for the microwave oven 1000 according to the embodiments of the present disclosure has the above-described beneficial effects, in the microwave oven 1000 according to the embodiments of the present disclosure and the interlocking device 100 according to the embodiments of the present disclosure, by providing the shielding component 62, the shielding component 62 is movable between the first position where the avoidance gap 61 is shielded by the shielding component 62 and the second position where the avoidance gap 61 is exposed. Moreover, the shielding component 62 is positioned at the first position when the door is opened, and therefore the foreign objects such as the fingers cannot inadvertently trigger the second lever 40 through the avoidance gap 61. Thus, the risk of the electric shock and the microwave leakage caused by the operation of the microwave oven 1000 when the door is opened is effectively reduced. In this way, the safety of using the microwave oven 1000 is improved. During the closing of the door, the shielding component 62 moves to the second position, at which time the first door hook 11 can drive the second lever 40 to rotate through the avoidance gap 61, and the second lever 40 is located at the rear side of the first lever 30. Thus, the corresponding switch components can be triggered in an orderly manner to avoid the disorder of the triggering sequence. In this way, the service life of the microwave oven 1000 is improved.

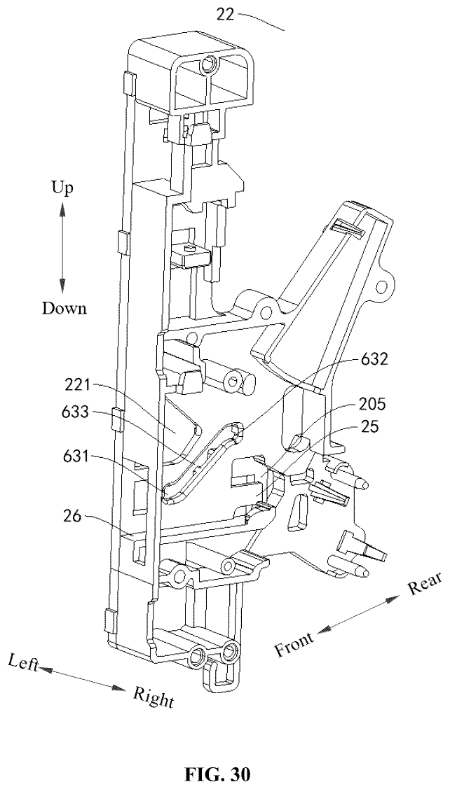

In order to enable the shielding component 62 to switch between the first position and the second position with the movement of the first door hook 11, as shown in FIGS. 14 to 17 and FIGS. 30 and 31, the interlocking bracket 20 may have a first guide groove 63, and at least part of the first guide groove 63 extends away from the second lever 40 in the door-closing direction (obliquely extending backwards and upwards as shown in FIG. 30), and the shielding component 62 can move under guiding and position limiting of the oblique part. Since the groove section extends away from the second lever 40, the shielding component 62 can move away from the second lever along the first guide groove 63 (in the upward direction as shown in FIG. 30), thereby realizing the shielding component 62 switching from the first position to the second position, at which time the shielding component 62 cannot provide a shielding effect, and the avoidance gap 61 is in an exposed state, that is, the shielding component 62 is at the second position, and the first door hook 11 can pass through the first lever 30 to drive the second lever 40 to rotate.

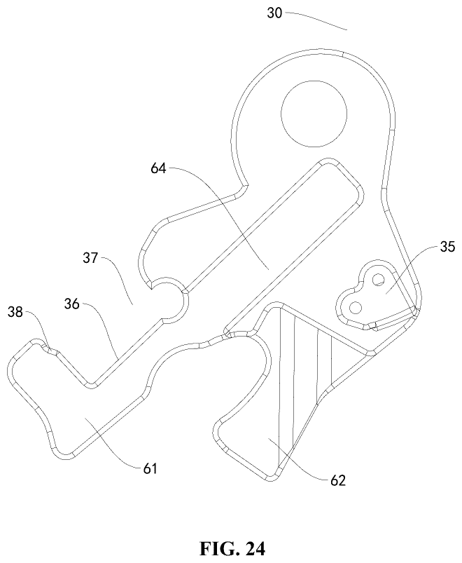

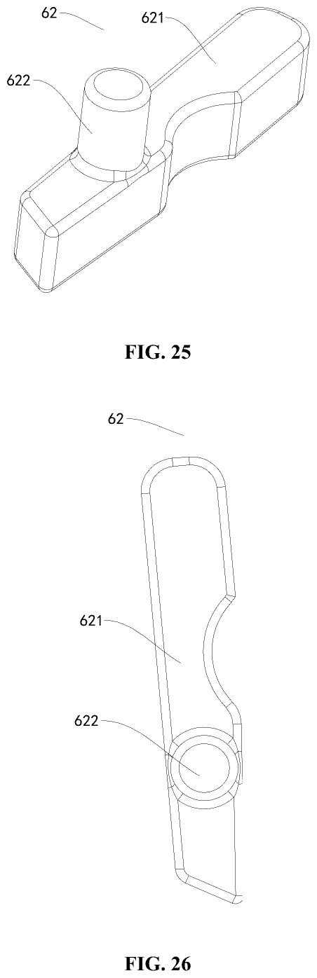

Moreover, as shown in FIGS. 25 and 26, the shielding component 62 may include a shielding block 621 and a guide block 622. The shielding block 621 is configured to shield the avoidance gap 61, for example, it may stop foreign objects such as fingers from passing through the avoidance gap 61 to drive the second lever 40. The guide block 622 may be connected to the shielding block 621 and movably disposed in the first guide groove 63. During a movement of the guide block 622, the shielding block 621 moves with the guide block 622 in the first guide groove 63 to complete the switching of the shielding component 62 between the first position and the second position. For example, when the guide block 622 moves to a position in the first guide groove 63 away from the second lever 40 in the door-closing direction, the shielding block 621 remains at a position away from the second lever 40, and then the avoidance gap 61 is exposed. In this case, the first door hook 11 may continue to move through the avoidance gap 61 to drive the second lever 40 to rotate.

The embodiments of the present disclosure do not impose any special restrictions on a shape of the guide block 622. For example, the guide block 622 may be a rectangular post or a cylinder. In some embodiments, as shown in FIG. 25, the guide block 622 is a cylindrical protrusion, and then resistance during the movement can be effectively reduced when the guide block 622 moves in the first guide groove 63, such as friction resistance generated between the guide block 622 and a groove wall of the first guide groove 63, ensuring that the shielding component 62 can more smoothly move to the second position from the first position, and ensuring that the first door hook 11 can drive the second lever 40 through the avoidance gap 61.

In addition, the embodiments of the present disclosure do not impose any special restrictions on a shape of the shielding block 621. In some embodiments, as shown in FIG. 25, the shielding block 621 may be an elongated post, which can achieve a larger shielding range and better prevent the foreign objects such as the fingers from inadvertently triggering the second lever 40.

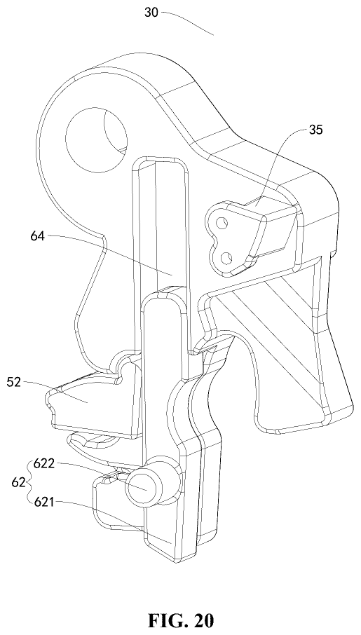

In addition, according to some embodiments of the present disclosure, as shown in FIGS. 20 to 24, the first lever 30 may have a second guide groove 64. The shielding block 621 may be movably disposed in the second guide groove 64. The second guide groove 64 can guide and limit a movement of the shielding block 621. Moreover, by reasonably providing the corresponding positions of the first guide groove 63 and the second guide groove 64, during a movement of the shielding component 62, the guide block 622 and the shielding block 621 may simultaneously move in the first guide groove 63 and the second guide groove 64, respectively. Thus, the shielding component 62 can not only keep moving with the first lever 30, but also smoothly switch between the first position and the second position without being hindered by the structure.

The first door hook 11 is adapted to abut against at least one of the first lever 30 and the shielding block 621 to drive the first lever 30 to rotate and move the shielding component 62 to the second position. In some embodiments of the present disclosure, during the movement of the first door hook 11 in the door-closing direction, the first door hook 11 abuts against the first lever 30 and can apply a force in the door-closing direction to the first lever 30, and then the first lever 30 can rotate. Since the shielding block 621 is movably disposed in the second guide groove 64 of the first lever 30, the shielding component 62 can move to the second position under position limiting and guiding of the second guide groove 64, and then the avoidance gap 61 is exposed, and the first door hook 11 can continue to move to drive the second lever 40.

In some other embodiments, the first door hook 11 abuts against the shielding block 621, and the first door hook 11 may apply a force in the door-closing direction to the shielding block 621. Since the shielding block 621 is movably disposed in the second guide groove 64 of the first lever 30, the first lever 30 can rotate under the force of the shielding block 621 while the shielding component 62 moves to the second position. The shielding component 62 moves to the second position under the position limiting of the first guide groove 63 and the second guide groove 64, and then the avoidance gap is exposed, and the first door hook 11 can continue to move to drive the second lever 40 to rotate. Moreover, at this time, since the first door hook 11 abuts against the shielding block 621, the first door hook 11 can be in full contact with the second lever 40 after the shielding component 62 moves to the second position. In this way, a better driving effect can be achieved.

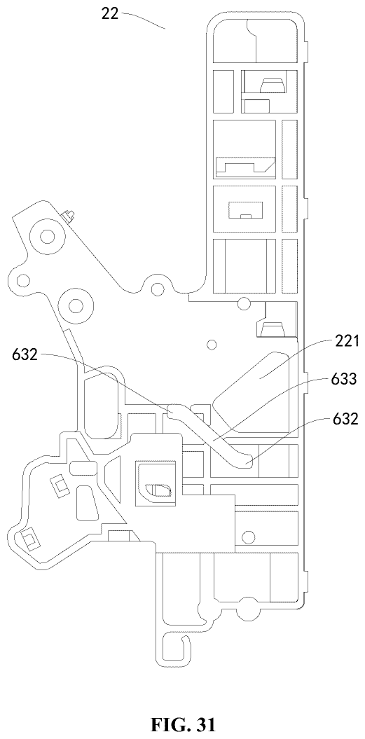

In some embodiments, as shown in FIGS. 30 and 31, the first guide groove 63 may include a first horizontal groove section 631, a second horizontal groove section 632, and an inclined groove section 633 connecting the first horizontal groove section 631 with the second horizontal groove section 632. That is, a projection of the first guide groove 63 parallel to a rotation axis of the first lever 30 may be in a “Z” shape. Moreover, the first horizontal groove section 631 and the second horizontal groove section 632 can limit a position of the shielding component 62, and the guide block 622 may be stably located in the first horizontal groove section 631 and the second horizontal groove section 632. Thus, the shielding component 62 cannot have a moving trend in the first guide groove 63.

In addition, the first horizontal groove section 631 is located at a side of the second horizontal groove section 632 close to the second lever 40. That is, the second horizontal groove section 632 is located at a side of the first horizontal groove section 631 facing away from the second lever 40. With the first horizontal groove section 631 to be offset from the second horizontal groove section 632, there can be a certain height difference between the first horizontal groove section 631 and the second horizontal groove section 632 in an up-down direction as shown in FIG. 31. Thus, the shielding component 62 can be guided to reciprocate between the height difference by the inclined groove section 633 when moving in the first guide groove 63, to realize the switching of the shielding component 62 between the operating states of exposing and shielding the avoidance gap 61.

In some embodiments of the present disclosure, when the door is opened, the guide block 622 is positioned in the first horizontal groove section 631 and does not tend to move. In this case, the avoidance gap 61 is shielded, which can effectively stop the foreign objects such as the fingers from contacting the second lever 40. In this way, the disorder in the triggering sequence of the switch components is avoided. As a result, the safety of using the microwave oven 1000 is avoided from being affected. The guide block 622 is positioned in the second horizontal groove section 632 when the door is closed. In this case, the guide block 622 is guided to move to the second horizontal groove section 632 by the inclined groove section 633. At this time, the avoidance gap 61 is exposed, and the first door hook 11 can continue to move to drive the second lever 40. In addition, since the guide block 622 is positioned in the second horizontal groove section 632, the guide block 622 cannot slide, such as falling to the inclined groove section 633. Thus, position interference between the first door hook 11 and the shielding component 62 can be avoided during the movement of the first door hook 11 towards the second lever 40 in the door-closing direction. Therefore, the first door hook 11 is prevented being blocking from continuing to move to drive the second lever 40. As a result, the triggering sequence of the switch components is avoided from being affected.

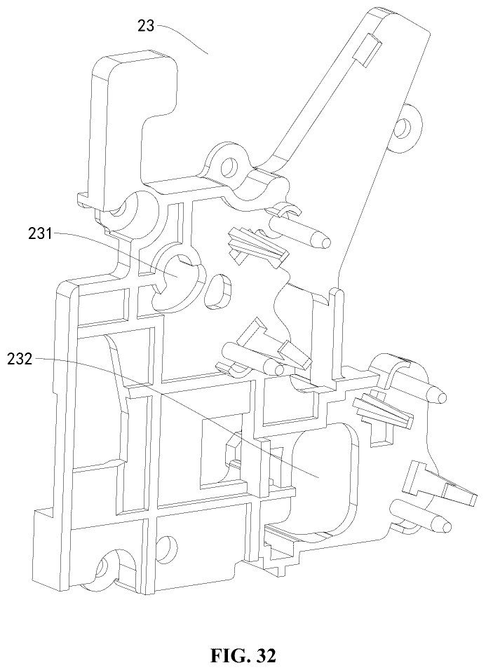

According to some embodiments of the present disclosure, as shown in FIGS. 32 to 35, the first lever 30 may include a first drive arm 31 and a second drive arm 32, and the second drive arm 32 is located at a side of the first drive arm 31 facing away from the second lever 40 in the door-closing direction. That is, the first drive arm 31 is located at a leading side of the second drive arm 32 in the door-closing direction.

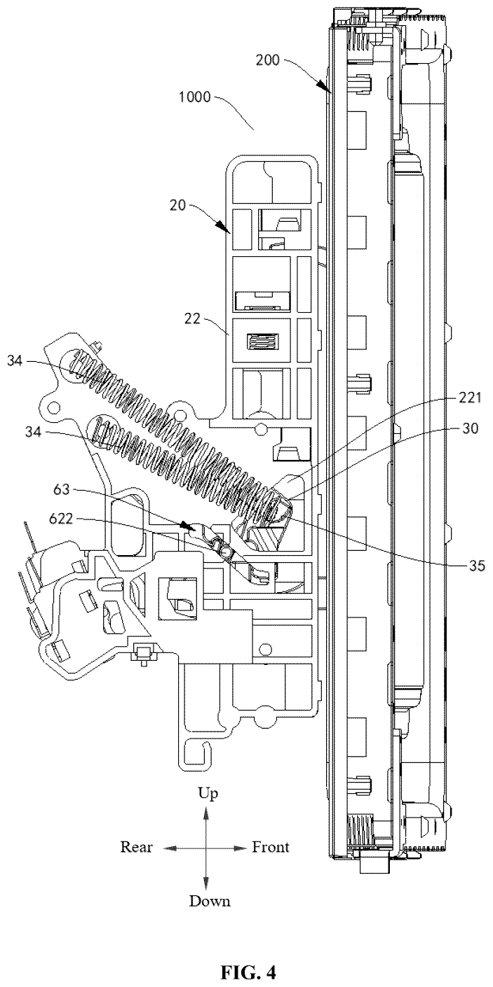

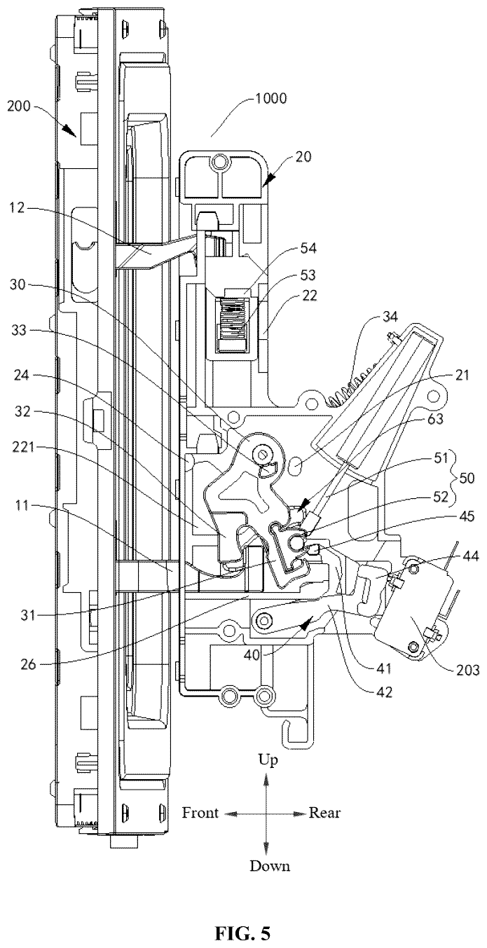

The first door hook 11 is adapted to abut against the first drive arm 31 to drive the first lever 30 to rotate. As shown in FIGS. 4 and 5, the first door hook 11 may abut against the first drive arm 31 during the closing of the door to drive the first drive arm 31 to rotate around the rotation axis of the first lever 30 in a second direction (counterclockwise direction as shown in FIG. 5), to trigger a corresponding switch component. In some specific embodiments, the first drive arm 31 may be provided with a fourth cooperation portion 33, and a switch component corresponding to the triggering of the first lever 30 may be a monitoring switch 201. The fourth cooperation portion 33 is driven to rotate by rotating the first drive arm 31, and therefore the fourth cooperation portion 33 can be rotated to a position of triggering the monitoring switch 201 to turn on the monitoring switch 201.

Moreover, the avoidance gap 61 may be formed between the first drive arm 31 and the interlocking bracket 20, rather than between the second drive arm 32 and the interlocking bracket 20. Since the first drive arm 31 is closer to the second lever 40 in the door-closing direction, the first door hook 11 can be in contact with the second lever 40 to drive the second lever 40 to rotate after passing through the avoidance gap 61, thereby avoiding position interference.

In addition, in some embodiments, as shown in FIGS. 20, 22, and 24, the shielding component 62 may be movably disposed at the first drive arm 31 in a length direction of the first drive arm 31, to facilitate reducing a volume of the first drive arm 31. In some embodiments of the present disclosure, when the first lever 30 is not driven by the first door hook 11, a certain angle is formed between an arm length direction of the first drive arm 31 and the door-closing direction, for example, it may be a right angle. Since the avoidance gap 61 is formed between the first drive arm 31 and the interlocking bracket 20, the first drive arm 31 can achieve a partial shielding effect. The shielding component 62 is disposed at the first drive arm 31 in the length direction of the first drive arm 31, and an extending direction of the shielding component 62 is the same as the arm length direction of the first drive arm 31. Thus, the shielding component 62 can be engaged with the first drive arm 31 to achieve a shielding effect, and foreign objects such as fingers cannot be in contact with the second lever 40.

Moreover, the shielding component 62 is movable at the first drive arm 31. Thus, the shielding component 62 can be switched between the first position and the second position. In this way, the shielding component 62 is positioned at the first position when the door is opened, and the shielding component 62 can move to the second position when the first door hook 11 moves in the door-closing direction.

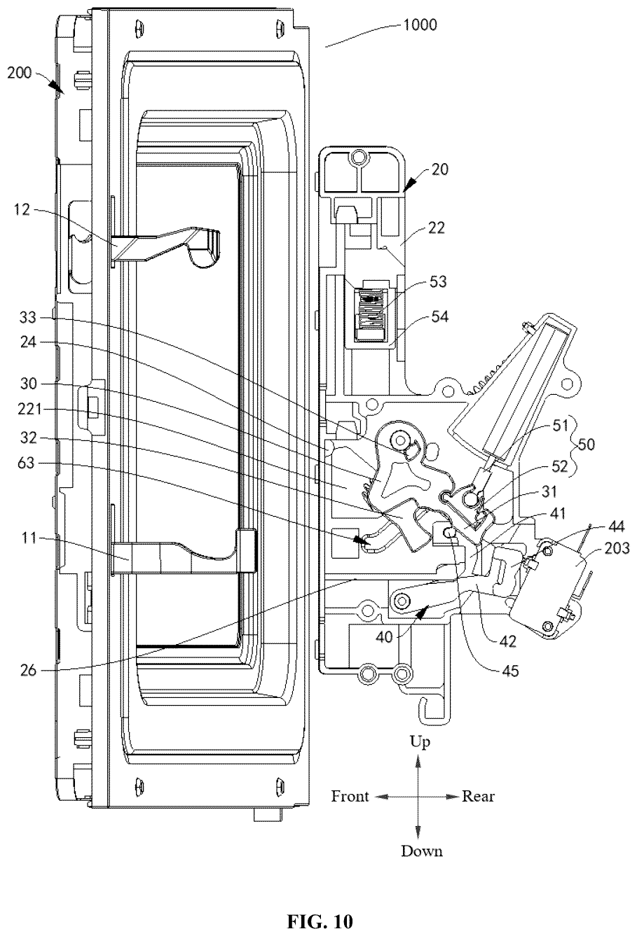

In some embodiments of the present disclosure, as shown in FIG. 10, a predetermined gap may be formed between the second drive arm 32 and the interlocking bracket 20 in a state where the switch component is triggered by the first lever 30, for example, when the first lever 30 is inadvertently touched to rotate, causing the switch component to be abnormally triggered. For example, the predetermined gap may be formed by providing a recess at the first lever 30, or by providing a recess at the interlocking bracket 20, which is not particularly limited in the embodiments of the present disclosure.

During the normal closing of the door, the first lever 30 rotates under the driving of the first door hook 11 to trigger the switch component. Moreover, the first door hook 11 is positioned between the first drive arm 31 and the second drive arm 32 when the switch component is triggered by the first lever 30. On the one hand, it is convenient to drive the second lever 40 to rotate. On the other hand, it is convenient to drive the first lever 30 to rotate in an opposite direction through the engagement between the first door hook 11 and the second drive arm 32 when the door is opened to release the triggering of the switch component.

By providing the predetermined gap, the first door hook 11 can pass through the predetermined gap and move to a position between the first drive arm 31 and the second drive arm 32 when the switch component is abnormally triggered by the first lever 30. Thus, the microwave oven 1000 can be changed to the state of the door being normally closed from the abnormal triggering state without assembling and disassembling the entire machine. Users can manually solve the problem of the abnormal triggering of the first lever 30, which is very convenient to operate and can effectively reduce use cost.

In addition, when the microwave oven 1000 needs to be opened, the first door hook 11 can abut against the second drive arm 32 through a door opening action to drive the first lever 30 to rotate in an opposite direction to a first direction, allowing the first lever 30 to be reset. Then, the first door hook 11 can be disengaged from a position between the first drive arm 31 and the second drive arm 32, and then a containing chamber (not shown in the figure) of the body can be opened to allow the door 200 to be opened. Thus, the door can be opened and closed smoothly and repeatedly. According to some embodiments of the present disclosure, as shown in FIGS. 27 to 29, the second lever 40 may include a first cooperation portion 45 and at least one second cooperation portion 44. The first door hook 11 is adapted to abut against the first cooperation portion to drive the second lever 40 to rotate, and the at least one second cooperation portion 44 is configured to trigger at least one of the plurality of switch components. In some embodiments, the interlocking bracket 20 is provided with a first micro switch 202 and a second micro switch 203, and the second lever 40 may be provided with two second cooperation portions 44. The first micro switch 202 and the second micro switch 203 are respectively triggered by the two second cooperation portions 44 during a rotation of the second lever 40.

Moreover, in the door-closing direction, the second cooperation portion 44 may be positioned at a side of the first cooperation portion 45 facing away from the first lever 30, and the shielding component 62 is positioned at a side of the first cooperation portion 45 close to the first lever 30. That is, the shielding component 62, the first cooperation portion 45, and the second cooperation portion 44 are sequentially arranged in the door-closing direction. Thus, when the shielding component 62 is positioned at the second position, the first door hook 11 can first drive the first cooperation portion 45 through the avoidance gap 61, and then drive the second lever 40 to rotate, and then at least one second cooperation portion 44 can trigger a corresponding switch component. When the second lever 40 includes a plurality of second cooperation portions 44, it is beneficial to orderly triggering of corresponding switch components.

As shown in FIG. 5 and FIGS. 27 to 29, in some embodiments, the second lever may include a first rotary arm and a second rotary arm. The first cooperation portion is disposed at the first rotary arm, and the second cooperation portion is disposed at the second rotary arm. Moreover, the first rotary arm 41 and the second rotary arm 42 are sequentially arranged around a rotation axis of the second lever 40 in the first direction (clockwise direction as shown in FIG. 5). On the one hand, it is beneficial to the orderly triggering of the micro switches at the interlocking bracket 20 to avoid a disorder in a triggering sequence. On the other hand, it is beneficial to a reasonable arrangement of the micro switches at the interlocking bracket 20 to realize compactness of the body structure of the microwave oven 1000.

According to some embodiments of the present disclosure, as shown in FIGS. 11 to 17, the interlocking bracket 20 may have a mounting space 204, and an avoidance recess 205 is formed at a side wall of the mounting space 204. The first rotary arm 41 may be located in the avoidance recess 205, which can effectively prevent the second lever 40 from rotating after elongated objects or fingers are inserted into the mounting space 204 in the door-closing direction and in contact with the first rotary arm 41, thereby avoiding the first micro switch 202 and the second micro switch 203 from being inadvertently triggered.

Moreover, the first cooperation portion 45 may extend into the mounting space 204, and the first door hook 11 is adapted to extend into the mounting space 204 and movable in the mounting space 204 in the door-closing direction to close the microwave oven 1000. During the movement of the first door hook 11, the first door hook 11 may be in contact with the first cooperation portion 45 extending into the mounting space 204 to drive the second lever 40 to rotate.

Since the first cooperation portion 45 may be flexibly disposed at the first rotary arm 41 based on actual needs, the first door hook 11 can be ensured to be in contact with the first cooperation portion 45 by changing the position of the first cooperation portion 45 at the first rotary arm 41 to drive the second lever 40 to rotate, and it is not easy for other elongated objects such as fingers to come into contact with the first cooperation portion 45 in the mounting space 204, which can effectively avoid objects other than the first door hook 11 from contacting the first cooperation portion 45 and inadvertently triggering the micro switch, thereby ensuring the safety of using the microwave oven 1000.

In some embodiments, the first cooperation portion 45 is located at a side surface of a top of the first rotary arm 41, which can effectively avoid position interference between the first cooperation portion 45 and other components in the mounting space 204 on the one hand, and can avoid the rotation of the second lever 40 caused by other elongated objects to be in contact with the first cooperation portion 45 on the other hand. In this way, safety performance of the microwave oven 1000 is better.

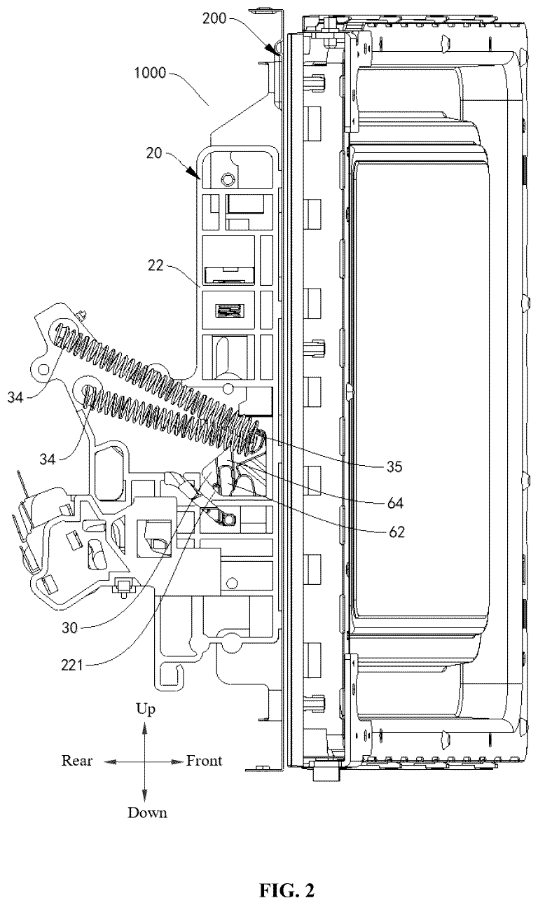

In some embodiments where the interlocking bracket 20 includes a bracket body 22 and a cover 23, as shown in FIGS. 30 to 33, the cover 23 covers the bracket body 22 to allow the cover 23 to be fit with the bracket body 22 to define the mounting space 204. Referring to FIGS. 1 and 2, the first micro switch 202 is disposed at a side of the cover 23 facing away from the bracket body 22, and the second micro switch 203 is disposed in the mounting space 204. The cover 23 may further have a second through hole 232, and the second cooperation portion 44 of the second lever 40 may pass through the second through hole 232 to extend to the side of the cover 23 facing away from the bracket body 22. During the rotation of the second lever 40, the second cooperation portion 44 rotates with the second lever 40 in the second through hole 232 to easily trigger the first micro switch 202 located outside the mounting space 204. The third cooperation portion 46 is located in the mounting space 204 and can trigger the second micro switch 203 located in the mounting space 204. The first micro switch 202 and the second micro switch 203 are located at different sides of the cover 23 and thus do not interfere with each other. For example, projections of the first micro switch 202 and the second micro switch 203 in an axial direction of the second lever 40 may at least partially overlap, allowing the arrangement of the two micro switches to be more compact and the sequential triggering of the two micro switches by the second lever 40 to be quicker.

According to some embodiments of the present disclosure, as shown in FIGS. 30 and 31, the interlocking bracket 20 may include a first baffle 25 that may partially block a communication opening between the avoidance recess 205 and the mounting space 204. In this way, the first baffle 25 can prevent the second lever 40 from rotating due to the fingers or other objects touching the first rotary arm 4 while can limit a position of the first rotary arm 41.

In some embodiments of the present disclosure, as shown in FIGS. 14 and 15, the first rotary arm 41 may be displaced along its rotation axis in the avoidance recess 205. On the one hand, it is impossible to satisfy a stable rotation state of the lever. On the other hand, if part or all of the first rotary arm 41 moves out of the avoidance recess 205, the fingers or other elongated objects can drive the second lever 40 through the first rotary arm 41 without any obstruction, and the risk of rotating the second lever 40 due to the accidental touch still exists. By providing the first baffle 25 to partially block the communication opening between the avoidance recess 205 and the mounting space 204, the first rotary arm 41 can be stably positioned in the avoidance recess 205 and cannot be moved to the mounting space 204. In this way, the accidental touch of the first rotary arm 41 by the fingers is avoided. Meanwhile, the first baffle 25 can also limit the position of the rotary arm 41 and guide the first rotary arm 41. When the first door hook 11 abuts against the first cooperation portion 45 to drive the second lever 40 to rotate, the first baffle 25 may mate with a side surface of the interlocking bracket 20 facing towards the first rotary arm 41 to form a matching groove. In this case, the first rotary arm 41 can rotate smoothly in the matching groove to avoid misalignment of the second cooperation portion 44, the third cooperation portion 46, and their corresponding micro switches, which could otherwise lead to a failure in accurate trigger of the corresponding micro switches, and thus to avoid the operating state of the microwave oven 1000 affected by the failure in the accurate trigger of the micro switches.

The communication opening between the avoidance recess 205 and the mounting space 204 is partially blocked by the first baffle 25, rather than being completely blocked. If the communication opening is completely blocked by the first baffle 25, the first rotary arm 41 cannot enter the avoidance space through the communication opening. However, with the first baffle 25 partially blocking the communication opening, the mounting of the first rotary arm 41 is facilitated while avoiding the accidental touch and providing the position limiting effect, which can effectively save labor time and improve assembling efficiency.

According to some embodiments of the present disclosure, as shown in FIGS. 11 to 17 and FIG. 30, the interlocking bracket 20 may have a mounting space 204. The second rotary arm 42 is located in the mounting space 204. A second baffle 26 is disposed in the mounting space 204. At least part of the second baffle 26 may extend in the door-closing direction and is located between a rotary shaft of the second lever 40 and the first door hook 11. In this way, it is possible to limit a position of the first door hook 11 and guide the first door hook 11 on the one hand, for a part of the second baffle 26 can serve as a track for a movement of the first door hook 11. The first door hook 11 moves on the part of the second baffle 26 in the door-closing direction, and then accurately abuts against the first cooperation portion 45 to drive the second lever 40 to rotate. On the other hand, the part is located between the rotary shaft and the first door hook 11, which is beneficial to avoiding the accidental triggering of the micro switch caused by the fingers touching the rotary shaft of the second lever 40.

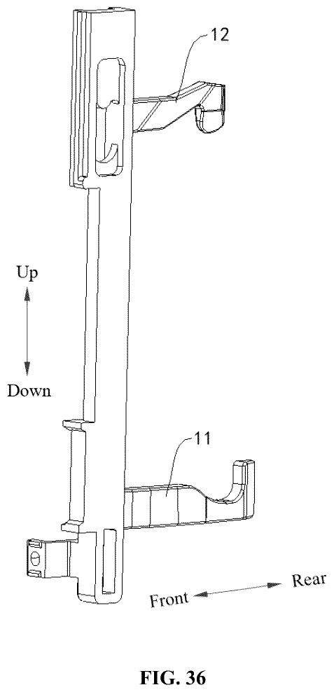

In some embodiments where at least part of the second baffle 26 extends in the door-closing direction, the second baffle 26 further includes an arc segment located at a tip of the second baffle 26 and extending in an upward direction as shown in FIG. 36. The second baffle 26 may have a cross section of a slide shape perpendicular to the rotation axis. Moreover, in the door-closing direction, the second baffle 26 is offset from the second rotary arm 42, and the arc segment of the second baffle 26 is located at a position of the second rotary arm 42 close to the first door hook 11. The arc segment of the second baffle 26 can stop the foreign objects such as the fingers entering the mounting space 204, ensuring that the second rotary arm 42 is not touched by the foreign objects such as the fingers.

According to some embodiments of the present disclosure, as shown in FIG. 27, the interlocking bracket 20 may have a mounting space 204. The second rotary arm 42 is located in the mounting space 204. A third baffle 27 is disposed in the mounting space 204 and located at a side of the second rotary arm 42 close to the first door hook 11. In this way, it is possible to prevent the fingers or other objects from contacting the second rotary arm 42 and avoid the second rotary arm 42 from being inadvertently touched, which would otherwise drive the second lever 40 to rotate and thus affect the safety of the microwave oven 1000.

In some embodiments of the present disclosure, the third baffle 27 at least partially overlaps with a projection of the door hook in the door-closing direction. Moreover, the third baffle 27 is closer to the first door hook 11 than the second rotary arm 42 in the door-closing direction, and thus the third baffle 27 can stop the foreign objects such as the fingers.

In some embodiments where the interlocking bracket 20 includes a bracket body 22 and a cover 23, at least one of the bracket body 22 and the cover 23 is provided with a third baffle 27. That is, the third baffle 27 may be disposed at the bracket body 22 or at the cover 23, or both the bracket body 22 and the cover 23 are provided with a third baffle 27 to prevent the fingers or the other objects from inadvertently touching the second rotary arm 42.

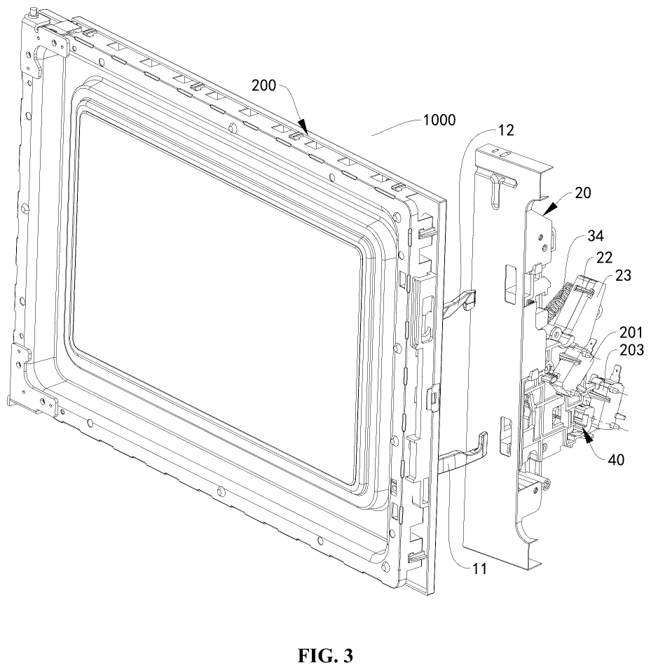

According to some embodiments of the present disclosure, as shown in FIGS. 4, 7, and 11 to 13, the interlocking device 100 further includes an elastic component 34 connected to the interlocking bracket 20 and the first lever 30. For example, the elastic component 34 may be one or more coil springs. For example, in an example shown in FIG. 18, the elastic component 34 is a tension spring, and two tension springs are provided. As shown in FIG. 3, the first lever 30 is provided with a connection portion 35 that is a protrusion disposed at a side of the first lever 30 facing away from the fourth cooperation portion 33. Each of the two tension springs has an end connected to the interlocking bracket 20 and another end connected to the connection portion 35, and ends of the two tension springs connected to the interlocking bracket 20 are spaced by a predetermined distance.

In addition, the elastic component 34 has a first driving state. The elastic component 34 is configured to, in the first driving state, apply a driving force to the first lever 30 to rotate in the second direction, allowing the second drive arm 32 to drive the first door hook 11 to move in the door-closing direction.

In some embodiments of the present disclosure, as shown in FIGS. 1 to 9, during the closing of the door, the first door hook 11 moves to a position between the first drive arm 31 and the second drive arm 32 in the door-closing direction to abut against the first drive arm 31 to drive the first lever 30 to start to rotate in the second direction. When the first lever 30 starts to rotate in the second direction or after the first lever 30 rotates by a relatively small angle, the elastic component 34 is in the first driving state to automatically drive the first lever 30 to rotate in the second direction, allowing the second drive arm 32 to drive the first door hook 11 to continue to move in the door-closing direction, to realize an automatic door-closing effect. In this case, even if the user releases the door-closing force applied to the door 200, it can be ensured that the door 200 is closed in place, and that the first door hook 11 can move in the door-closing direction until all the three switch components are triggered. In this way, it is labor-saving and convenient for the user to operate on the one hand, and a problem of incomplete door-closing can be avoided on the other hand.

In some embodiments, the elastic component 34 has a second driving state. The elastic component 34 is configured to, in the second driving state, apply a driving force to the first lever 30 to rotate in the first direction. The first door hook 11 can abut against the first drive arm 31 during the closing of the door, allowing the elastic component 34 to be switched to the first driving state from the second driving state.

In some embodiments of the present disclosure, when the door is opened, the first lever 30 can be maintained at a desired position under the action of the elastic component 34. In this way, on the one hand, it is possible to prevent the rotation of the first lever 30 in the first direction without the action of the first door hook 11, which would otherwise inadvertently trigger the monitoring switch 201. On the other hand, it can be ensured that the first door hook 11 can smoothly move to the position between the first drive arm 31 and the second drive arm 32 during the closing of the door, avoiding the rotation of the first lever 30, which would otherwise affect the engagement between the first door hook 11 and the first lever 30. Moreover, since the first door hook 11 abuts against the first drive arm 31 to drive the first lever 30 to rotate in the second direction, the elastic component 34 is timely switched between the driving states with the rotation of the first lever 30, ensuring that the elastic component 34 can timely drive the door to be closed.

The elastic component 34 is in the first driving state when the door is closed. In this case, the first lever 30 can abut against the first door hook 11 by the second drive arm 32, ensuring that the door 200 remains to be closed. When the door needs to be opened, the user controls the first door hook 11 to move in the door opening direction to abut against the second drive arm 32, allowing the first lever 30 to rotate in the first direction. When the first lever 30 rotates to a predetermined angle, the elastic component 34 is switched to the second driving state from the first driving state, and therefore the elastic component 34 can drive the first lever 30 to rotate in the first direction and timely release resistance to the first door hook 11. As a result, the door 200 can be easily opened.

In some embodiments where the elastic component 34 is a spring, the spring constantly remains in a stretched state regardless of the first driving state or the second driving state.

According to some embodiments of the present disclosure, as shown in FIGS. 11 to 13, the interlocking device 100 may further include a door-closing buffer assembly 50. The interlocking bracket 20 is connected to the first lever 30 by the door-closing buffer assembly 50, for example, the door-closing buffer assembly 50 is connected to the first drive arm 31 of the first lever 30.

The door-closing buffer assembly 50 is configured to apply a buffering force to the first lever 30 during the closing of the door in an opposite direction to the second direction, to allow for a buffered door-closing effect. In this way, a violent collision between the door 200 and the body is avoided during the closing of the door, and door-closing noise is advantageously reduced.

The structure of the door-closing buffer assembly 50 is not specifically limited in the present disclosure, as long as the buffered door-closing effect can be satisfied. For example, the door-closing buffer assembly 50 may include a damper, a spring plate, or a compression spring, etc.

For example, in some specific embodiments, as shown in FIGS. 11 to 13, the door-closing buffer assembly 50 includes a buffer 51 and a connector 52. The buffer 51 has an end rotatably connected to the interlocking bracket 20, and the connector 52 is rotatably connected to each of another end of the buffer 51 and the first drive arm 31. Therefore, the buffer 51 can provide a buffering effect during the rotation of the first lever 30, and the rotatable connection structure can adapt to the rotation of the first lever 30 to avoid jamming.

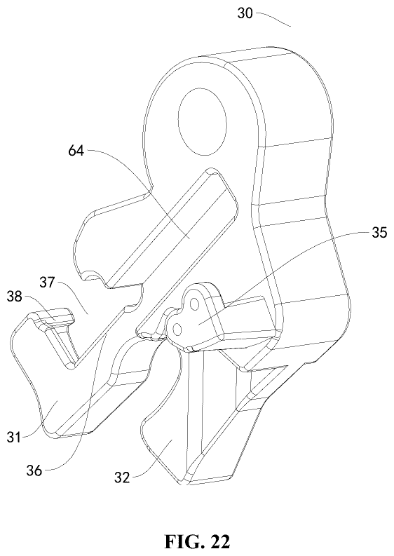

In addition, referring to FIGS. 22 and 24, the first drive arm 31 has a drive surface 36, and the connector 52 is rotatably mounted at the first lever 30. As shown in FIG. 6, when the door is opened, a predetermined angle is formed between the connector 52 and the drive surface 36, and the buffer 51 has another end rotatably connected to the connector 52. During the opening of the door, the drive surface 36 may abut against the connector 52 after the first lever 30 rotates by the predetermined angle in the second direction, to drive the connector 52 to rotate.

Since the connector 52 and the drive surface 36 are arranged at the predetermined angle when the door is opened, the buffer 51 cannot apply a buffering force to the first lever 30 upon the first door hook 11 contacting the first lever 30 to drive the first lever 30 to rotate in the second direction. As a result, it is easier for the first door hook 11 to drive the first lever 30 to rotate.

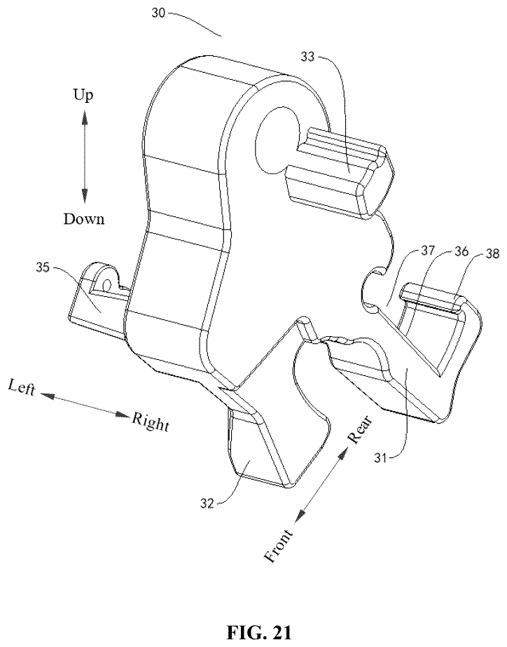

In some exemplary embodiments, as shown in FIGS. 21, 22, and 24, the first drive arm 31 has a recess 37 formed at a side of the first drive arm 31 facing towards the door-closing buffer assembly 50. A bottom wall surface of the recess 37 is formed as a drive surface 36. A side surface of the recess 37 is connected to the connector 52 through a hole-and-shaft fit, and the recess 37 is provided with a hook 38 spaced apart from the drive surface 36 by a predetermined distance on another side surface of the recess 37. The buffer 51 is a damper connected to the connector 52 through a hole-and-shaft fit at an opening of the recess 37. The interlocking device 100 further includes an elastic component 34 connected to the first lever 30.

The elastic component 34 applies a driving force to the first lever 30 to rotate in the first direction when the door is opened, and therefore the first door hook 11 can smoothly move to abut against the first drive arm 31. In this case, a predetermined angle is formed between the connector 52 and the drive surface 36, and therefore the damper does not generate a buffering force. During the closing of the door, the first door hook 11 is in contact with the first drive arm 31 to drive the first lever 30 to rotate in the second direction. Since the damper does not generate the buffering force, the first door hook 11 only needs to overcome the driving force of the elastic component 34 to drive the first lever 30. In this case, the resistance is smaller. When the first lever 30 rotates until the connector 52 abuts against the drive surface 36, the elastic component 34 is switched to a state in which it applies a driving force to the first lever 30 to rotate in the second direction, to actively drive the first lever 30 to rotate, the first door hook 11 to move, and the door 200 to be closed. In this case, the damper generates a buffering force to reduce the door-closing noise. During the opening of the door, the first door hook 11 pulls the first lever 30 to rotate in the first direction, and the connector 52 rotates relative to the first drive arm 31. Therefore, a predetermined angle is formed between the connector 52 and the drive surface 36, and the hook 38 abuts against the connector 52 to prevent the angle from being too large and prevent the connector 52 from disengaging from the recess 37, and thus to ensure that the connector 52 is stably connected to the first lever 30.

For example, in some other exemplary embodiments, the door-closing buffer assembly 50 may include a buffer 51, which is a spring plate or a compression spring, and the door-closing buffer assembly 50 is formed as a buffer energy storage assembly. In some embodiments of the present disclosure, the spring plate has an end connected to the interlocking bracket 20 and another end abutting against the first lever 30, and the spring plate is elastically deformable to store energy.

During the closing of the door, the first lever 30 rotates in the first direction and squeezes the other end of the spring plate, and therefore a bending degree of the spring plate increases and stores energy, which provides buffering and energy storage effects. During the opening of the door, the spring plate can release the stored energy to apply a driving force to the first lever 30 to rotate in the first direction, and therefore the first lever 30 can push the first door hook 11 and the door 200 to move towards the door opening direction, which provides an effect in assisting the door opening. When the door is closed, a driving force of the spring plate acting on the first lever 30 directs towards a rotation center of the first lever 30 or near the rotation center of the first lever 30. In this case, the spring plate does not provide a component force in a rotation direction of the first lever 30 or only provides a smaller component force, ensuring that the door 200 can be tightly closed.

In some embodiments of the present disclosure, as shown in FIGS. 10 and 12, the first lever 30 may have a thinned region formed at a side of the first lever 30 in the axial direction of the first lever 30, allowing the avoidance gap 61 to be formed at the thinned region when the first lever 30 is mounted at the interlocking bracket 20. When the first lever 30 is inadvertently touched and rotates in the second direction (counterclockwise direction as shown in FIG. 10) to the position of triggering the monitoring switch 201, the first door hook 11 can be forced to pass through the avoidance gap 61 and move to the position between the first drive arm 31 and the second drive arm 32 of the first lever 30 through the door-closing action, and then the first door hook 11 can drive the first lever 30 to rotate and reset in the first direction (clockwise direction as shown in FIG. 10) by opening the door.

An interlocking device for a microwave oven according to some embodiments of the present disclosure will be described in detail below with reference to the accompanying drawings. It should be understood that the following description is illustrative rather than limiting the present disclosure.

As shown in FIGS. 1 to 38, a microwave oven 1000 according to embodiments of the present disclosure includes a door 200, a body, and an interlocking device 100. The interlocking device 100 includes a first door hook 11, a second door hook 12, an interlocking bracket 20, a first baffle 25, a second baffle 26, a third baffle 27, a first lever 30, a shielding component 62, a second lever 40, a monitoring switch 201, a first micro switch 202, a second micro switch 203, an elastic component 34, a door-closing buffer assembly 50, a driver 53, and an inclined block 54.

As shown in FIGS. 18, 19, 36, and 37, the door 200 is rotatably mounted at the body about a vertical axis. The first door hook 11 and the second door hook 12 are fixed to the door 200, and the second door hook 12 is located above the first door hook 11. The interlocking bracket 20 is mounted at the body and includes a bracket body 22 and a cover 23 to define a mounting space 204. An avoidance recess 205 is formed at a side wall of the mounting space 204. The bracket body 22 includes a first baffle 25 partially blocking a communication opening between the avoidance recess 205 and the mounting space 204. In addition, as shown in FIGS. 18 to 24 and FIGS. 36 to 38, a second baffle 26 and a third baffle 27 are disposed in the mounting space 204. The second baffle 26 is a slide-shaped plate body, and the third baffle 27 is a rectangular plate body. In addition, the interlocking bracket 20 has a first guide groove 63 including a first horizontal groove section 631, a second horizontal groove section 632, and an inclined groove section 633 connecting the first horizontal groove section 631 and the second horizontal groove section 632.

As shown in FIGS. 1 to 10, the first lever 30 and the second lever 40 are rotatably mounted in the mounting space 204, and the first lever 30 includes a first drive arm 31, a second drive arm 32, and a fourth cooperation portion 33, and the fourth cooperation portion 33 passes through a first through hole 231 of the cover 23; and an avoidance gap 61 is formed between the first drive arm 31 and the interlocking bracket 20. In addition, as shown in FIGS. 20 and 22, the first lever 30 has a second guide groove 64. The shielding component 62 includes a shielding block 621 and a guide block 622. The shielding block 621 is an elongated post, and the guide block 622 is a cylinder. The guide block 622 is connected to the shielding block 621 and movably disposed in the first guide groove 63, and the shielding block 621 is movably disposed in the second guide groove 64.

The second lever 40 includes a first rotary arm 41 provided with a first cooperation portion 45, a second rotary arm 42 provided with a second cooperation portion 44, and a third cooperation portion 46. The second cooperation portion 44 passes through a second through hole 232 of the cover 23. Moreover, the second baffle 26 has an arc section located at a side of the second rotary arm 42 close to the first door hook 11 and a flat straight section located between a rotary shaft of the second lever 40 and the first door hook 11. The third baffle 27 is located at the side of the second rotary arm 42 close to the first door hook 11. In addition, the first rotary arm 41 is located in the avoidance recess 205, and the first cooperation portion 45 extends into the mounting space 204.

As shown in FIGS. 6, 8, and 10, the second micro switch 203 is disposed in the mounting space 204, and the monitoring switch 201 and the first micro switch 202 are disposed at a side of the cover 23 facing away from the bracket body 22. The bracket body 22 has a third through hole 221. The elastic component 34 is disposed at a side of the bracket body 22 facing away from the cover 23, and the first lever 30 is provided with a connection portion 35 passing through the third through hole 221 to be connected to the elastic component 34.

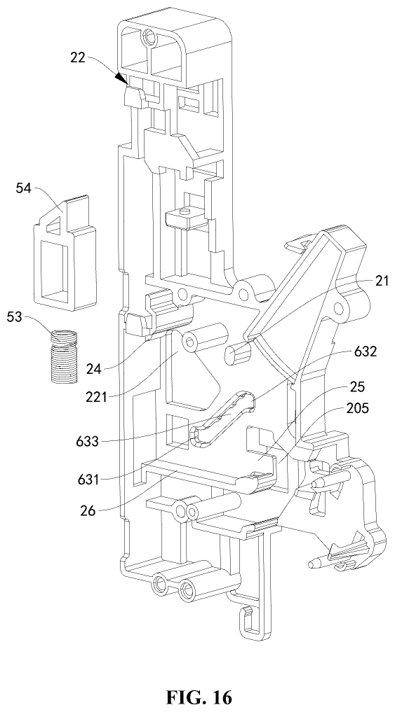

In addition, as shown in FIGS. 16, 17, and 38, the inclined block 54 may be vertically movably mounted at the bracket body 22, and two ends of the driver 53 respectively abut against the inclined block 54 and the bracket body 22 to apply an upward driving force to the inclined block 54.

As shown in FIGS. 1 to 3 and FIGS. 18 and 19, the first door hook 11 and the second door hook 12 are separated from the body when the door is opened. The driver 53 is configured to drive the inclined block 54 to be located at a high position. The first lever 30, under a pulling force of the elastic component 34, rotates clockwise to an extreme position where it abuts against an edge of the bracket body 22, and is disengaged from the monitoring switch 201; and the second lever 40 is positioned at a position where the first micro switch 202 is separated from the second micro switch 203. Moreover, the shielding component 62 is positioned at a first position (i.e., in the first horizontal groove section 631), and the avoidance gap 61 is shielded.

As shown in FIGS. 4 and 5, during closing of the door, the door 200 is pushed to move the first door hook 11 and the second door hook 12 in a door-closing direction, i.e., backwards. The first door hook 11 moves in the door-closing direction under position limiting of the second baffle 26. A rear end of the first door hook 11 extends to a position between the first drive arm 31 and the second drive arm 32 and abuts against the first drive arm 31 to push the first lever 30 to rotate counterclockwise. A direction of a pulling force of the elastic component 34 is switched to drive the first lever 30 to rotate counterclockwise when the first lever 30 rotates by a predetermined angle, allowing the second drive arm 32 of the first lever 30 to automatically pull the first door hook 11 to move backwards. Moreover, a connector 52 is in contact with a drive surface 36, and the drive surface 36 drives the connector 52 to move. A buffer 51 can provide a buffering effect. The first lever 30 rotates to enable the fourth cooperation portion 33 to trigger the monitoring switch 201. Meanwhile, the shielding component 62 moves towards a second position (i.e., located in the second horizontal groove section 632) under limiting of a first guide groove 63 and a second guide groove 64. Then, the first door hook 11 passes through the avoidance gap 61, and the first door hook 11 moves to be in contact with the first cooperation portion 45 of the second lever 40, which can drive the second lever 40 to rotate clockwise. The first micro switch 202 and the second micro switch 203 are sequentially triggered by the second cooperation portion 44 and the third cooperation portion 46 of the second lever 40. During the closing of the door, as shown in FIGS. 21 and 22, the second door hook 12 abuts against the inclined block 54, and the inclined block 54 compresses the driver 53 to move a hook portion of the second door hook 12 to a rear side of the inclined block 54. In this way, a position of the second door hook 12 is limited by the inclined block 54 to keep the door 200 closed.

As shown in FIGS. 6 to 9, when the first lever 30 rotates to abut against a first limit portion 21, it stops rotating, and the second lever 40 stops rotating after triggering the second micro switch 203. In this case, the second drive arm 32 of the first lever 30 stops the first door hook 11 under the pulling force of the elastic component 34. Thus, the door 200 is kept closed, and the first lever 30 and the second lever 40 are kept in a position where the monitoring switch 201, the first micro switch 202, and the second micro switch 203 are activated.

During the opening of the door, as shown in FIGS. 1 to 8, the door 200 rotates in an opposite direction to be opened, allowing the first door hook 11 to move forwards. During the movement, a stop force applied to the second lever 40 is removed first, and the second lever 40 rotates counterclockwise under a rebound force of the first micro switch 202 and the second micro switch 203 to release the triggering of the first micro switch 202 and the second micro switch 203. The first door hook 11 also abuts against the second drive arm 32 during the movement of the first door hook 11, to drive the first lever 30 to overcome the elastic force of the elastic component 34 and rotate clockwise, allowing the fourth cooperation portion 33 to releases the triggering of the monitoring switch 201. When a pulling force direction of the elastic component 34 is switched to drive the first lever 30 to rotate clockwise, the first lever 30 automatically resets to a position where it abuts against a second limit portion 24 under the driving of the elastic component 34, and stays at this position, and the first lever 30 can drive the first door hook 11 to move forwards to allow the door 200 to bounce open. In addition, the shielding component 62 moves to the first position from the second position, and the avoidance gap 61 is shielded by the shielding component 62 again. During the opening of the door, as shown in FIGS. 5, 16, 17, and 38, the second door hook 12 abuts against the inclined block 54 again, and the inclined block 54 compresses the driver 53 to move the hook portion of the second door hook 12 to a front side of the inclined block 54. In this way, the position limiting of the second door hook 12 by the inclined block 54 is released. As a result, the door 200 can be opened.

In summary, the first door hook 11 is engaged with the two levers to separately trigger the three switch components, and the three switch components, which are not in direct contact with the first door hook 11, can be triggered in the order of the monitoring switch 201, the first micro switch 202, and the second micro switch 203. In this way, safety of the device is ensured. In addition, by providing the shielding component 62, the shielding component 62 is movable between the first position where the avoidance gap 61 is shielded by the shielding component 62 and the second position where the avoidance gap 61 is exposed, thereby effectively preventing foreign objects such as fingers from inadvertently touching the second lever 40, and ensuring that the first door hook 11 can be in contact with the second lever 40 to drive the second lever 40 to rotate.

An interlocking device 100 for a microwave oven 1000 and a microwave oven 1000 having an interlocking device 100 according to embodiments of the present disclosure will be described below with reference to the accompanying drawings.

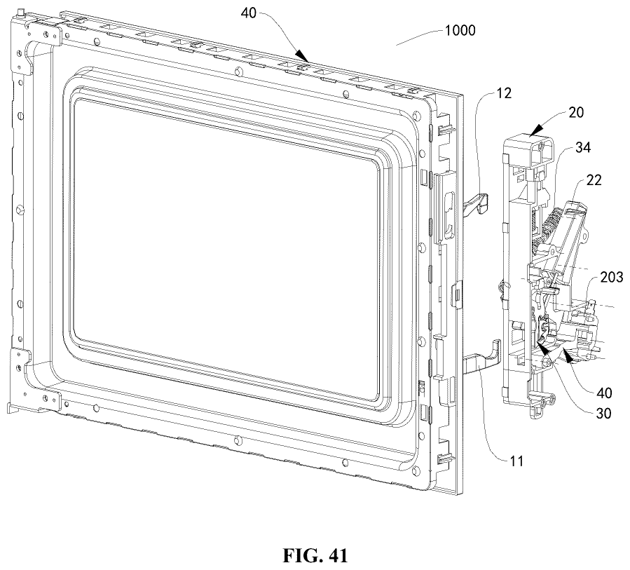

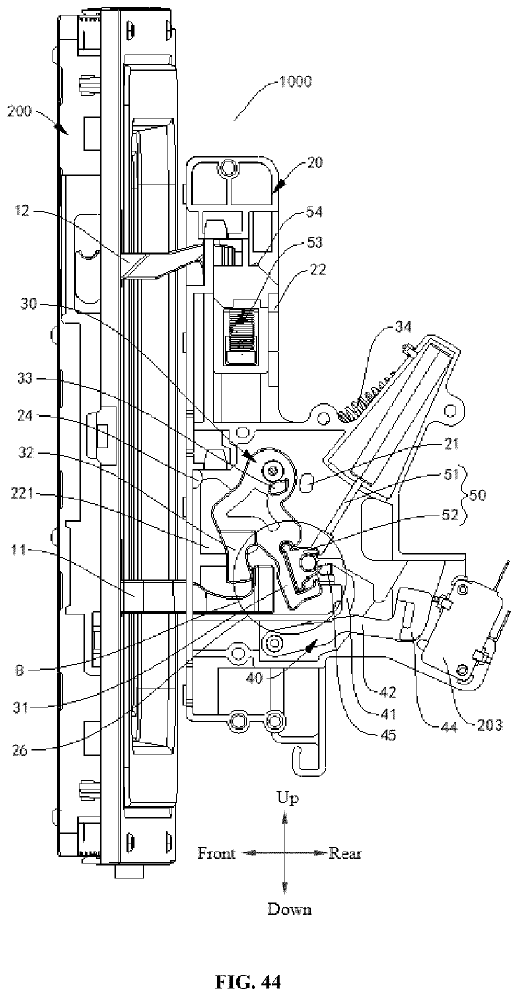

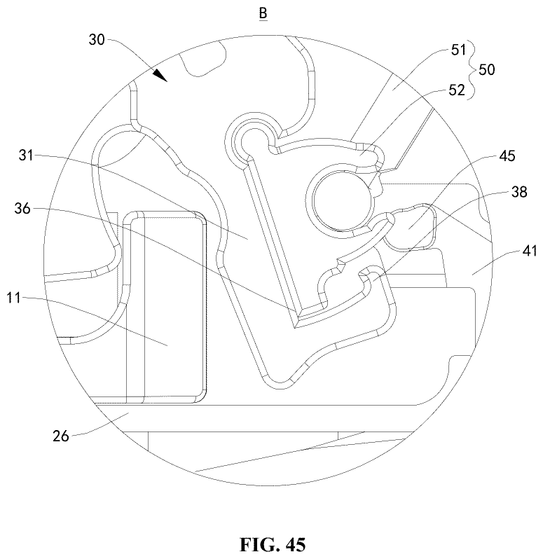

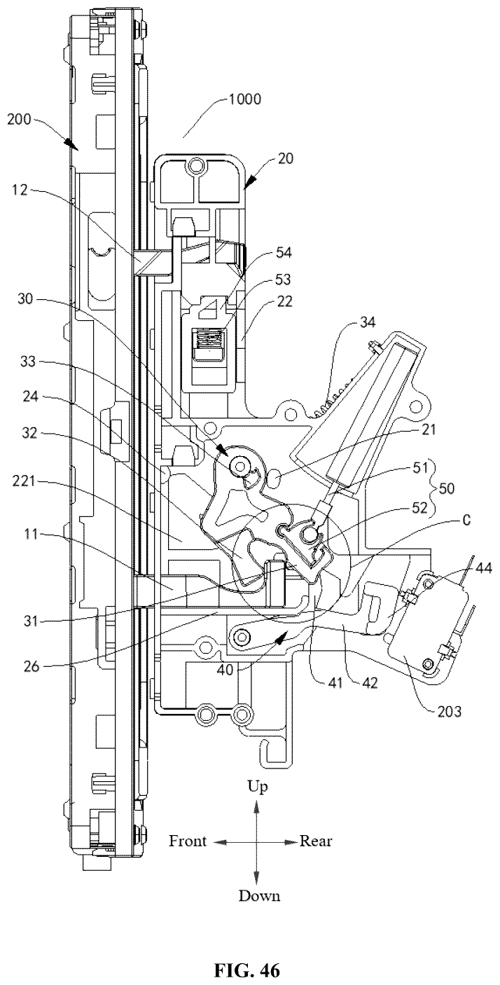

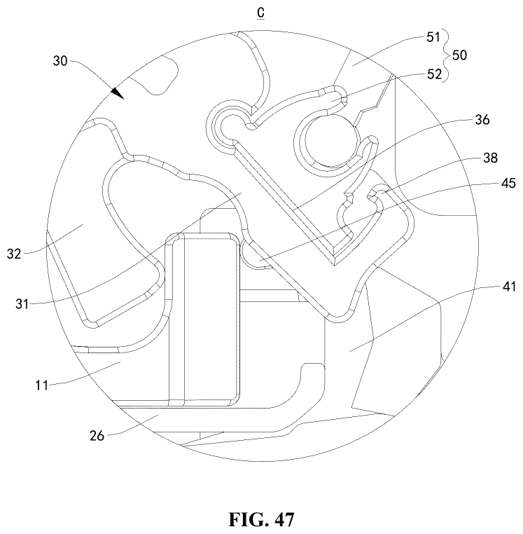

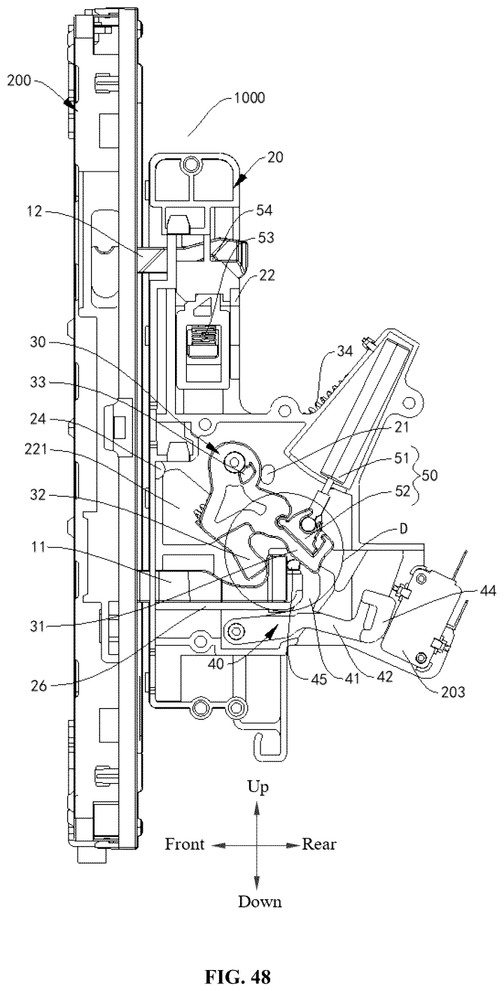

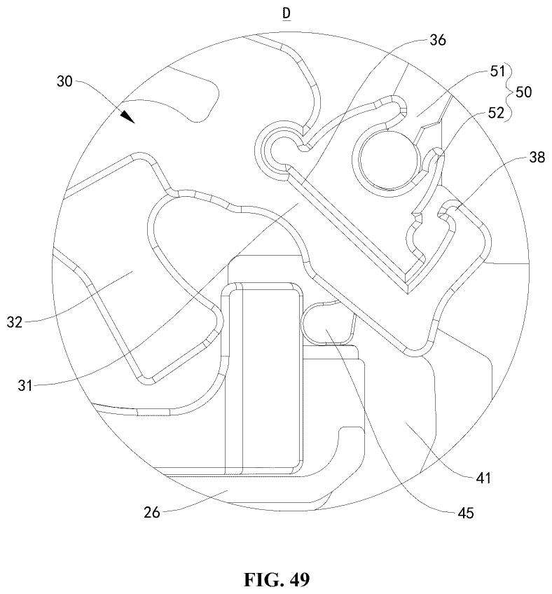

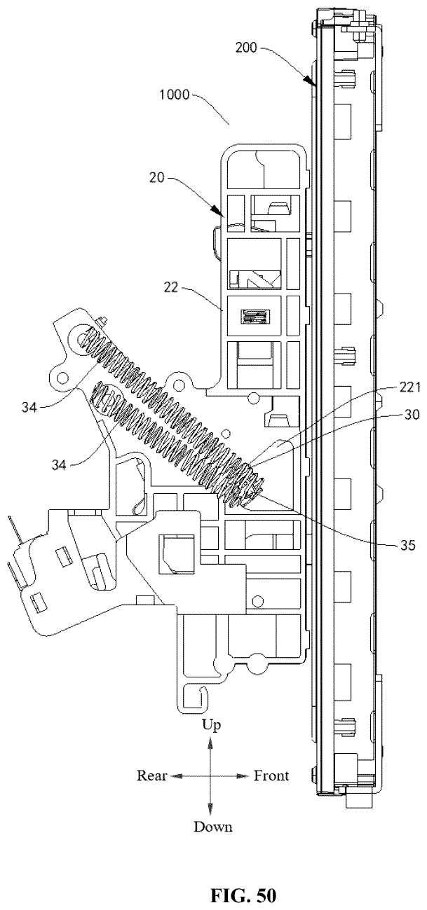

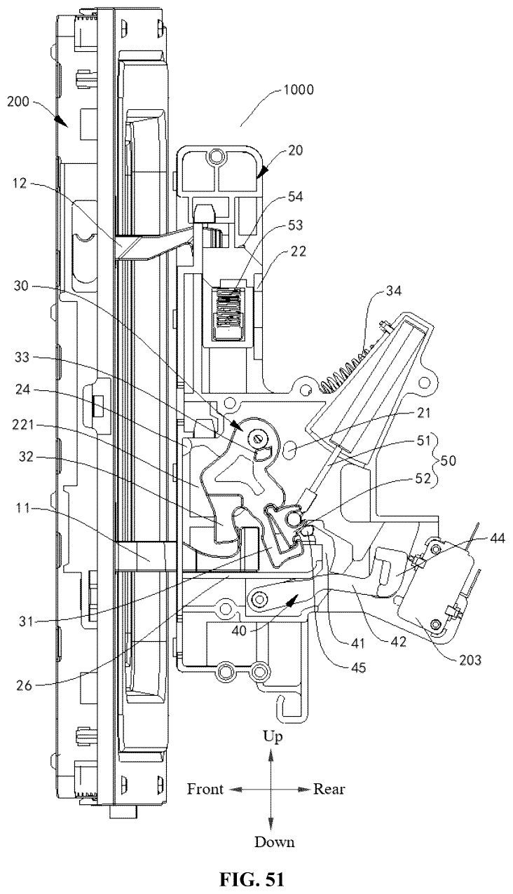

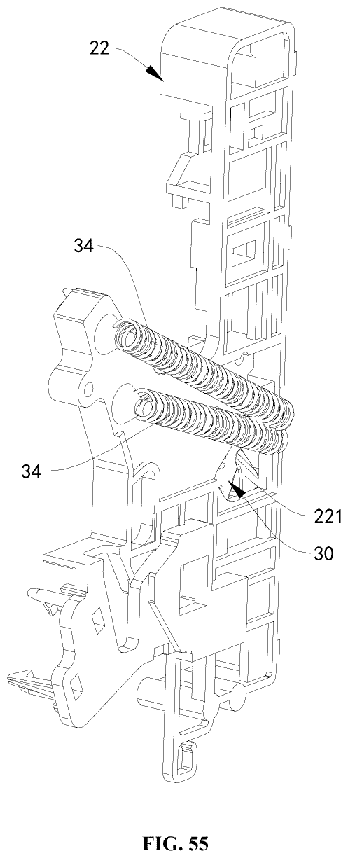

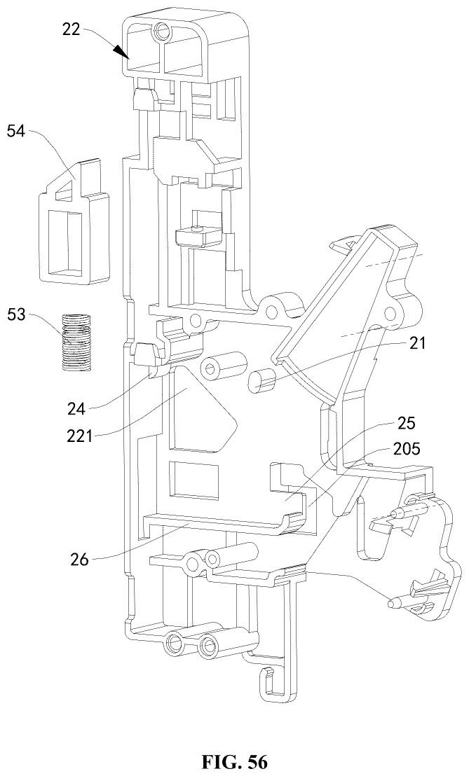

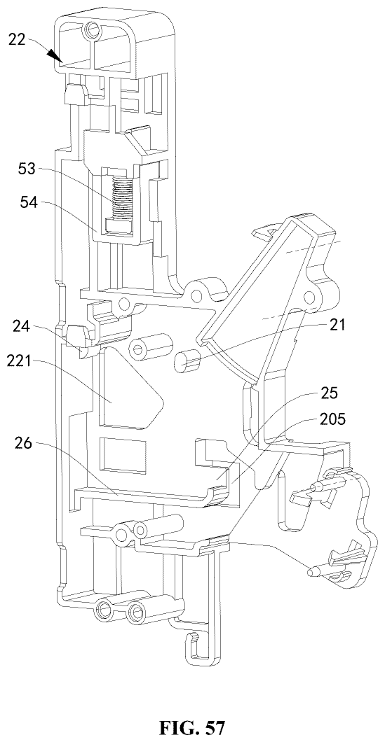

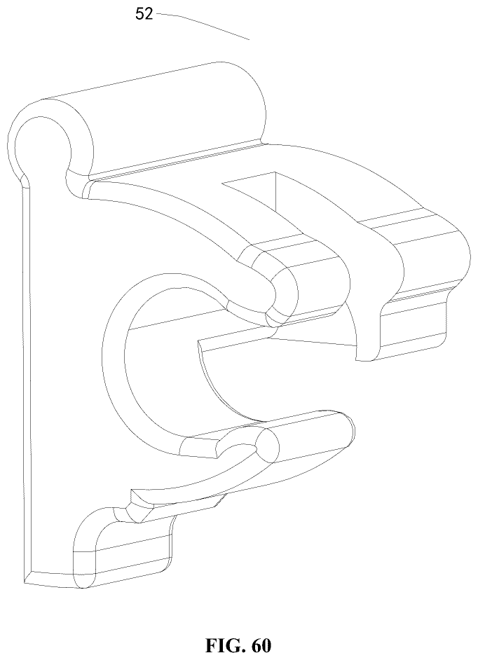

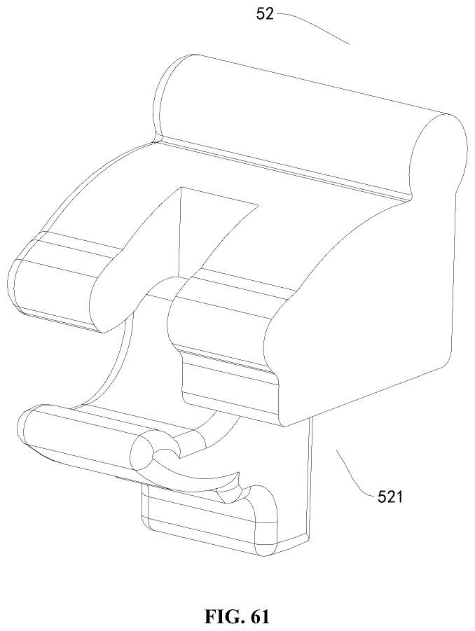

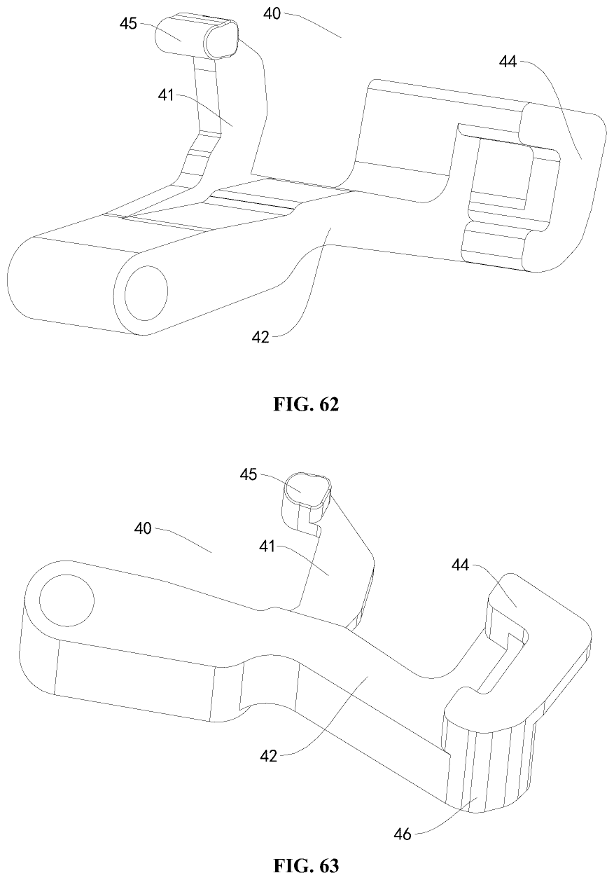

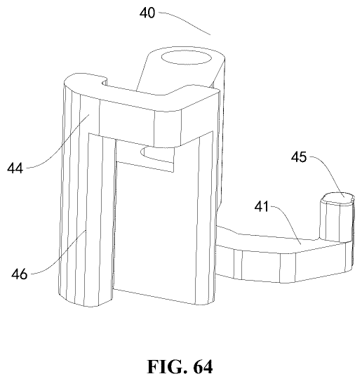

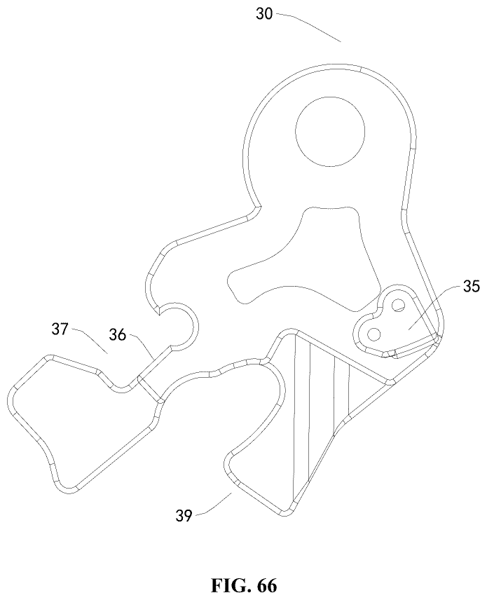

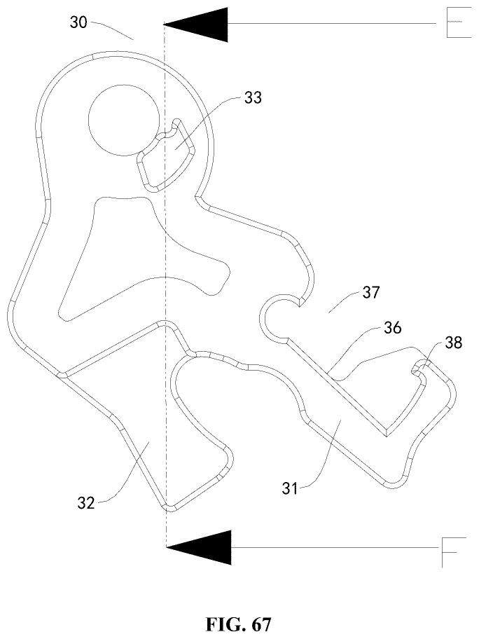

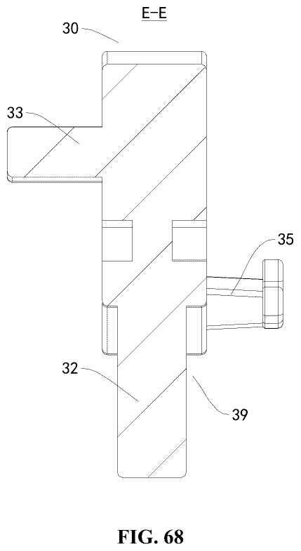

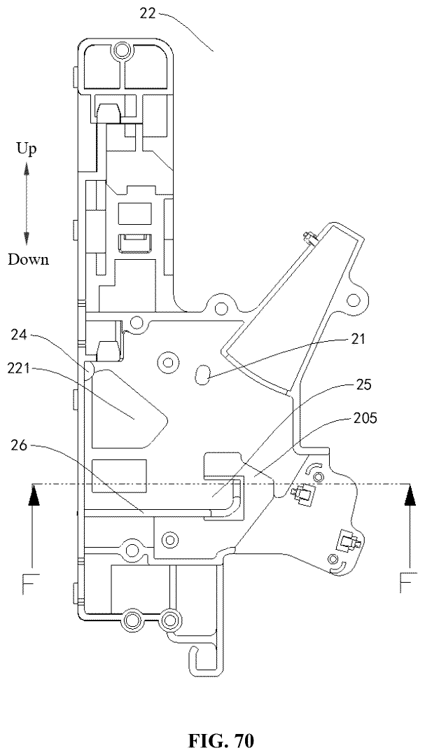

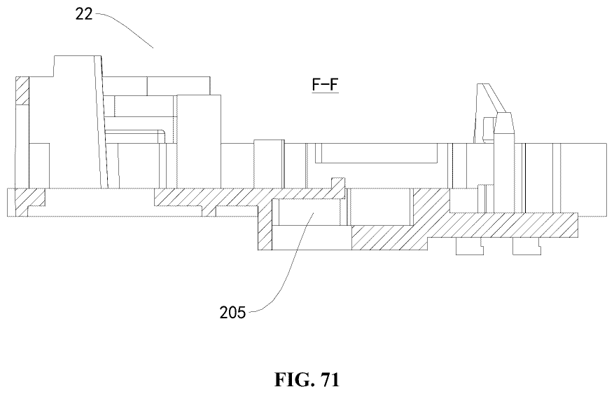

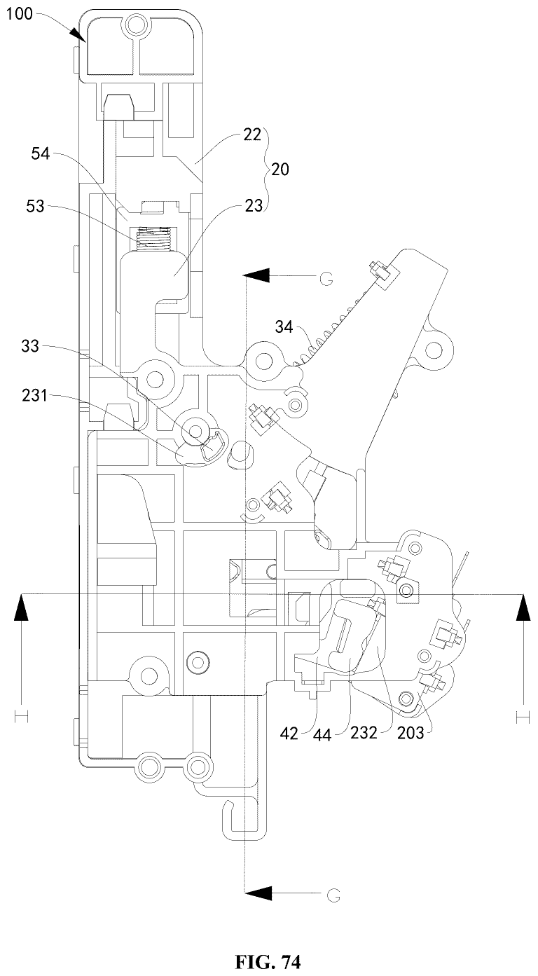

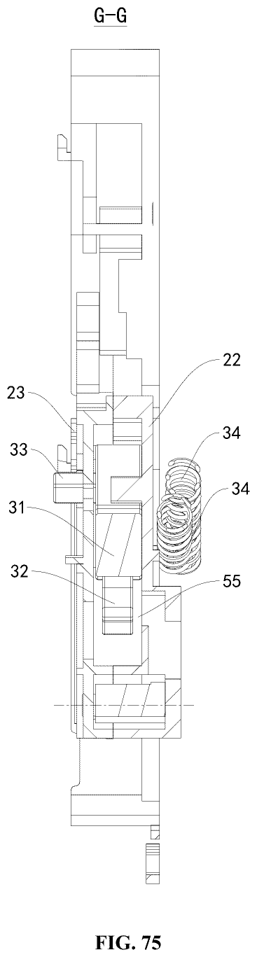

Referring to FIGS. 1 and 39 to 77, a microwave oven 1000 according to embodiments of the present disclosure may include a body, a door 200, and the interlocking device 100 for the microwave oven 1000 according to the above embodiments of the present disclosure. The door 200 is mounted at the body, for example, which is rotatably mounted at the body, to realize opening and closing of a containing chamber of the body, and to realize switching of the door 200 between an opened state and a closed state. The interlocking device 100 can realize a corresponding function based on the state switching of the door 200.

The interlocking device 100 for the microwave oven 1000 according to the above embodiments of the present disclosure may include: a first door hook 11, an interlocking bracket 20, and a first lever 30.

In some embodiments of the present disclosure, as shown in FIGS. 1, 39, 43, 36, and 37, the first door hook 11 may be mounted at the door 200 to move relative to the body as the door 200 is opened and closed. The interlocking bracket 20 is mounted at the body, and therefore the first door hook 11 can cooperate with the interlocking bracket 20 and the components at the interlocking bracket 20 during a movement of the first door hook 11 relative to the body.

In some embodiments of the present disclosure, as shown in FIG. 1, the interlocking bracket 20 is provided with switch components, which, for example, may be respectively recorded as a monitoring switch 201, a first micro switch 202, and a second micro switch 203. The monitoring switch 201, the first micro switch 202, and the second micro switch 203 may be sequentially triggered to ensure that the microwave oven 1000 can be powered on and operate normally.

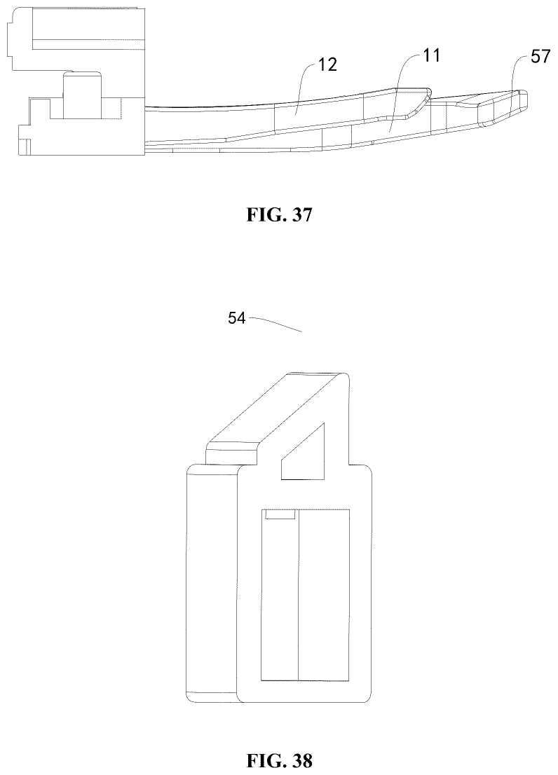

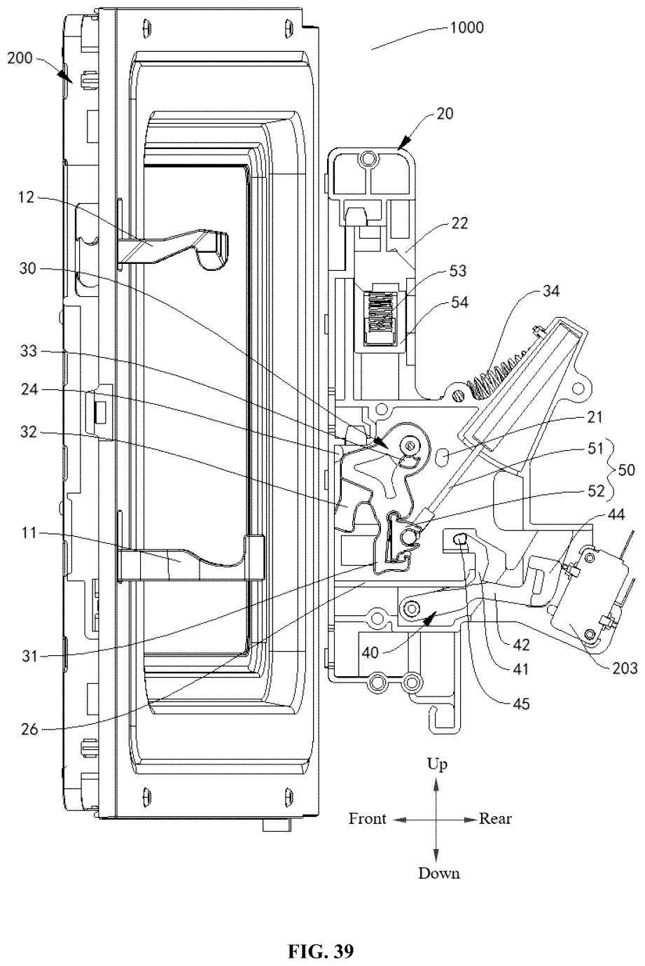

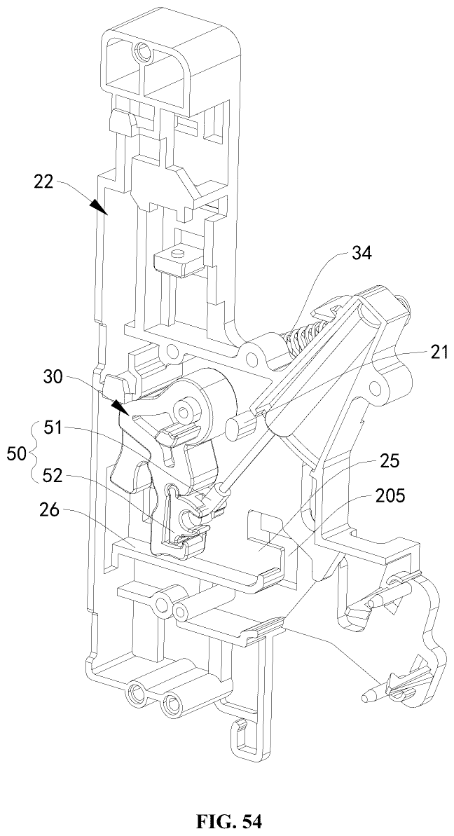

In some embodiments of the present disclosure, as shown in FIGS. 39 and 54, the first lever 30 is rotatably mounted at the interlocking bracket 20, and the first lever 30 may be configured to rotate about a rotation axis of the first lever 30 in a first direction (counterclockwise direction as shown in FIG. 39) to trigger the switch component. For example, the first lever 30 may be configured to trigger the monitoring switch 201 at the interlocking bracket 20. In addition, the first lever 30 may include a first drive arm 31 and a second drive arm 32 that are arranged in an opposite direction to the first direction. Therefore, different functions are realized.

In some related arts, after the interlocking device for the microwave oven is abnormally triggered, it may cause the first lever to rotate, causing the door not to be closed. A user needs to close the door of the microwave oven by disassembling the machine for repair, to normalize the microwave oven, that is, the normal operation of the microwave oven cannot be restored by the interlocking device itself. However, disassembling for the repair increases the users' use cost, and the user needs to spend a lot of time and energy, which greatly reduces use experience.

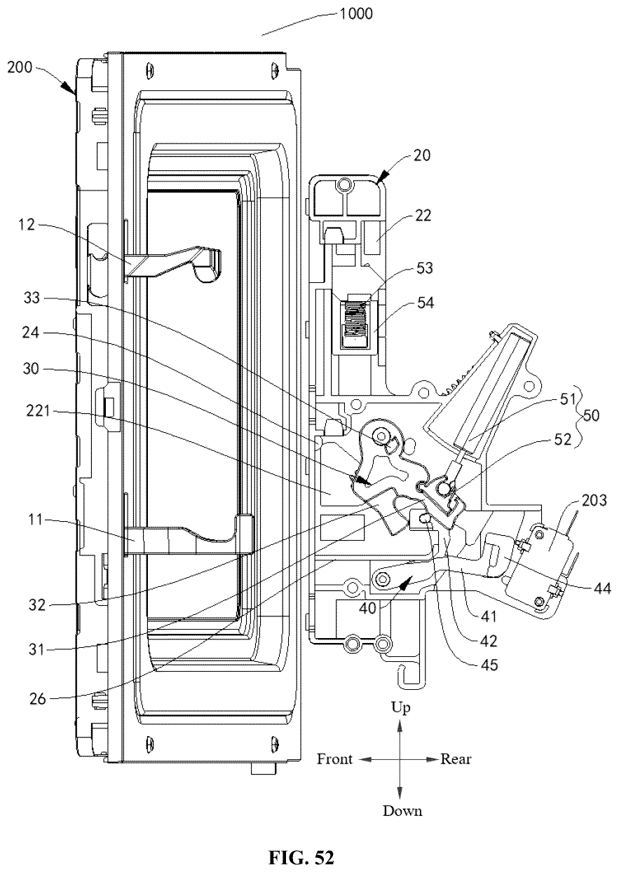

In the present disclosure, as shown in FIGS. 52, 75, and 76, a predetermined gap 55 may be formed between the second drive arm 32 and the interlocking bracket 20 in a state where the switch component is triggered by the first lever 30, for example, when the first lever 30 is inadvertently touched and rotated, causing the switch component to be abnormally triggered. For example, the predetermined gap 55 may be formed by providing a recess at the first lever 30, or by providing a recess at the interlocking bracket 20, which is not particularly limited in the embodiments of the present disclosure.

During normal closing of the door, the first lever 30 rotates under the driving of the first door hook 11 to trigger the switch component. Moreover, the first door hook 11 is positioned between the first drive arm 31 and the second drive arm 32 when the switch component is triggered by the first lever 30. On the one hand, it is convenient to drive the second lever 40 to rotate. On the other hand, it is convenient to drive the first lever 30 to rotate in an opposite direction through the engagement between the first door hook 11 and the second drive arm 32 when the door is opened to release the triggering of the switch component.

By providing the predetermined gap, the first door hook 11 can pass through the predetermined gap and move to a position between the first drive arm 31 and the second drive arm 32 when the switch component is abnormally triggered by the first lever 30. Thus, the microwave oven 1000 can be changed to the state of the door being normally closed from the abnormal triggering state without assembling and disassembling the entire machine. The user can manually solve the problem of the abnormal triggering of the first lever 30, which is very convenient to operate and can effectively reduce the use cost.

In addition, when the microwave oven 1000 needs to be opened, the first door hook 11 can abut against the second drive arm 32 through a door opening action to drive the first lever 30 to rotate in the opposite direction to the first direction, allowing the first lever 30 to be reset. Then, the first door hook 11 can be disengaged from a position between the first drive arm 31 and the second drive arm 32, and then a containing chamber (not shown in the figure) of the body can be opened to allow the door 200 to be opened. Thus, the door can be opened and closed smoothly and repeatedly.

According to the interlocking device of the embodiments of the present disclosure, by forming the predetermined gap 55 between the second drive arm 32 and the interlocking bracket 20 when the switch component is triggered by the first lever 30, the first door hook 11 can move to the position between the first drive arm 31 and the second drive arm 32 through the predetermined gap 55 when the first lever 30 is abnormally triggered. In this way, the microwave oven 1000 can restore its normal door-closing state without disassembling and overhauling the whole machine, effectively lowering the use cost. Moreover, by performing the door opening action again, the first door hook can drive the first lever to rotate and reset in the opposite direction to the first direction, facilitating smooth and repeated door-opening and closing operations. The whole process is very convenient, greatly improving the user experience. Since the interlocking device 100 for the microwave oven 1000 according to the embodiments of the present disclosure has the above-described beneficial effects, in the microwave oven 1000 according to the embodiments of the present disclosure and in the interlocking device 100 according to the embodiments of the present disclosure, the predetermined gap 55 is formed between the second drive arm 32 and the interlocking bracket 20 when the switch component is triggered by the first lever 30. Therefore, the first door hook 11 can move to the position between the first drive arm 31 and the second drive arm 32 through the predetermined gap 55 when the first lever 30 is abnormally triggered, allowing the microwave oven 1000 to restore its normal door-closing state, without disassembling and overhauling the whole machine. In this way, the use cost can be effectively reduced. Moreover, the first door hook can drive the first lever to rotate and reset in the opposite direction to the first direction by performing the door opening action again, and therefore it is convenient to open and close the door smoothly and repeatedly afterwards. The whole process is very convenient, which greatly improves the user experience.

In addition, in some embodiments, the door 200 of the microwave oven 1000 may further include a second door hook 12. For example, as shown in FIGS. 18, 19, 36, and 37, the first door hook 11 is a lower door hook, the second door hook 12 is an upper door hook, and the lower door hook is disposed at a lower side of the upper door hook. In other exemplary embodiments of the present disclosure, the door 200 of the microwave oven 1000 may further include a third door hook or more door hooks, and the plurality of door hooks are vertically arranged at intervals. In some embodiments where the door 200 of the microwave oven 1000 includes a plurality of door hooks, two switch components are indirectly triggered through the engagement between the first door hook 11 and the second lever 40, thereby ensuring orderliness of opening and closing of the two switch components.

The first door hook 11 may be a fixed door hook, that is, it is fixed relative to the door 200. Therefore, a position and a structure of the first door hook 11 are stable in the process of the first door hook 11 driving the second lever 40 to rotate, to avoid affecting the orderly triggering of the switch components due to a change of the position of the first door hook 11. The second door hook 12 and the third door hook and other door hooks may be fixed door hooks or movable door hooks, for example, they may be door hooks rotatably or movably mounted at the door 200.

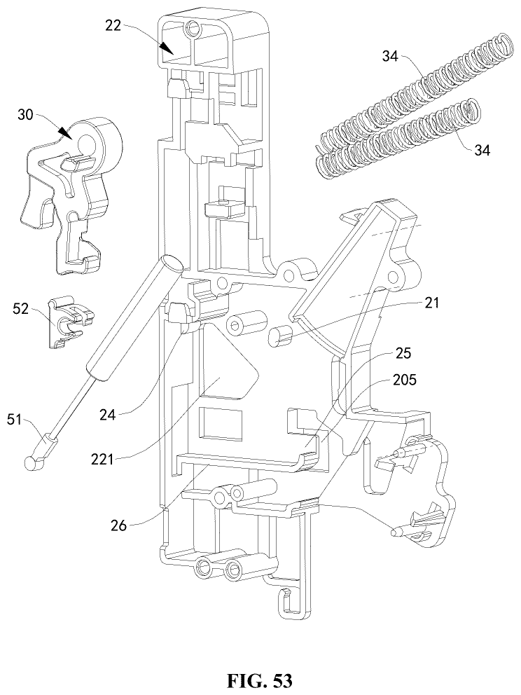

According to some embodiments of the present disclosure, as shown in FIGS. 53 and 54, the interlocking bracket 20 may have a mounting space 204, and the first drive arm 31 and the second drive arm 32 are located in the mounting space 204. The mounting space 204 can provide a stable operating environment for the first lever 30 to allow for a more reasonable structural design of the interlocking bracket 20. In addition, the predetermined gap 55 is formed between at least one side of the second drive arm 32 along the rotation axis of the first lever 30 and an inner wall of the mounting space 204, and the second drive arm 32 and the inner wall of the mounting space 204 can guide the first door hook 11 and limit a position of the first door hook 11 from two sides to ensure that the first door hook 11 can smoothly move the position between the first drive arm 31 and the second drive arm 32. In this way, the microwave oven 1000 can smoothly restore its normal door-closing state.

In some embodiments of the present disclosure, the mounting space 204 may have two inner walls spaced apart from each other along the rotation axis of the first lever 30, and the two inner walls are respectively located at two sides of the second drive arm 32 along the rotation axis of the first lever 30. The predetermined gap 55 may be a gap between any one of the two inner walls and the second drive arm 32, which is not particularly limited in the embodiments of the present disclosure. In some exemplary embodiments, the predetermined gap 55 is formed at each of two sides along the rotation axis of the first lever 30. Therefore, it is easier to ensure that the first door hook 11 can move to the position between the first drive arm 31 and the second drive arm 32 when the first lever 30 is abnormally triggered. Thus, the microwave oven 1000 can smoothly restore its normal door-closing effect. In this way, the user experience is greatly improved.

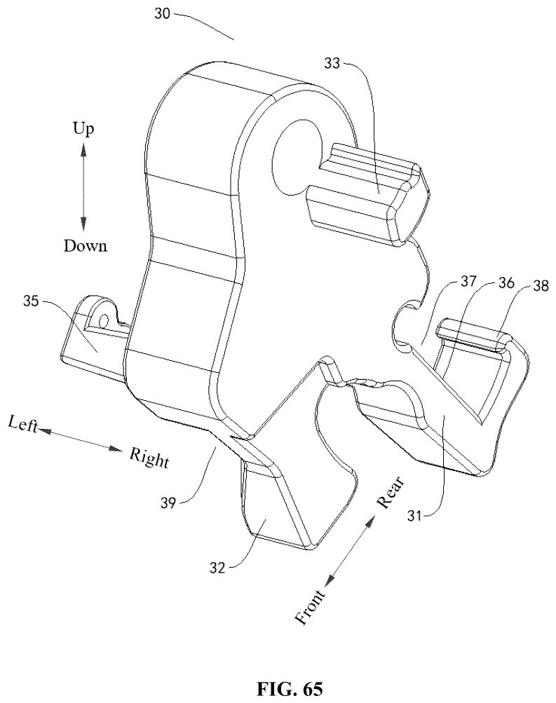

In some embodiments of the present disclosure, as shown in FIGS. 65, 66, and 77, in the rotation axis of the first lever 30, the second drive arm 32 may have a thinned region 39 on at least one side surface of the second drive arm 32. For example, the thinned region 39 may be a groove with a notch at the second drive arm 32. The predetermined gap 55 can be formed between at least part of the second drive arm 32 and the inner wall of the mounting space 204 by providing the thinned region 39. In addition, the thinned region 39 is disposed on at least one side surface of the second drive arm 32, rather than the inner wall of the mounting space 204, which can effectively reduce processing difficulty. For example, it is easier to process thinned regions 39 of different shapes based on different models of microwave ovens 1000 to form different predetermined gaps 55 to meet different actual use requirements.

The thinned region 39 may be disposed at a side of the second drive arm 32, or may be disposed at each of two sides of the second drive arm 32, which is not specially limited in the embodiments of the present disclosure.

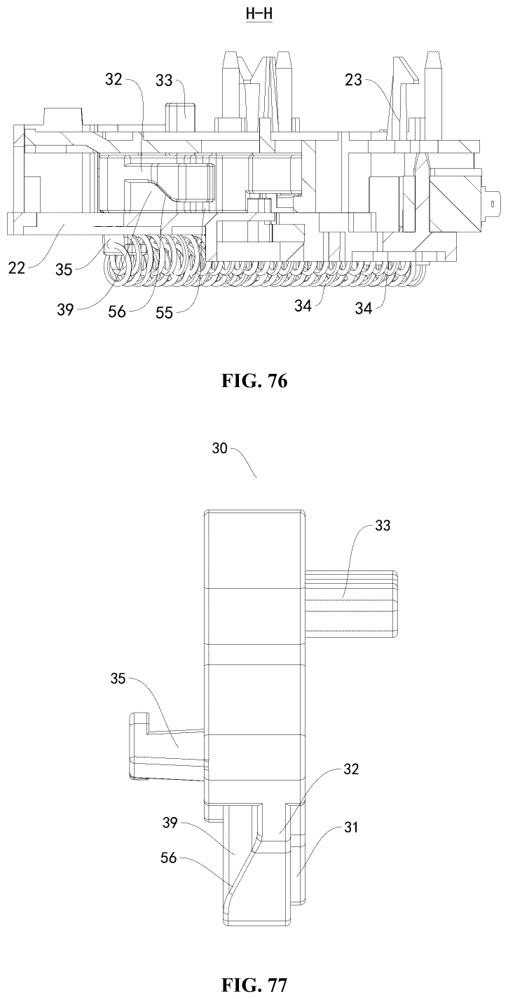

In order to enable the first door hook 11 to pass through the predetermined gap 55 more smoothly, in some embodiments, as shown in FIGS. 76 and 77, the thinned region 39 may have an inclined surface facing towards the inner wall of the mounting space 204, and the inclined surface extends towards the inner wall of the mounting space 204 in a door-closing movement direction of the first door hook 11. Therefore, taking the front-to-rear door-closing direction as an example, a front end of the predetermined gap 55 (i.e., an end facing away from the first drive arm 31) has a larger gap size, and a rear end of the gap 55 (i.e., an end close to the first drive arm 31) has a smaller gap size. As a result, the first door hook 11 can more smoothly and easily extend into the predetermined gap 55. Moreover, the predetermined gap 55 can guide the extension of the first door hook 11, and thus the first door hook 11 can more smoothly move to the position between the first drive arm 31 and the second drive arm 32. As a result, the microwave oven 1000 can smoothly restore its normal door-closing effect.

In addition, in some embodiments of the present disclosure, as shown in FIGS. 36 and 37, an end of the first door hook 11 may have a thickness gradually decreasing in the door-closing movement direction of the first door hook 11. As a result, a rear end of the first door hook 11 as shown in FIG. 36 can have a smaller thickness and a front end of the first door hook 11 can have a larger thickness. For example, when the monitoring switch 201 is accidentally triggered by the first lever 30, it is easier for the first door hook 11 to move to the position between the first drive arm 31 and the second drive arm 32 from the predetermined gap 55 with the structure of the first door hook 11 with the thick front end and the thin rear end. In this way, the abnormal triggering problem is easily solved.

The manner in which the thickness of the end of the first door hook 11 gradually decreases is not specially limited in the embodiments of the present disclosure. In some embodiments, as shown in FIG. 37, the first door hook 11 has an inclined side surface facing towards the second drive arm 32 in a thickness direction of the first door hook 11, that is, the structure with the gradually decreasing thickness is formed by providing the inclined surface. Moreover, the inclined surface of the first door hook 11 extends away from the second drive arm 32 in the door-closing movement direction of the first door hook 11. By providing the inclined surface, the structure can be formed at the end of the first door hook 11, in which the rear end has the smaller thickness and the front end has the larger thickness. Meanwhile, the inclined surface can allow the first door hook 11 to more smoothly extend into the predetermined gap 55, without applying an excessive force to the first door hook 11. In this way, it is easier for the first door hook 11 to extend into the predetermined gap 55.

In some exemplary embodiments, as shown in FIGS. 37 and 77, the thinned region 39 has a first inclined surface 56 facing towards a corresponding inner wall of the mounting space 204, and the first door hook 11 has a second inclined side surface 57 facing towards the second drive arm 32 in a thickness direction of the first door hook 11. The first inclined surface 56 may be matched with the second inclined side surface 57. Thus, the first inclined surface 56 can better guide the second inclined side surface 57, and the first door hook 11 can move more smoothly to the position between the first drive arm 31 and the second drive arm 32 through the predetermined gap 55 to realize the normal door-closing effect.

According to some embodiments of the present disclosure, at least one of the first door hook 11 and the second drive arm 32 may be made of plastic. For example, the first door hook 11 may be made of plastic, or the second drive arm 32 may be made of plastic, or both the first door hook 11 and the second drive arm 32 may be made of plastic. Specifically, the plastic has properties of easy elastic deformation and easy processing, and thus processing accuracy for the predetermined gap 55 can be reduced. For example, even if the predetermined gap 55 is slightly smaller than the thickness of the first door hook 11, the first door hook 11 can also easily pass through the predetermined gap 55 by generating elastic deformation.

In some embodiments of the present disclosure, when the first lever 30 has rotated after being accidentally triggered and the door 200 cannot be closed, by applying a force to the door 200 towards the body, the front end of the first door hook 11 made of the plastic can be bent and deformed to make the process of extending into the predetermined gap 55 smoother, and quickly pass through the predetermined gap 55 to move to the position between the first drive arm 31 and the second drive arm 32 to enter a position after the door 200 is normally closed.

According to some embodiments of the present disclosure, as shown in FIGS. 39, 58, and 59, the switch component may include a first micro switch 202, a second micro switch 203, and a monitoring switch 201. In a specific operation process, the monitoring switch 201, the first micro switch 202, and the second micro switch 203 are sequentially triggered to ensure that the microwave oven 1000 can be powered on and operate normally.

In some embodiments of the present disclosure, the interlocking device 100 may further include a second lever 40 rotatably mounted at the interlocking bracket 20. The second lever 40 may include a first rotary arm 41 provided with a first cooperation portion 45, and a second rotary arm 42 provided with a second cooperation portion 44 and a third cooperation portion 46. Moreover, the first rotary arm 41 and the second rotary arm 42 are sequentially arranged around a rotation axis of the second lever 40 in a second direction (clockwise direction as shown in FIG. 39). On the one hand, it is beneficial to orderly triggering of the micro switches at the interlocking bracket 20 to avoid a disorder in a triggering sequence. On the other hand, it is beneficial to a reasonable arrangement of the micro switches at the interlocking bracket 20 to realize compactness of the body structure of the microwave oven 1000.

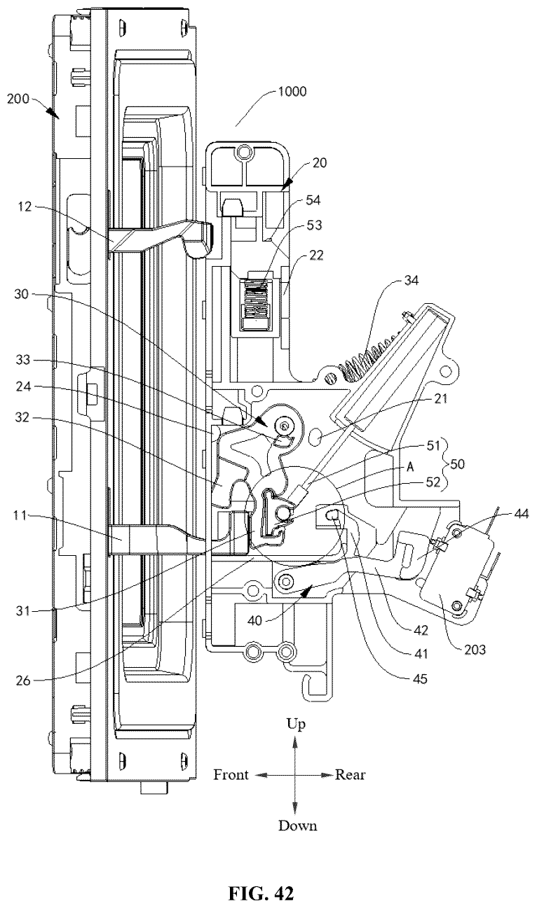

During closing of the door of the microwave oven 1000, as shown in FIGS. 42 to 47, the first door hook 11 is adapted to move in a door-closing direction to abut against the first cooperation portion 45 to drive the second lever 40 to rotate in the second direction, allowing the third cooperation portion 46 to trigger the second micro switch 203 after the first micro switch 202 is triggered by the second cooperation portion 44. In this way, the orderly triggering of the first micro switch 202 and the second micro switch 203 can be realized, which is used to detect the opening and closing states of the door 200 to ensure that the microwave oven 1000 can operate normally, thus avoiding the disorder in the triggering sequence of the micro switches, and avoiding a safety hazard to the microwave oven 1000 due to the disorder of the triggering sequence of the micro switches.

Each of the first micro switch 202 and the second micro switch 203 may be provided with a resilient sheet, and the second cooperation portion 44 and the third cooperation portion 46 are respectively configured to trigger the first micro switch 202 and the second micro switch 203 through the elastic sheet. To ensure the triggering sequence, the micro switches at the interlocking bracket 20 should be reasonably arranged, and an angle of each of the resilient sheet of the first micro switch 202 and the second cooperation portion 44 relative to the rotation axis of the second lever 40 should be smaller than an angle of each of the resilient sheet of the second micro switch 203 and the third cooperation portion 46 relative to the rotation axis of the second lever 40.

For example, as shown in FIGS. 18, 19, and 42 to 47, the door 200 is rotatably mounted at the body about a vertically extending rotation axis. During the closing of the door, the door 200 rotates to allow the first door hook 11 to move backwards relative to the interlocking bracket 20 in a front-rear direction shown in FIG. 42. During the movement, the first door hook 11 is first in contact with the first cooperation portion 45 to drive the second lever 40 to rotate in a second direction (clockwise direction as shown in FIG. 42). After the second lever 40 starts to rotate, the second cooperation portion 44 and the third cooperation portion 46 also rotate in the second direction by the same angle. Through the reasonable arrangement of the first micro switch 202 and the second micro switch 203 at the interlocking bracket 20, the second cooperation portion 44 may be in contact with the first micro switch 202 to trigger the first micro switch 202 when the second lever 40 rotates to a first predetermined angle. When the second lever 40 continues to rotate to a second predetermined angle, the third cooperation portion 46 is in contact with the second micro switch 203 to trigger the second micro switch 203. Thus, the orderly triggering of the first micro switch 202 and the second micro switch 203 is realized.

In the related art, the microwave oven without a soft close design adopts an integral door hook, and the door is in direct contact with a door frame. There is a lack of effective buffer design during a contact period. Therefore, door-closing noise increases sharply when a user closes the door with a relatively large force, seriously affecting user experience.

In the present disclosure, since the first cooperation portion 45, the second cooperation portion 44, and the third cooperation portion 46 are sequentially arranged in the second direction. That is, projections of the first cooperation portion 45, the second cooperation portion 44, and the third cooperation portion 46 on a cross section perpendicular to an axis of the second lever 40 are sequentially offset, the orderliness of triggering the first micro switch 202 and the second micro switch 203 can be realized. Moreover, on the one hand, when the corresponding micro switches are triggered by the second cooperation portion 44 and the third cooperation portion 46, the second cooperation portion 44 and the third cooperation portion 46 are subjected to large torque, that is, resistance during the closing of the door is large. When the user slams the door, the buffered door-closing effect can be exerted by increasing an arm length of the second rotary arm 42, avoiding a violent collision between the door 200 and the body during the closing of the door, which in turn facilitates reducing the door-closing noise. In this way, the user experience is improved. On the other hand, when rotating by the same angle, the longer second rotary arm 42 traces a longer arc during the rotation. The door 200 only needs to move a small distance when the door is opened to quickly disengage the second cooperation portion 44 and the third cooperation portion 46 from the micro switches. Therefore, the microwave oven 1000 stops operating. Thus, the microwave leakage can be effectively reduced when the door is opened. As a result, the safety of using the microwave oven 1000 is increased.

According to some embodiments of the present disclosure, as shown in FIGS. 62 to 64, an angle of the first cooperation portion 45 and the second cooperation portion 44 relative to the rotation axis of the second lever 40 may be a, and an angle of the second cooperation portion 44 and the third cooperation portion 46 relative to the rotation axis of the second lever 40 may be β, in which α>β. In this way, the first door hook 11 can be allowed to be in contact with the first cooperation portion 45 more quickly to drive the second lever 40 to rotate more quickly.

In some embodiments of the present disclosure, an angle a of the first cooperation portion 45 and the second cooperation portion 44 relative to the rotation axis of the second lever 40 and an angle β between the second cooperation portion 44 and the third cooperation portion 46 may cooperate with the micro switches at the interlocking bracket 20 to realize the orderly triggering effect. As a result, the safety hazard to the microwave oven 1000 due to the disorder in the triggering sequence is avoided.

In some embodiments of the present disclosure, during the closing of the door, since α>β, α is reasonably increased when β is constant. Thus, a distance between the first cooperation portion 45 and the first door hook 11 is smaller. As a result, the first door hook 11 can be in contact with the first cooperation portion 45 faster to drive the second lever 40 to rotate. Further, the second cooperation portion 44 and the third cooperation portion 46 can trigger the corresponding micro switches faster to bring the microwave oven 1000 into an operating state. Thus, the user's waiting time during an operation is saved.

During the opening of the door, since β<α, β is reasonably reduced when α is constant. Thus, the angle of each of the second cooperation portion 44 and the third cooperation portion 46 relative to the rotation axis of the second lever 40 is smaller. As a result, the third cooperation portion 46 and the second cooperation portion 44 can be sequentially disengaged from the corresponding micro switches faster. Therefore, the microwave oven 1000 can stop operating faster. Thus, the microwave leakage during the opening of the door can be effectively reduced. In this way, the use of the microwave oven 1000 is safer.

With continued reference to FIGS. 62 to 64, according to some embodiments of the present disclosure, a spacing between the first cooperation portion 45 and the rotation axis of the second lever 40 may be smaller than a spacing between the second cooperation portion 44 and the rotation axis of the second lever 40 and smaller than a spacing between the third cooperation portion 46 and the rotation axis of the second lever 40. In this way, on the one hand, the second cooperation portion 44 and the third cooperation portion 46 can be disengaged from the corresponding micro switches more quickly during the opening of the door, effectively reducing the microwave leakage. On the other hand, it is conducive to reducing the door-closing noise with greatly improved user experience.

Specifically, when the spacing between the first cooperation portion 45 and the rotation axis of the second lever 40 is constant, a spacing among the second cooperation portion 44, the third cooperation portion 46, and the rotation axis of the second lever 40 may be reasonably increased. Thus, when the second lever 40 rotates by the same angle, the second cooperation portion 44 and the third cooperation portion 46 during the rotation of the second lever 40 traces a longer arc. In this case, the first door hook 11 only needs to move a small distance to disengage the second cooperation portion 44 and the third cooperation portion 46 from the corresponding micro switches. In this way, a duration required to disconnect the corresponding micro switches is shorter. Thus, the microwave leakage during the opening of the door of the microwave oven 1000 can be effectively reduced.

Moreover, during the closing of the door, torque applied to the second cooperation portion 44 and the third cooperation portion 46 when triggering the micro switches corresponding thereto is large, and therefore the buffered door-closing effect can be exerted by reasonably increasing a spacing among the second cooperation portion 44, the third cooperation portion 46, and the second lever 40. Therefore, the door 200 can be effectively avoided from violently colliding with the body during the closing of the door, which is beneficial to reducing the noise during the closing of the door. Thus, the user experience is improved.

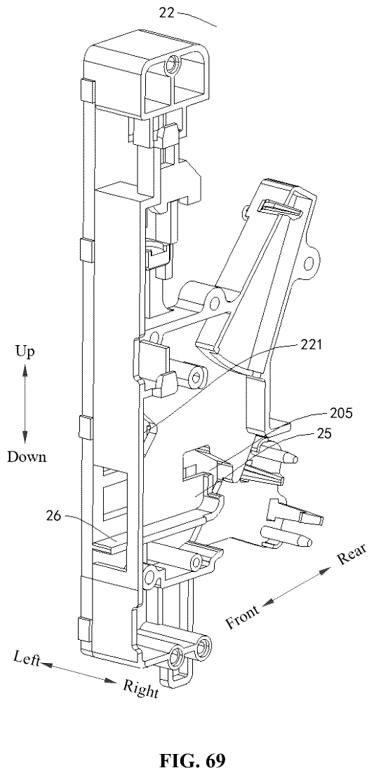

According to some embodiments of the present disclosure, as shown in FIGS. 69 to 71, the interlocking bracket 20 may have a mounting space 204, and an avoidance recess 205 is formed at a side wall of the mounting space 204. The first rotary arm 41 may be located in the avoidance recess 205, which can effectively prevent the second lever 40 from rotating after elongated objects or fingers are inserted into the mounting space 204 in the door-closing direction and in contact with the first rotary arm 41, thereby avoiding the first micro switch 202 and the second micro switch 203 from being inadvertently triggered.

Moreover, the first cooperation portion 45 may extend into the mounting space 204, and the first door hook 11 is adapted to extend into the mounting space 204 and movable in the mounting space 204 in the door-closing direction to close the microwave oven 1000. During the movement of the first door hook 11, the first door hook 11 may be in contact with the first cooperation portion 45 extending into the mounting space 204 to drive the second lever 40 to rotate.

Since the first cooperation portion 45 may be flexibly disposed at the first rotary arm 41 based on actual needs, by changing the position of the first cooperation portion 45 at the first rotary arm 41, it can be ensured that the first door hook 11 is in contact with the first cooperation portion 45 to drive the second lever 40 to rotate, and other elongated objects such as fingers are not easy to be in contact with the first cooperation portion 45 in the mounting space 204, which can effectively avoid objects other than the first door hook 11 contacting the first cooperation portion 45 and inadvertently triggering the micro switch, thereby ensuring the safety of using the microwave oven 1000.

In some embodiments, the first cooperation portion 45 is located at a side surface of a top of the first rotary arm 41. On the one hand, this can effectively avoid position interference between the first cooperation portion 45 and other components in the mounting space 204. On the other hand, this can avoid the second lever 40 rotating due to other elongated objects contacting the first cooperation portion 45. In this way, safety performance of the microwave oven 1000 is better.

In some embodiments where the interlocking bracket 20 includes a bracket body 22 and a cover 23, as shown in FIGS. 1, 39, and 69 to 73, the cover 23 covers the bracket body 22 to allow the cover 23 to be fit with the bracket body 22 to define the mounting space 204. Referring to FIGS. 1 and 39, the first micro switch 202 is disposed at a side of the cover 23 facing away from the bracket body 22, and the second micro switch 203 is disposed in the mounting space 204. The cover 23 may further have a second through hole 232, and the second cooperation portion 44 of the second lever 40 may pass through the second through hole 232 to extend to the side of the cover 23 facing away from the bracket body 22. During rotation of the second lever 40, the second cooperation portion 44 rotates with the second lever 40 in the second through hole 232 to easily trigger the first micro switch 202 located outside the mounting space 204. The third cooperation portion 46 is located in the mounting space 204 and can trigger the second micro switch 203 located in the mounting space 204. The first micro switch 202 and the second micro switch 203 are located at different sides of the cover 23 and thus do not interfere with each other. For example, projections of the first micro switch 202 and the second micro switch 203 in an axial direction of the second lever 40 may at least partially overlap, allowing the arrangement of the two micro switches to be more compact and the sequential triggering of the two micro switches by the second lever 40 to be quicker.

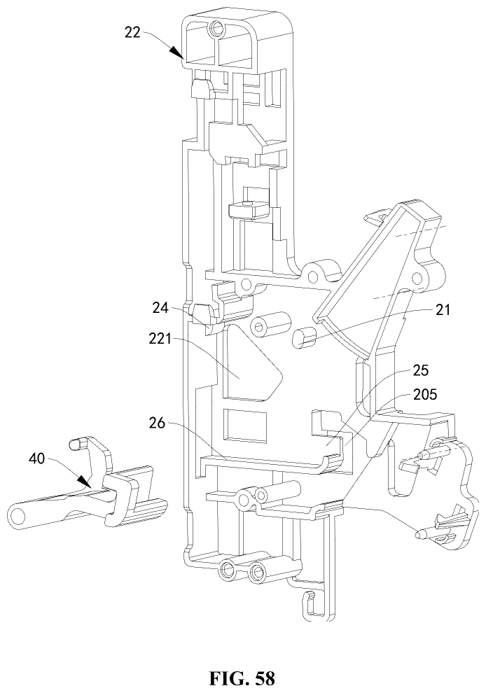

According to some embodiments of the present disclosure, as shown in FIGS. 58, 59, and 69 to 71, the interlocking bracket 20 may include a first baffle 25 that may partially block a communication opening between the avoidance recess 205 and the mounting space 204. In this way, the first baffle 25 can prevent the second lever 40 from rotating due to the fingers or other objects touching the first rotary arm 4 while limiting a position of the first rotary arm 41.

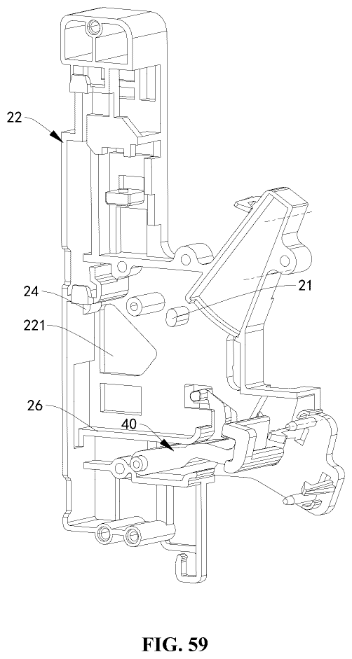

In some embodiments of the present disclosure, as shown in FIG. 59, the first rotary arm 41 may be displaced along a rotation axis of the first rotary arm 41 in the avoidance recess 205. On the one hand, it cannot ensure a stable rotation state of the lever. On the other hand, if part or all of the first rotary arm 41 moves out of the avoidance recess 205, the fingers or other elongated objects would drive the second lever 40 through the first rotary arm 41 without any obstruction, and the risk of rotating the second lever 40 due to the accidental touching still exists. By providing the first baffle 25 to partially block the communication opening between the avoidance recess 205 and the mounting space 204, the first rotary arm 41 can be stably positioned in the avoidance recess 205 and cannot be moved to the mounting space 204. In this way, the accidental touch of the first rotary arm 41 by the fingers is avoided. Meanwhile, the first baffle 25 can also limit the position of the rotary arm 41 and guide the first rotary arm 41. When the first door hook 11 abuts against the first cooperation portion 45 to drive the second lever 40 to rotate, the first baffle 25 may mate with a side surface of the interlocking bracket 20 facing towards the first rotary arm 41 to form a matching groove. In this case, the first rotary arm 41 can rotate smoothly in the matching groove to avoid misalignment of the second cooperation portion 44, the third cooperation portion 46, and their corresponding micro switches, which could otherwise lead to a failure in accurately triggering of the corresponding micro switches, and thus avoid the operating state of the microwave oven 1000 being affected due to the failure in accurately triggering of the micro switches.

The communication opening between the avoidance recess 205 and the mounting space 204 is partially blocked by the first baffle 25, rather than being completely blocked. If the communication opening is completely blocked by the first baffle 25, the first rotary arm 41 cannot enter the avoidance space through the communication opening. However, with the first baffle 25 partially blocking the communication opening, the mounting of the first rotary arm 41 is facilitated while avoiding the accidental touch and providing the position limiting effect, which can effectively save labor time and improve assembling efficiency.

According to some embodiments of the present disclosure, as shown in FIGS. 58, 59, 69, and 70, the interlocking bracket 20 may have a mounting space 204. The second rotary arm 42 is located in the mounting space 204. A second baffle 26 is disposed in the mounting space 204. At least part of the second baffle 26 may extend in the door-closing direction and is located between a rotary shaft of the second lever 40 and the first door hook 11. In this way, it is possible to limit a position of the first door hook 11 and guide the first door hook 11 on the one hand, for a part of the second baffle 26 can serve as a track for a movement of the first door hook 11. The first door hook 11 moves on the part of the second baffle 26 in the door-closing direction, and then accurately abuts against the first cooperation portion 45 to drive the second lever 40 to rotate. On the other hand, the part is located between the rotary shaft and the first door hook 11, which is beneficial to avoiding the accidental triggering of the micro switch caused by the fingers touching the rotary shaft of the second lever 40.

In some embodiments where at least part of the second baffle 26 extends in the door-closing direction, the second baffle 26 further includes an arc segment located at a tip of the second baffle 26 and extending in an upward direction as shown in FIG. 69. The second baffle 26 may have a cross section perpendicular to the rotation axis, which is in a slide shape. Moreover, in the door-closing direction, the second baffle 26 is offset from the second rotary arm 42, and the arc segment of the second baffle 26 is located at a position of the second rotary arm 42 close to the first door hook 11. The arc segment of the second baffle 26 can stop the foreign objects such as the fingers entering the mounting space 204, ensuring that the second rotary arm 42 is not touched by the foreign objects such as the fingers.

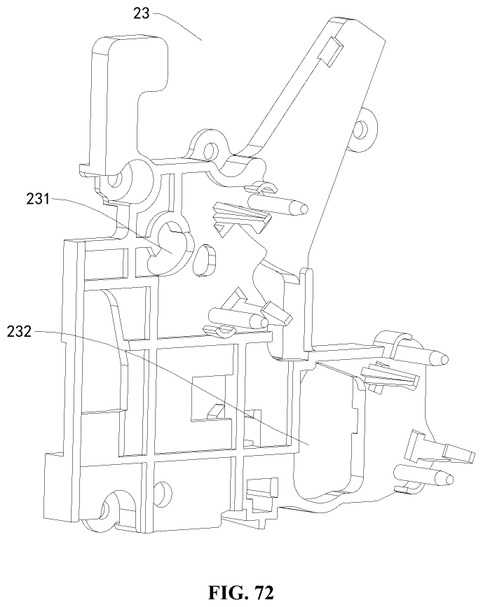

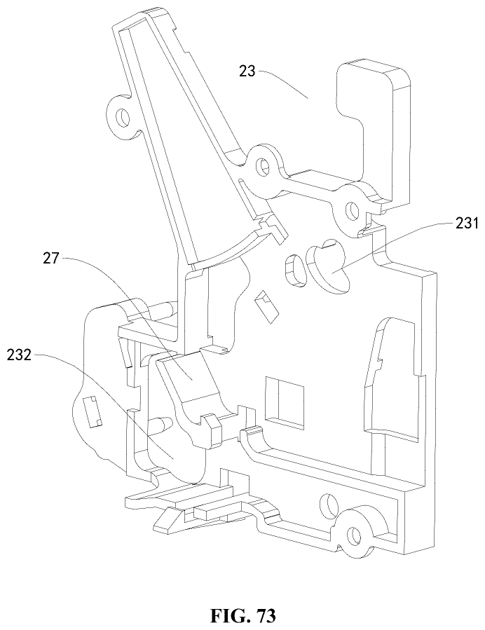

According to some embodiments of the present disclosure, as shown in FIGS. 72 and 73, the interlocking bracket 20 may have a mounting space 204. The second rotary arm 42 is located in the mounting space 204. A third baffle 27 is disposed in the mounting space 204 and located at a side of the second rotary arm 42 close to the first door hook 11. In this way, it is possible to prevent the fingers or other objects from contacting the second rotary arm 42 and avoid the second rotary arm 42 from being inadvertently touched, which would otherwise drive the second lever 40 to rotate and thus affect the safety of the microwave oven 1000.

In some embodiments of the present disclosure, the third baffle 27 at least partially overlaps with a projection of the door hook in the door-closing direction. Moreover, the third baffle 27 is closer to the first door hook 11 than the second rotary arm 42 in the door-closing direction, and thus the third baffle 27 can stop the foreign objects such as the fingers.

In some embodiments where the interlocking bracket 20 includes a bracket body 22 and a cover 23, at least one of the bracket body 22 and the cover 23 is provided with a third baffle 27. That is, the third baffle 27 may be disposed at the bracket body 22 or at the cover 23, or both the bracket body 22 and the cover 23 are provided with a third baffle 27 to prevent the fingers or the other objects from inadvertently touching the second rotary arm 42.

According to some embodiments of the present disclosure, as shown in FIGS. 1, 6, and 65 to 68, the interlocking device 100 further includes a monitoring switch 201 and a first lever 30. The monitoring switch 201 is disposed at the interlocking bracket 20, the first lever 30 is rotatably disposed at the interlocking bracket 20, and the first door hook 11 is configured to drive the first lever 30 to rotate in a first direction prior to driving the second lever 40 to rotate to trigger the monitoring switch 201. Therefore, the orderly triggering of the monitoring switch 201, the first micro switch 202, and the second micro switch 203 can be realized.

During closing of the door, the first door hook 11 is first in contact with the first lever 30 at the interlocking bracket 20 to drive the first lever 30 to rotate in a first direction (counterclockwise direction as shown in FIG. 1), and the monitoring switch 201 is triggered by the first lever 30 when the first lever 30 rotates to a predetermined angle. Then, the first door hook 11 is in contact with the second lever 40 to drive the second lever 40 to rotate in the first direction (clockwise direction as shown in FIG. 1). The first micro switch 202 is triggered by the second lever 40 when the second lever 40 rotates to the first predetermined angle, and the second micro switch 203 is triggered by the second lever 40 when the second lever 40 continues to rotate to a second predetermined angle. Thus, the monitoring switch 201, the first micro switch 202, and the second micro switch 203 are sequentially triggered in an orderly manner.

According to some embodiments of the present disclosure, as shown in FIGS. 65 to 68, the first lever 30 may include a first drive arm 31. The first drive arm 31 may be provided with a fourth cooperation portion 33. The fourth cooperation portion 33 is configured to drive the monitoring switch 201.

The arrangement position of the fourth cooperation portion 33 at the first drive arm 31 may be flexibly provided based on actual conditions such as a space layout. For example, in a length direction of the first drive arm 31, the fourth cooperation portion 33 may be disposed at any position such as a middle part or an end of the first drive arm 31.

In some embodiments, the fourth cooperation portion 33 may be a protrusion disposed at a side of the first drive arm 31 in an axial direction of the first drive arm 31. Therefore, the fourth cooperation portion is not interfered by the first drive arm 31 during cooperation between the fourth drive portion and the monitoring switch 201. As a result, the risk of the first drive arm 31 inadvertently touching the monitoring switch 201 is avoided.

In some embodiments where the mounting space 204 is defined by the bracket body 22 and the cover 23, as shown in FIGS. 1, 6, 72, and 73, the monitoring switch 201 is disposed at a side of the cover 23 facing away from the bracket body 22, the cover 23 has a first through hole 231, and the first lever 30 is provided with a fourth cooperation portion 33. The fourth cooperation portion 33 is configured to pass through the first through hole 231 to extend to the side of the cover 23 facing away from the bracket body 22. During rotation of the first lever 30, the fourth cooperation portion 33 rotates with the first lever 30 in the first through hole 231 to facilitate triggering of the monitoring switch 201. The monitoring switch 201 may be disposed outside the mounting space 204 to avoid position interference with components in the mounting space 204, such as the door-closing buffer assembly 50. In this way, the position arrangement is more reasonable.

Moreover, as shown in FIGS. 65 to 68, the first lever 30 may further include a second drive arm 32 located at a side of the first drive arm 31 close to the first door hook 11. That is, the first drive arm 31 is located at a leading side of the second drive arm 32 in the first direction.

The first door hook 11 is adapted to abut against the first drive arm 31 to drive the first lever 30 to rotate. As shown in FIGS. 42 to 47, during the closing of the door, the first door hook 11 can abut against the first drive arm 31 to drive the first drive arm 31 to rotate about the rotation axis of the first lever 30 in the first direction to drive the fourth cooperation portion 33 to rotate, allowing the fourth cooperation portion 33 to rotate to the position of triggering the monitoring switch 201 to open the monitoring switch 201.

As shown in FIGS. 6, 9, and 48 to 50, the first cooperation portion 45 is located between the first drive arm 31 and the second drive arm 32 when the door is closed, which can ensure that the first cooperation portion 45 is not touched by the fingers or the other objects. In some embodiments of the present disclosure, when the fingers or the other objects are inserted into the mounting space 204, the first drive arm 31 may be first touched, allowing the first lever 30 to rotate in the first direction. However, as the first lever 30 rotates, the second drive arm 32 may positionally interfere with the fingers, etc., preventing continuous insertion of the fingers. Thus, the first cooperation portion 45 of the second lever 40 cannot be touched. Therefore, the second lever 40 cannot be touched to rotate. As a result, neither the first micro switch 202 nor the second micro switch 203 is triggered. In contrast, when the first door hook 11 is inserted into the mounting space 204, since the first door hook 11 is provided with a recessed portion to avoid the second drive arm 32, the second drive arm 32 cannot prevent the continuous insertion of the first door hook 11, and the first door hook 11 can touch the first cooperation portion 45 to drive the second lever 40 to rotate.

In some embodiments of the present disclosure, in an axial direction of the first lever 30, the first drive arm 31 and the first cooperation portion 45 may be separated by a predetermined gap to ensure that the first drive arm 31 is not in contact with the first cooperation portion 45 when the first drive arm 31 rotates to the position of the first cooperation portion 45 in the first direction, which in turn cannot drive the second lever 40 to rotate. In this way, an abnormal situation that the door 200 is not completely closed and the monitoring switch 201 and the micro switch are both triggered is prevented.

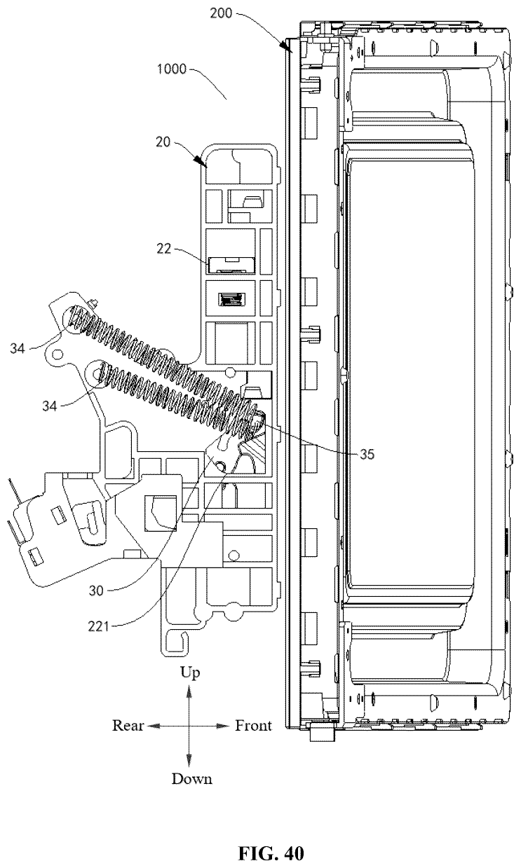

According to some embodiments of the present disclosure, as shown in FIGS. 1, 39 to 40, and 53 to 55, the interlocking device 100 further includes an elastic component 34 connected to the interlocking bracket 20 and the first lever 30. For example, the elastic component 34 may be one or more coil springs. For example, in an example shown in FIG. 53, the elastic component 34 is two tension springs. As shown in FIG. 40, the first lever 30 is provided with a connection portion 35 that is a protrusion disposed at a side of the first lever 30 facing away from the fourth cooperation portion 33. Each of the two tension springs has an end connected to the interlocking bracket 20 and another end connected to the connection portion 35, and ends of the two tension springs connected to the interlocking bracket 20 are spaced by a predetermined distance.

In addition, the elastic component 34 has a first driving state. The elastic component 34 is configured to, in the first driving state, apply a driving force to the first lever 30 to rotate in the first direction, allowing the second drive arm 32 to drive the first door hook 11 to move in the door-closing direction.

In some embodiments of the present disclosure, as shown in FIGS. 42 to 47, during the closing of the door, the first door hook 11 moves to a position between the first drive arm 31 and the second drive arm 32 in the door-closing direction to abut against the first drive arm 31 to drive the first lever 30 to start to rotate in the first direction. When the first lever 30 starts to rotate in the first direction or after the first lever 30 rotates by a relatively small angle, the elastic component 34 is in the first driving state to automatically drive the first lever 30 to rotate in the first direction, allowing the second drive arm 32 to drive the first door hook 11 to continue to move in the door-closing direction, to realize an automatic door-closing effect. In this case, even if the user releases the door-closing force applied to the door 200, it can be ensured that the door 200 is closed in place, and that the first door hook 11 can move in the door-closing direction until all the three switch components are triggered. In this way, it is labor-saving and convenient for the user to operate on the one hand, and a problem of incomplete door-closing can be avoided on the other hand.

In some embodiments, the elastic component 34 has a second driving state. The elastic component 34 is configured to, in the second driving state, apply a driving force to the first lever 30 to rotate in the second direction. The first door hook 11 can abut against the first drive arm 31 during the closing of the door, allowing the elastic component 34 to be switched to the first driving state from the second driving state.

In some embodiments of the present disclosure, when the door is opened, the first lever 30 can be maintained at a desired position under the action of the elastic component 34. In this way, on the one hand, it is possible to prevent the rotation of the first lever 30 in the second direction without the action of the first door hook 11, which would otherwise inadvertently trigger the monitoring switch 201. On the other hand, it can be ensured that the first door hook 11 can smoothly move to the position between the first drive arm 31 and the second drive arm 32 during the closing of the door, avoiding the rotation of the first lever 30, which would otherwise affect the cooperation between the first door hook 11 and the first lever 30. Moreover, since the first door hook 11 abuts against the first drive arm 31 to drive the first lever 30 to rotate in the first direction, the elastic component 34 is switched between the driving states timely with the rotation of the first lever 30, ensuring that the elastic component 34 can timely drive the door to be closed.

The elastic component 34 is in the first driving state when the door is closed. In this case, the first lever 30 can abut against the first door hook 11 by the second drive arm 32, ensuring that the door 200 remains to be closed. When the door needs to be opened, the user controls the first door hook 11 to move in the door opening direction to abut against the second drive arm 32, allowing the first lever 30 to rotate in the second direction. When the first lever 30 rotates to a predetermined angle, the elastic component 34 is switched to the second driving state from the first driving state, and therefore the elastic component 34 can drive the first lever 30 to rotate in the first direction and timely release resistance against the first door hook 11. As a result, the door 200 can be easily opened.

In some embodiments where the elastic component 34 is a spring, the spring constantly remains in a stretched state regardless of the first driving state or the second driving state.

According to some embodiments of the present disclosure, as shown in FIGS. 42 to 47 and 69 to 71, the interlocking bracket 20 may be provided with a first limit portion 21. The first limit portion 21 can abut against the first lever 30 when the door is closed to prevent the first lever 30 from rotating in the first direction. That is, the first limit portion 21 can limit an extreme position of the first lever 30 rotating in the first direction to avoid the first lever 30 rotating at an excessive angle and causing damage to the monitoring switch 201 or the first door hook 11.

For example, in some embodiments where an elastic component 34 is included, the elastic component 34 drives the first lever 30 to rotate in the first direction to drive the first door hook 11 to move in the door-closing direction to achieve an automatic door-closing action. When the first lever 30 rotates to abut against the first limit portion 21, the first lever 30 is balanced in force under the position limiting of the limit portion, and does not continue to rotate under the driving of the elastic component 34. In this case, the first lever 30 can be maintained in a position where it is stably engaged with the first door hook 11 and the door 200 is kept closed.

According to some embodiments of the present disclosure, as shown in FIGS. 39, 69, and 70, the interlocking bracket 20 may be provided with a second limit portion 24. The second limit portion 24 can abut against the first lever 30 when the door is opened to prevent the first lever 30 from rotating in the second direction. That is, the second limit portion 24 can limit an extreme position of the first lever 30 rotating in the second direction to prevent the first lever 30 rotating in the second direction at an excessive angle, which would otherwise result in position interference. Therefore, the first door hook 11 is prevented from failing to be in contact with and engaged with the first lever 30 normally during the closing of the door. Thus, the user experience is prevented from being affected.

According to some embodiments of the present disclosure, as shown in FIGS. 40, 50, 53 to 55, 60, and 61, the interlocking device 100 may further include a door-closing buffer assembly 50. The interlocking bracket 20 is connected to the first lever 30 by the door-closing buffer assembly 50, for example, the door-closing buffer assembly 50 is connected to the first drive arm 31 of the first lever 30.

The door-closing buffer assembly 50 is configured to apply a buffering force to the first lever 30 during the closing of the door in an opposite direction to the first direction, to allow for a buffered door-closing effect. In this way, a violent collision between the door 200 and the body is avoided during the closing of the door, and door-closing noise is advantageously reduced.

The structure of the door-closing buffer assembly 50 is not specifically limited in the present disclosure, as long as the buffered door-closing effect can be satisfied. For example, the door-closing buffer assembly 50 may include a damper, a spring plate, or a compression spring, etc.

For example, in some exemplary embodiments, referring to FIGS. 53 to 55 and FIGS. 60 and 61, the door-closing buffer assembly 50 includes a buffer 51 and a connector 52. An end of the buffer 51 is rotatably connected to the interlocking bracket 20, and another end of the buffer 51 is rotatably connected to the first lever 30 (such as the first drive arm 31) by the connector 52. As a result, the buffer 51 can provide a buffering effect during the rotation of the first lever 30, and the rotatable connection structure can adapt to the rotation of the first lever 30 to avoid jamming.

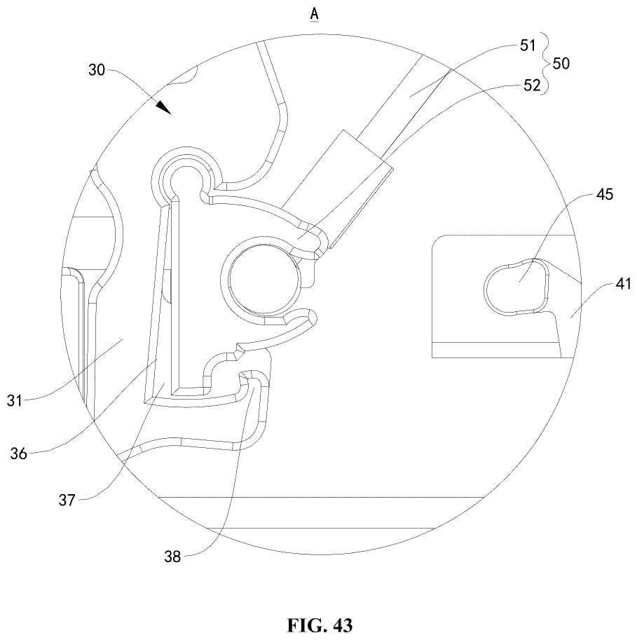

In addition, referring to FIGS. 43, 45, 47, and 49, the first lever 30 has a drive surface 36, and the connector 52 is rotatably mounted at the first lever 30. Moreover, as shown in FIG. 43, the connector 52 is at a predetermined angle with the drive surface 36 when the door is opened, and another end of the buffer 51 is rotatably connected to the connector 52. During the opening of the door, after the first lever 30 rotates by the predetermined angle in the first direction, the drive surface 36 can abut against the connector 52 to drive the connector 52 to rotate.

Since the connector 52 and the drive surface 36 are arranged at the predetermined angle when the door is opened, when the first door hook 11 is just in contact with the first lever 30 to drive the first lever 30 to rotate in the first direction, the buffer 51 cannot apply a buffering force to the first lever 30. As a result, it is easier for the first door hook 11 to drive the first lever 30 to rotate.

In some exemplary embodiments, as shown in FIGS. 43 and 65 to 67, the first drive arm 31 of the first lever 30 has a recess 37 at a side of the first drive arm 31 of the first lever 30 facing towards the door-closing buffer assembly 50. A bottom wall surface of the recess 37 is formed into the drive surface 36. The recess 37 has a side surface connected to the connector 52 through a hole-and-shaft fit and another side surface provided with a hook 38 that is spaced apart from the drive surface 36 by a predetermined distance. The buffer 51 is a damper connected to the connector 52 through a hole-and-shaft fit at an opening of the recess 37. The interlocking device 100 further includes an elastic component 34 connected to the first lever 30.

The elastic component 34 applies a driving force to the first lever 30 to rotate in the second direction when the door is opened, and therefore the first door hook 11 can smoothly move to abut against the first drive arm 31 of the first lever 30. In this case, a predetermined angle is formed between the connector 52 and the drive surface 36, and therefore the damper does not generate a buffering force. During the closing of the door, the first door hook 11 is in contact with the first drive arm 31 of the first lever 30 to drive the first lever 30 to rotate in the first direction. Since the damper has no buffering force, the first door hook 11 only needs to overcome the driving force of the elastic component 34 to drive the first lever 30. In this case, the resistance is smaller. When the first lever 30 rotates until the connector 52 abuts against the drive surface 36, the elastic component 34 is switched to a state in which it applies a driving force to the first lever 30 to rotate in the first direction, to actively drive the first lever 30 to rotate, the first door hook 11 to move, and the door 200 to be closed. In this case, the damper generates a buffering force to reduce the door-closing noise. During the opening of the door, the first door hook 11 pulls the first lever 30 to rotate in the second direction, and the connector 52 rotates relative to the first drive arm 31 of the first lever 30. Therefore, a predetermined angle is formed between the connector 52 and the drive surface 36, and the hook 38 abuts against the connector 52 to prevent the angle from being too large and prevent the connector 52 from disengaging from the recess 37, and thus to ensure that the connector 52 is stably connected to the first lever 30.

For example, in some other exemplary embodiments, the door-closing buffer assembly 50 may include a buffer 51, which is a spring plate or a compression spring, and the door-closing buffer assembly 50 is formed as a buffer energy storage assembly. In some embodiments of the present disclosure, the spring plate has an end connected to the interlocking bracket 20 and another end abutting against the first lever 30, and the spring plate is elastically deformable to store energy.

During the closing of the door, the first lever 30 rotates in the second direction and squeezes another end of the spring plate, and therefore a bending degree of the spring plate increases and stores energy, which provides buffering and energy storage effects. During the opening of the door, the spring plate can release the stored energy to apply a driving force to the first lever 30 to rotate in the second direction, and therefore the first lever 30 can push the first door hook 11 and the door 200 to move in the door opening direction, which provides an effect in assisting the door opening. When the door is closed, a driving force of the spring plate acting on the first lever 30 directs towards a rotation center of the first lever 30 or near the rotation center of the first lever 30. In this case, the spring plate does not provide a component force in a rotation direction of the first lever 30 or only provides a smaller component force, ensuring that the door 200 can be tightly closed.

In some embodiments of the present disclosure, as shown in FIGS. 60 and 61, in an axial direction of the first lever 30, the connector 52 may be provided with an avoidance notch 521 for avoiding the first cooperation portion 45 at a side surface of the connector 52. By providing the avoidance notch 521, there is a gap between end surfaces of the connector 52 and the first cooperation portion 45 in the axial direction of the first lever 30. In this way, it is possible to ensure that during the rotation of the first lever 30, the connector 52 is prevented from contacting the first cooperation portion 45 to trigger the rotation of the second lever 40, and the disorder in the triggering sequence of the monitoring switch 201 and the micro switches is avoided.

An interlocking device 100 of a microwave oven 1000 according to some embodiments of the present disclosure will be described in detail below with reference to the accompanying drawings. It should be understood that the following description is merely illustrative and should not be construed as a limitation to the present disclosure.

As shown in FIGS. 1 and 39 to 77, the microwave oven 1000 according to some embodiments of the present disclosure includes a door 200, a body, and an interlocking device 100. The interlocking device 100 includes a first door hook 11, a second door hook 12, an interlocking bracket 20, a first baffle 25, a second baffle 26, a third baffle 27, a first lever 30, a second lever 40, a monitoring switch 201, a first micro switch 202, a second micro switch 203, an elastic component 34, a door-closing buffer assembly 50, a driver 53, and an inclined block 54.

As shown in FIGS. 18, 19, 36, and 37, the door 200 is rotatably mounted at the body about a vertical axis. The first door hook 11 and the second door hook 12 are fixed to the door 200, and the second door hook 12 is located above the first door hook 11. The interlocking bracket 20 is mounted at the body and includes a bracket body 22 and a cover 23 to define a mounting space 204. An avoidance recess 205 is formed at a side wall of the mounting space 204. The bracket body 22 includes a first baffle 25 partially blocking a communication opening between the avoidance recess 205 and the mounting space 204. In addition, as shown in FIGS. 53 to 59 and 69 to 73, a second baffle 26 and a third baffle 27 are disposed in the mounting space 204. The second baffle 26 is a slide-shaped plate body, and the third baffle 27 is a rectangular plate body.

As shown in FIGS. 53 to 55, FIGS. 58 and 59, and FIGS. 62 to 68, the first lever 30 and the second lever 40 are rotatably mounted in the mounting space 204. The first lever 30 includes a first drive arm 31, a second drive arm 32, and a fourth cooperation portion 33. The fourth cooperation portion 33 passes through a first through hole 231 of the cover 23. The second lever 40 includes a first rotary arm 41 provided with a first cooperation portion 45 and a second rotary arm 42 provided with a second cooperation portion 44 and a third cooperation portion 46. The second cooperation portion 44 passes through a second through hole 232 of the cover 23. Moreover, the second baffle 26 has an arc section located at a side of the second rotary arm 42 close to the first door hook 11 and a flat straight section located between a rotary shaft of the second lever 40 and the first door hook 11. The third baffle 27 is located at the side of the second rotary arm 42 close to the first door hook 11. In addition, the first rotary arm 41 is located in the avoidance recess 205, and the first cooperation portion 45 extends into the mounting space 204.

As shown in FIGS. 39, 42, 44, 46, 48, 51, and 52, the second micro switch 203 is disposed in the mounting space 204, and the monitoring switch 201 and the first micro switch 202 are disposed at a side of the cover 23 facing away from the bracket body 22. The bracket body 22 has a third through hole 221. The elastic component 34 is disposed at a side of the bracket body 22 facing away from the cover 23, and the first lever 30 is provided with a connection portion 35 passing through the third through hole 221 to be connected to the elastic component 34.

In addition, as shown in FIGS. 56, 57, and 38, the inclined block 54 may be vertically movably mounted at the bracket body 22, and two ends of the driver 53 respectively abut against the inclined block 54 and the bracket body 22 to apply an upward driving force to the inclined block 54.

As shown in FIGS. 1, 39 to 41, 56, 57, and 38, the first door hook 11 and the second door hook 12 are separated from the body when the door is opened. The driver 53 is configured to drive the inclined block 54 to be located at a high position. The first lever 30, under a pulling force of the elastic component 34, rotates clockwise to an extreme position where it abuts against an edge of the bracket body 22, and is disengaged from the monitoring switch 201; and the second lever 40 is positioned at a position where the second lever 40 is separated from the first micro switch 202 and the second micro switch 203.

As shown in FIGS. 6, 9, and 42 to 50, during the closing of the door, the door 200 is pushed to move the first door hook 11 and the second door hook 12 in the door-closing direction, i.e., backwards. The first door hook 11 moves in the door-closing direction under position limiting of the second baffle 26. A rear end of the first door hook 11 extends to a position between the first drive arm 31 and the second drive arm 32 and abuts against the first drive arm 31 to push the first lever 30 to rotate counterclockwise. When the first lever 30 rotates by a predetermined angle, a pulling force direction of the elastic component 34 is switched to drive the first lever 30 to rotate counterclockwise, allowing the second drive arm 32 of the first lever 30 to automatically pull the first door hook 11 to move backwards. Moreover, the connector 52 is in contact with the drive surface 36, and the drive surface 36 drives the connector 52 to move. The buffer 51 can provide a buffering effect. The first lever 30 rotates to enable the fourth cooperation portion 33 to trigger the monitoring switch 201. Then, the first door hook 11 moves to be in contact with the first cooperation portion 45 of the second lever 40, which can drive the second lever 40 to rotate clockwise. The first micro switch 202 and the second micro switch 203 are sequentially triggered by the second cooperation portion 44 and the third cooperation portion 46 of the second lever 40. During the closing of the door, as shown in FIGS. 56, 57, and 38, the second door hook 12 abuts against the inclined block 54, and the inclined block 54 compresses the driver 53 to move a hook portion of the second door hook 12 to a rear side of the inclined block 54. In this way, a position of the second door hook 12 is limited by the inclined block 54 to keep the door 200 closed.

As shown in FIG. 39, when the first lever 30 rotates to abut against the first limit portion 21, it stops rotating, and the second lever 40 stops rotating after triggering the second micro switch 203. In this case, the second drive arm 32 of the first lever 30 stops the first door hook 11 under the pulling force of the elastic component 34. Thus, the door 200 is kept closed, and the first lever 30 and the second lever 40 are kept in a position where the monitoring switch 201, the first micro switch 202, and the second micro switch 203 are activated.

During the opening of the door, as shown in FIGS. 6, 9, and 42 to 50, the door 200 rotates in an opposite direction to be opened, allowing the first door hook 11 to move forwards. During the movement, a stop force applied to the second lever 40 is removed first, and the second lever 40 rotates counterclockwise under a rebound force of the first micro switch 202 and the second micro switch 203 to release the triggering of the first micro switch 202 and the second micro switch 203. The first door hook 11 also abuts against the second drive arm 32 during the movement of the first door hook 11, to drive the first lever 30 to overcome the elastic force of the elastic component 34 and rotate clockwise, allowing the fourth cooperation portion 33 to release the triggering of the monitoring switch 201. When a direction of a pulling force of the elastic component 34 is switched to drive the first lever 30 to rotate clockwise, the first lever 30 automatically resets to a position where it abuts against a second limit portion 24 under the driving of the elastic component 34, and stays at this position, and the first lever 30 can drive the first door hook 11 to move forwards to allow the door 200 to bounce open. During the opening of the door, as shown in FIGS. 1, 56, 57, and 38, the second door hook 12 abuts against the inclined block 54 again, and the inclined block 54 compresses the driver 53 to move the hook portion of the second door hook 12 to a front side of the inclined block 54. In this way, the position limiting of the second door hook 12 by the inclined block 54 is released. As a result, the door 200 can be opened.

In summary, the first door hook 11 is engaged with the two levers to separately trigger the three switch components, and the three switch components are not in direct contact with the first door hook 11 and can be triggered in the order of the monitoring switch 201, the first micro switch 202, and the second micro switch 203. In this way, safety of the device is ensured. Moreover, the door-closing noise can be effectively reduced, and the microwave leakage when the door is opened can be reduced. As a result, the safety of using the microwave oven 1000 is ensured.

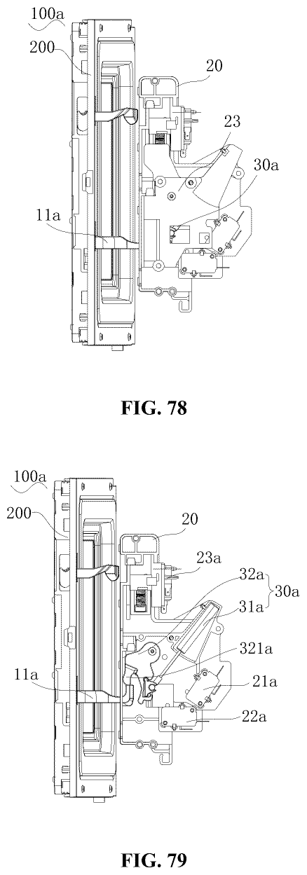

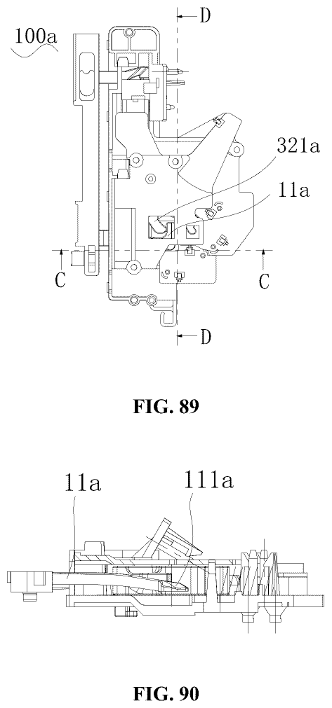

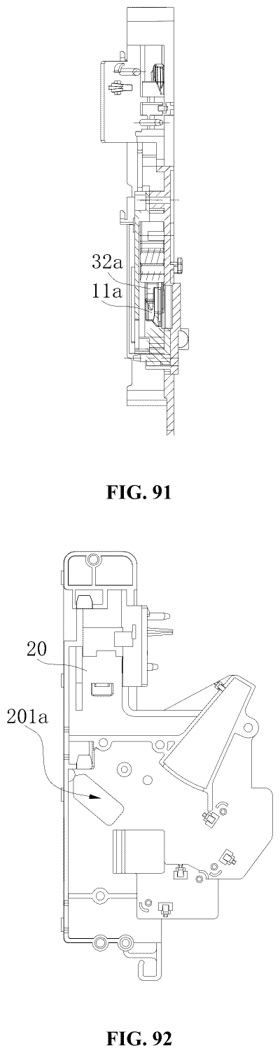

Referring to FIGS. 78 to 91, a household appliance 100a according to embodiments of the present disclosure includes a door 200, an interlocking bracket 20, and a damping assembly 30a. The door 200 has a door hook 11a, and the door hook 11a has a first inclined guide surface 111a at a tip of the door hook 11a. The door 200 is movably connected to the interlocking bracket 20. The damping assembly 30a is mounted at the interlocking bracket 20. The damping assembly 30a includes a damper 31a and a drive lever 32a. The drive lever 32a is rotatably connected to the interlocking bracket 20 and the damper 31a and includes a latching arm 321a. The latching arm 321a has a second inclined guide surface 322a at a side surface of the latching arm 321a. During closing of the door 200, the first inclined guide surface 111a is cooperatively connected to the second inclined guide surface 322a, allowing the latching arm 321a to be latched to the door hook 11a after the tip of the door hook 11a bypasses the latching arm 321a.

In the above-described household appliance 100a, the first inclined guide surface 111a is cooperatively connected to the second inclined guide surface 322a during the closing of the door 200, allowing the latching arm 321a to be latched to the door hook 11a after the tip of the door hook 11a bypasses the latching arm 321a. In this way, a forced door-closing structure design is realized. When the drive lever 32a is abnormally triggered, it is not necessary to disassemble the machine for maintenance, and the user can manually force the door closed to restore normal operation of the household appliance 100a.

The household appliance 100a includes but is not limited to household appliances with doors 200, such as microwave ovens, ovens (including electric ovens, microwave-steam-and-bake all-in-one ovens), steamers, dishwashers, and disinfection cabinets. The household appliance 100a is taken as an example of a microwave oven for illustration in the embodiments of the present disclosure, which is intended to facilitate an understanding of the implementation of the present disclosure and should not be construed as a limitation of the present disclosure.

In some embodiments of the present disclosure, the household appliance 100a includes a door 200, which may be a double-glazed door and may also be a leak-proof glazed door. One of the benefits of using the glazed door is that it is convenient for the user to observe food inside the household appliance 100a from outside. In addition, the door 200 may be provided with a handle on an outer surface of the door 200 to facilitate the user to open and close the door.

A material of the door hook 11a may be selected from a metallic material or a plastic material. The door hook 11a is elongated as a whole and is provided with a hook-shaped portion at the tip of the door hook 11a, and the hook-shaped portion can be easily engaged. The door hook 11a includes a first inclined guide surface 111a, and the first inclined guide surface 111a may be provided at the hook-shaped portion. In this way, it is convenient for the user to force the door closed. As a result, the door hook 11a and the drive lever 32a are returned to their normal engagement position.

The interlocking bracket 20 may be rotatably connected to the door 200, and the household appliance 100a may include a cavity (not shown in the drawings). The interlocking bracket 20 may be fixed to the cavity, and the door 200 is rotatably connected to the cavity. The cavity is provided with a chamber. The chamber has an opening at a front side of the chamber. The door 200 is configured to close and open the opening. To-be-heated food may be placed in the chamber. The damping assembly 30a is mounted at the interlocking bracket 20. The drive lever 32a may be rotatably connected to the interlocking bracket 20 by a rotary shaft of the interlocking bracket 20. The damper 31a may be a linear damper. It can be understood that in other embodiments, the damper 31a may also be other dampers, such as a rotary damper, which is not limited herein. The drive lever 32a is connected to the damper 31a, and the damper 31a can decelerate the drive lever 32a during a movement of the drive lever 32a, thereby extending service life of the drive lever 32a and the door hook 11a.

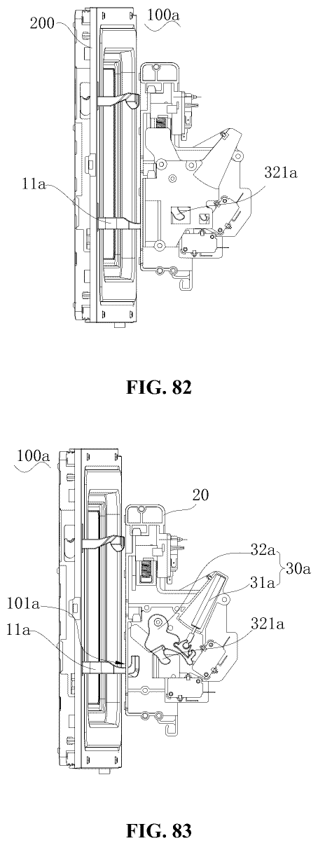

Under normal circumstances, with a predetermined initial speed, the door hook 11a is in contact with the drive lever 32a and cause the drive lever 32a to rotate. Therefore, an electrical switch is triggered after the drive lever 32a rotates, and the latching arm 321a of the drive lever 32a is latched to the door hook 11a. In this way, the door hook 11a can be engaged with the drive lever 32a to realize the door-closing state. However, in real life, it is easy for the users or children to use abnormal means to force the drive lever to be triggered (as shown in FIGS. 82 and 83). For example, children use bamboo sticks, fingers, etc. to reach into the interlocking bracket to toggle the drive lever, forcing the drive lever to be triggered, and causing the drive lever to rotate. In this way, the door hook cannot be engaged with the drive lever. As a result, the door cannot be closed, which in turn leads to the microwave oven losing its use function and even requiring disassembling for repair. In the household appliance 100a according to the embodiments of the present disclosure, the door hook 11a has a first inclined guide surface 111a at a tip of the door hook 11a, and the drive lever 32a includes a second inclined guide surface 322a. The first inclined guide surface 111a is cooperatively connected to the second inclined guide surface 322a, allowing the latching arm 321a to be latched to the door hook 11a after the tip of the door hook 11a bypasses the latching arm 321a. The user can use a large force to restore the normal engagement relationship between the door hook 11a and the drive lever 32a without the disassembling for the repair.

In some embodiments, the first inclined guide surface 111a is parallel to the second inclined guide surface 322a.

In this way, when the first inclined guide surface 111a is in contact with the second inclined guide surface 322a, a contact area between the first inclined guide surface 111a and the second inclined guide surface 322a is large, which can realize a stable engagement relationship.

In some embodiments of the present disclosure, materials of the door hook 11a and the drive lever 32a may both be plastic materials with large elastic deformation properties. In this way, in a case of forced door-closing where the user uses a very large force to close the door, the door hook 11a can be bent and deformed, and the first inclined guide surface 111a of the door hook 11a moves along the second inclined guide surface 322a and quickly bypasses the latching arm 321a of the drive lever 32a. As a result, the tip of the door hook 11a is inserted into the drive lever 32a, and the door hook 11a is positioned at a position after the door is normally closed. The first inclined guide surface 111a can allow the door hook 11a to be thinner and is in an arc shape, which is easy to bypass the latching arm 321a. In some embodiments, the first inclined guide surface 111a has an angle, which can facilitate the insertion of the drive lever 32a and the tip of the door hook 11a to bypass the latching arm 321a. The first inclined guide surface 111a is parallel to the second inclined guide surface 322a, which can increase the contact area between the first inclined guide surface 111a and the second inclined guide surface 322a. In this way, the first inclined guide surface 111a and the second inclined guide surface 322a are less likely to break during the forced closing of the door. As a result, the engagement relationship between the door hook 11a and the drive lever 32a is more stable.

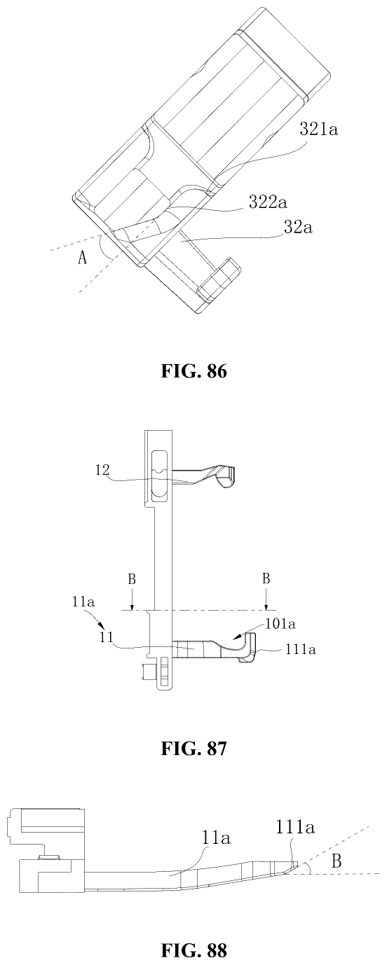

Referring to FIGS. 86 and 88, it can be seen from FIG. 86 that the drive lever 32a includes the second inclined guide surface 322a having an angle A. Further, it can be seen from FIG. 88 that the door hook 11a includes the first inclined guide surface 111a having an angle B. In some embodiments, the angle A may be the same as the angle B. Therefore, the first inclined guide surface 111a is parallel to the second inclined guide surface 322a. Thus, the tip of the door hook 11a can easily bypass the latching arm 321a.

In some embodiments, the side surface of the latching arm 321a having the second inclined guide surface 322a faces towards the interlocking bracket 20.

In this way, it is convenient for the tip of the door hook 11a to bypass the latching arm 321a from a rear side through the second inclined guide surface 322a.

In some embodiments of the present disclosure, the second inclined guide surface 322a and the latching arm 321a are integrally formed, and the second inclined guide surface 322a may be injection molded. The side surface of the latching arm 321a having the second inclined guide surface 322a faces towards the interlocking bracket 20. In this way, in the case of the forced closing of the door, the tip of the door hook 11a can bypass the latching arm 321a from the side surface of the latching arm 321a having the second inclined guide surface 322a. In some embodiments, an end of the latching arm 321a close to the door 200 is a rear end of the latching arm 321a, and an end of the latching arm 321a facing away from the door 200 is a front end of the latching arm 321a. The side surface of the latching arm 321a having the second inclined guide surface 322a faces towards the interlocking bracket 20. In the case of the forced closing of the door, the first inclined guide surface 111a of the door hook 11a abuts against the second inclined guide surface 322a, and the tip of the door hook 11a passes through the second inclined guide surface 322a of the latching arm 321a from the rear end of the latching arm 32 and is inserted into the front end of the latching arm 32. In this way, the door hook 11a and the drive lever 32a can restore their normal engagement relationship. As a result, the household appliance 100a is in its normal door-closing state. In some embodiments, the tip of the door hook 11a may also bypass the latching arm 321a from the front end of the latching arm 32 and then is inserted into the latching arm 32, which is not limited herein.

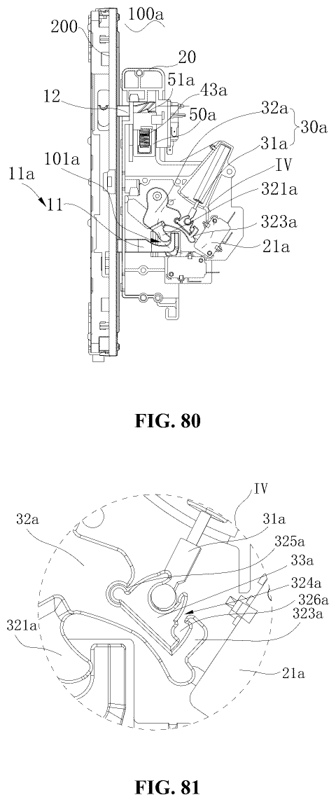

Referring to FIGS. 80, 83, and 87, in some embodiments, the door hook 11a has a depression 101a. A part of the latching arm 321a is located in the depression 101a when the latching arm 321a is latched to the door hook 11a.

In this way, stability of the engagement between the door hook 11a and the drive lever 32a can be realized.

In some embodiments of the present disclosure, a part of the latching arm 321a is located in the depression 101a when the door is closed. The latching arm 321a may partially penetrate into the depression 101a, which can allow the latching arm 321a to be more deeply engaged with the door hook 11a. In this way, the stable closing of the door can be realized.

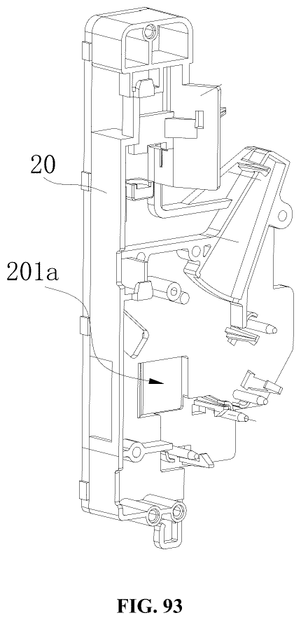

Referring to FIGS. 92 and 93, in some embodiments, the interlocking bracket 20 has a bracket groove 201a. A position of the bracket groove 201a corresponds to a position of the second inclined guide surface 322a.

In this way, the bracket groove 201a can ensure a movement space of the door hook 11a and the drive lever 32a in the case of the forced closing of the door.

In some embodiments of the present disclosure, the position of the bracket groove 201a corresponds to the position of the second inclined guide surface 322a. In this way, in the case of the forced closing of the door, the tip of the door hook 11a bypasses the drive lever 32a by using the cooperation between the first inclined guide surface 111a and the second inclined guide surface 322a, and the bracket groove 201a increases the movement space of the door hook 11a and the drive lever 32a to ensure that the forced closing of the door is completed smoothly.

Referring to FIGS. 80 and 81, in some embodiments, the drive lever 32a further includes a trigger arm 323a spaced apart from the latching arm 321a, a micro switch 21a is mounted at the interlocking bracket 20, and the micro switch 21a is triggered by the trigger arm 323a when the door 200 is closed in place.

In this way, the micro switch 21a can be triggered by the trigger arm 323a.

In some embodiments, the household appliance 100a is a microwave oven, and the micro switch 21a is a primary switch configured to control a microwave function of the household appliance 100a. The household appliance 100a further includes a monitoring switch 22a and a secondary switch 23a. The monitoring switch 22a is configured to monitor an entire loop of the microwave oven, and the secondary switch 23a is configured to control opening of a light, a cooling fan, or other assemblies. When the user uses the microwave oven, a triggering sequence of the three switches is particularly important. During closing of the door, the triggering sequence should be as follows: the monitoring switch 22a is first triggered, then the secondary switch 23a, and finally the primary switch. In this way, the user's use safety can be guaranteed. During opening of the door, the triggering sequence should be as follows: the primary switch is first triggered, then the secondary switch 23a, and finally the monitoring switch 22a. In this way, the user's use safety can be guaranteed. The door hook 11a includes a second door hook 12 and a first door hook 11. When the door 200 is closed in place, the second door hook 12 directly abuts against the secondary switch 23a to trigger the secondary switch 23a, and the first door hook 11 directly abuts against the monitoring switch 22a to trigger the monitoring switch 22a, and the first door hook 11 triggers the primary switch (the micro switch 21a) through the trigger arm 323a. In this way, the monitoring switch 22a, the secondary switch 23a, and the primary switch are sequentially triggered to avoid a problem of a disorder in the triggering sequence of the switches.

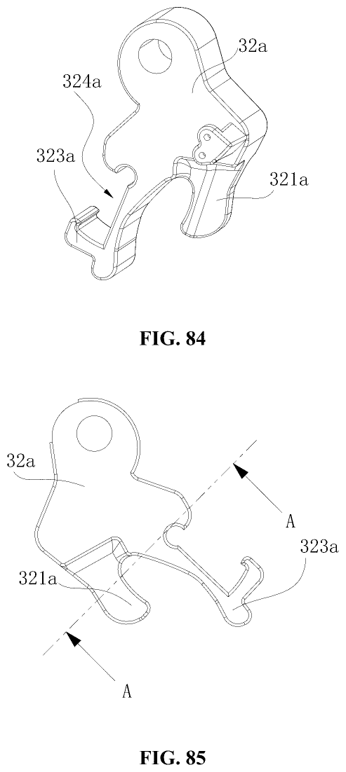

Referring again to FIGS. 81 and 84, in some embodiments, the trigger arm 323a has a receiving groove 324a. The receiving groove 324a has a rotation space 325a formed at a top of the receiving groove 324a and a swinging space 326a formed at a bottom of the receiving groove 324a. The damping assembly 30a includes a swing block 33a. The swing block 33a has an end rotatably received in the rotation space 325a and another end received in the swinging space 326a. The swinging space 326a is configured to provide a space for rotation of the drive lever 32a. The damper 31a is rotatably connected to the swing block 33a.

In this way, the trigger arm 323a can drive the swing block 33a to rotate after rotating by a predetermined angle.

In some embodiments of the present disclosure, the trigger arm 323a has a receiving groove 324a. The receiving groove 324a includes a rotation space 325a formed at a top of the receiving groove 324a, and the rotation space 325a can receive a top of the swing block 33a. In some embodiments, the rotation space 325a is roughly in a cylindrical shape, and the top of the swing block 33a is in a cylindrical shape matching with the rotation space 325a. The receiving groove 324a includes a swing space 326a at a bottom of the receiving groove 324a, and another end of the swing block 33a is received in the swing space 326a. The swing space 326a is configured to provide a space for rotation of the trigger arm 323a at a predetermined angle.

By providing the swing space 326a, the trigger arm 323a cannot act on the swing block 33a when it just starts to rotate, and thus cannot compress the damper 31a. Therefore, the door hook 11a cannot be affected by resistance of the damper 31a in an early stage of abutting against the trigger arm 323a, which would otherwise result in rebound or even stagnation. A size of the swing space 326a may determine a size of the predetermined angle, which may be calibrated based on actual conditions.

In some embodiments of the present disclosure, the drive lever 32a includes a trigger arm 323a and a latching arm 321a that are spaced apart from each other. The trigger arm 323a has a receiving groove 324a. The door hook 11a passes under the latching arm 321a and abuts against the trigger arm 323a when the door hook 11a moves towards the drive lever 32a to drive the drive lever 32a to rotate. In this way, after the door hook 11a drives the drive lever 32a to rotate, the latching arm 321a can hook the door hook 11a to drive the door hook 11a to close the door.

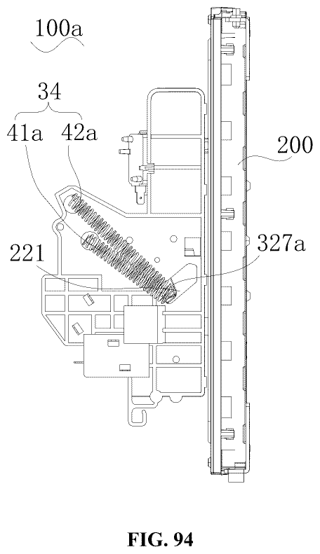

Referring to FIG. 94, in some embodiments, the damping assembly 30a includes an elastic component 34. The elastic component 34 and the drive lever 32a are respectively located at two opposite sides of the interlocking bracket 20. The interlocking bracket 20 has a third through hole 221. The drive lever 32a is connected to the elastic component 34 through the third through hole 221. The elastic component 34 is configured to drive the drive lever 32a to accelerate its rotation to allow the drive lever 32a to drive the door 200 to accelerate.

In this way, a process of first accelerating and then decelerating the door hook 11a can be realized.

In some embodiments of the present disclosure, the elastic component 34 and the drive lever 32a respectively located at the two opposite sides of the interlocking bracket 20 can allow the relevant structural components to be arranged separately to avoid too many structural components at one side of the interlocking bracket 20, which would otherwise lead to space reduction and excessive weight concentration. As a result, it is not conducive to a configuration of the structural components.

The elastic component 34 can provide a pulling force to the drive lever 32a to allow the drive lever 32a to drive the door hook 11a to accelerate, and can also provide a thrust force to the drive lever 32a to allow the drive lever 32a to drive the door hook 11a to accelerate.

Since the drive lever 32a can drive the door hook 11a to accelerate, the door 200 can be closed by relying on the force acting on the drive lever 32a during the acceleration stage. During the acceleration of the door hook 11a, the damper 31a is compressed after the drive lever 32a rotates by a predetermined angle. During a continuation of the door-closing, the damper 31a is continuously compressed by the swing block 33a, and a damping force provided by the damper 31a increases as a compression amount of the damper 31a increases. When the damping force provided by the damper 31a is greater than a driving force provided by the drive lever 32a, the door hook 11a starts to decelerate. Therefore, in the deceleration stage, noise when the door 200 is closed is not too loud. In some embodiments of the present disclosure, when the damper 31a is compressed, it can rotate in conjunction with a rotation manner of a rotary component and the swing block 33a, allowing the door hook 11a to enter the cavity more smoothly.

In some embodiments shown in FIG. 78, a cover 23 is further mounted at the interlocking bracket 20 and has a receiving space. The cover 23 may be mounted at the interlocking bracket 20 through screw fixation, interference fit, welding, snap-fit, etc. In some embodiments shown in FIG. 78, the cover 23 is mounted at the interlocking bracket 20 through snap-fit.

Referring to FIG. 94 again, in some embodiments, the elastic component 34 includes a first elastic member 41a and a second elastic member 42a. The drive lever 32a is provided with a connection structure 327a. The first elastic member 41a and the second elastic member 42a are both connected to the connection structure 327a. An acute angle is formed between the first elastic member 41a and the second elastic member 42a.

In this way, the drive lever 32a is driven by a combined force of the first elastic member 41a and the second elastic member 42a.

In some embodiments of the present disclosure, during the rotation of the drive lever 32a, one of the two elastic components may be stretched longer and another one of the two elastic components may be compressed. A combined force generated by the two elastic components changes slightly during driving the drive lever 32a to rotate. In this way, it is possible for the drive lever 32a to exert a relatively large resisting force on the door hook 11a even when the door 200 is closed in place, allowing the door 200 to be closed more tightly.

In one example, the first elastic member 41a and the second elastic member 42a may both be tension springs. The first elastic member 41a is located above the second elastic member 42a. A positioning post of the interlocking bracket 20 is hooked by an end of the first elastic member 41a, and the connection structure 327a is hooked by another end of the first 115332-5417-US 71 elastic member 41a. Another positioning post of the interlocking bracket 20 is hooked by an end of the second elastic member 42a, and the connection structure 327a is hooked by another end of the second elastic member 42a. An acute angle is formed between the first elastic member 41a and the second elastic member 42a, which may be 30 degrees, 35 degrees, 40 degrees, etc., and is not specifically limited herein.

Referring to FIG. 80 again, in some embodiments, the door hook 11a includes a second door hook 12 and a first door hook 11. The first door hook 11 has the first inclined guide surface 111a at a tip of the first door hook 11. The household appliance 100a includes an inclined block 50a and a third elastic member 43a that are mounted at the interlocking bracket 20. The third elastic member 43a abuts against a bottom of the inclined block 50a. The inclined block 50a has a third inclined guide surface 51a at a top of the inclined block 50a. The third inclined guide surface 51a is inclined upwards towards an interior of the interlocking bracket 20 along a vertical plane. A tip of the second door hook 12 abuts against the third inclined guide surface 51a during the closing of the door 200 to allow the inclined block 50a to descend and compress the third elastic member 43a. The inclined block 50a is latched to the second door hook 12 under an action of the third elastic member 43a when the tip of the second door hook 12 extends across the third inclined guide surface 51a.

In this way, a tight closing of the door can be achieved for the household appliance 100a through the engagement between the second door hook 12 and the inclined block 50a and the engagement between the first door hook 11 and the drive lever 32a.

In some embodiments of the present disclosure, the door 200 includes two door hooks 11a, namely, the second door hook 12 and the first door hook 11. In some embodiments, the door 200 may also include a plurality of door hooks to assist in opening and closing the door. The number of door hooks may be set based on actual conditions. For example, the number of door hooks may be 3, 4, or more than 4, which is not limited herein.

In some embodiments of the present disclosure, the top of the inclined block 50a is the third inclined guide surface 51a, and the third inclined guide surface 51a is inclined upwards towards the inside of the interlocking bracket 20 along the vertical surface. It can also be understood that an end of the inclined block 50a close to the second door hook 12 has a smaller height than an end of the inclined block 50a facing away from the second door hook 12. The third inclined guide surface 51a is an inclined plane with a predetermined angle, and the second door hook 12 can move to a position above the plane from a position below the plane.

The third elastic member 43a includes a compression spring. The second door hook 12 exerts a force on the inclined block 50a during the closing of the door 200, allowing the third elastic member 43a to be constantly in a compressed state. After the door 200 is closed, the third elastic member 43a is stretched, and the inclined block 50a moves upwards under the action of the third elastic member 43a. The end of the inclined block 50a facing away from the second door hook 12 can be latched to the second door hook 12. It is worth mentioning that a force used to open the door and a force used to close the door are different when the user opens and closes the door. The force to open the door is usually greater than the force to close the door. The user can use a relatively large force to directly pull the second door hook 12 out of an end of the inclined block 50a, and therefore the inclined block 50a is no longer latched to the second door hook 12. In this way, the door opening structure can be simplified, and the door can be closed tightly.

Other compositions and operations of the microwave oven 1000 and the household appliance 100a according to the embodiments of the present disclosure are known to those of ordinary skill in the art, and will not be described in detail herein.

In the description of the embodiments of the present disclosure, unless specified or limited otherwise, the technical terms “mounted”, “connected”, and “coupled” are understood broadly, such as fixed, detachable mountings, connections and couplings or integrated, and may be mechanical or electrical mountings, connections and couplings, and also may be direct and via media indirect mountings, connections, and couplings, and further may be inner mountings, connections and couplings of two components or interaction relations between two components. For those skilled in the art, the specific meaning of the above-mentioned terms in the embodiments of the present disclosure may be understood according to specific circumstances.

Reference throughout this specification to “an embodiment”, “a specific embodiment”, or “an example” means that a particular feature, structure, material, or characteristic described in connection with the embodiment or example is included in at least one embodiment or example of the present disclosure. The schematic representations of the above terms do not necessarily refer to the same embodiment or example. Moreover, the described specific features, structures, materials or characteristics may be combined in any one or more embodiments or examples in a suitable manner.

Although embodiments of the present disclosure have been illustrated and described, it is conceivable for those of ordinary skill in the art that various changes, modifications, replacements, and variations can be made to these embodiments without departing from the principles and spirit of the present disclosure. The scope of the present disclosure shall be defined by the claims as appended and their equivalents.

What is claimed is:

1. An interlocking device for a microwave oven, the interlocking device comprising:
a first door hook;
an interlocking bracket provided with a plurality of switch components;
a first lever mounted at the interlocking bracket, an avoidance gap being formed between the first lever and the interlocking bracket, and the first lever being rotatable to trigger at least one of the plurality of switch components;
a second lever mounted at the interlocking bracket and located at a rear side of the first lever in a door-closing direction, the second lever being rotatable to trigger at least one of the plurality of switch components; and
a shielding component provided at the avoidance gap, the shielding component being movable between a first position where the avoidance gap is shielded by the shielding component and a second position where the avoidance gap is exposed, wherein:
the shielding component is positioned at the first position when a door is opened; and
the shielding component is adapted to move to the second position during a movement of the first door hook in the door-closing direction, allowing the first door hook to sequentially drive the first lever and the second lever to rotate.

2. The interlocking device according to claim 1, wherein:
the interlocking bracket has a first guide groove, the first guide groove at least partially extending away from the second lever in the door-closing direction; and
the shielding component comprises:
a shielding block configured to shield the avoidance gap; and
a guide block connected to the shielding block and movably disposed in the first guide groove.

3. The interlocking device according to claim 2, wherein:
the first lever has a second guide groove, the shielding block being movably disposed in the second guide groove; and
the first door hook is adapted to abut against at least one of the first lever and the shielding block to drive the first lever to rotate and/or the shielding component to move towards the second position.

4. The interlocking device according to claim 2, wherein the first guide groove comprises:
a first horizontal groove section;
a second horizontal groove section; and
an inclined groove section connecting the first horizontal groove section with the second horizontal groove section, the first horizontal groove section being located at a side of the second horizontal groove section close to the second lever, wherein:
the guide block is positioned in the first horizontal groove section when the door is opened; and
the guide block is positioned in the second horizontal groove section when the door is closed.

5. The interlocking device according to claim 1, wherein the first lever comprises a first drive arm and a second drive arm, wherein:
the second drive arm is located at a side of the first drive arm facing away from the second lever in the door-closing direction;
the first door hook is adapted to abut against the first drive arm to drive the first lever to rotate; and
the avoidance gap is formed between the first drive arm and the interlocking bracket.

6. The interlocking device according to claim 5, wherein the shielding component is movably disposed at the first drive arm in a length direction of the first drive arm.

7. The interlocking device according to claim 5, wherein a predetermined gap is formed between the second drive arm and the interlocking bracket in a state where the at least one of the plurality of switch components is triggered by the first lever, allowing the first door hook to move to a position between the first drive arm and the second drive arm through the predetermined gap.

8. The interlocking device according to claim 1, wherein the second lever comprises:
a first cooperation portion, the first door hook being adapted to abut against the first cooperation portion to drive the second lever to rotate; and
at least one second cooperation portion configured to trigger at least one of the plurality of switch components,
wherein in the door-closing direction, the second cooperation portion is positioned at a side of the first cooperation portion facing away from the first lever, and the shielding component is positioned at a side of the first cooperation portion close to the first lever.

9. The interlocking device according to claim 8, wherein:
the second lever further comprises:
a first rotary arm provided with the first cooperation portion; and
a second rotary arm provided with the second cooperation portion; and
the interlocking bracket has a mounting space, wherein an avoidance recess is formed at a side wall of the mounting space, the first rotary arm being located in the avoidance recess, the first cooperation portion extending into the mounting space, and the first door hook being adapted to extend into the mounting space.

10. The interlocking device according to claim 9, wherein the interlocking bracket comprises a first baffle partially blocking a communication opening between the avoidance recess and the mounting space.

11. The interlocking device according to claim 9, wherein the interlocking bracket has a mounting space, the second rotary arm being located in the mounting space, a second baffle being disposed in the mounting space, and at least part of the second baffle extending in the door-closing direction and being located between a rotary shaft of the second lever and the first door hook.

12. The interlocking device according to claim 9, wherein the interlocking bracket has a mounting space, the second rotary arm being located in the mounting space, and a third baffle being disposed in the mounting space and located at a side of the second rotary arm close to the first door hook.

13. An interlocking device for a microwave oven, the interlocking device comprising:
a first door hook;
an interlocking bracket provided with a switch component;
a first lever rotatably mounted at the interlocking bracket and configured to trigger the switch component by rotating about a rotation axis of the first lever in a first direction, the first lever comprising a first drive arm and a second drive arm that are arranged in an opposite direction to the first direction,
wherein a predetermined gap is formed between the second drive arm and the interlocking bracket in a state where the switch component is triggered by the first lever, allowing the first door hook to move to a position between the first drive arm and the second drive arm through the predetermined gap.

14. The interlocking device according to claim 13, wherein the interlocking bracket has a mounting space, the first drive arm and the second drive arm being located in the mounting space, and the predetermined gap being formed between at least one side of the second drive arm along the rotation axis of the first lever and an inner wall of the mounting space.

15. The interlocking device according to claim 14, wherein along the rotation axis of the first lever, the second drive arm has a thinned region on at least one side surface of the second drive arm, the predetermined gap being formed between the thinned region and the inner wall of the mounting space.

16. The interlocking device according to claim 15, wherein the thinned region has an inclined surface facing towards the inner wall of the mounting space, the inclined surface extending towards the inner wall of the mounting space in a door-closing movement direction of the first door hook.

17. The interlocking device according to claim 16, wherein an end of the first door hook has a thickness gradually decreasing in the door-closing movement direction of the first door hook.

18. The interlocking device according to claim 17, wherein the first door hook has an inclined side surface facing towards the second drive arm in a thickness direction of the first door hook, the inclined side surface extending away from the second drive arm in the door-closing movement direction of the first door hook.

19. The interlocking device according to claim 13, wherein at least one of the first door hook and the second drive arm is made of plastic.

20. The interlocking device according to claim 13, wherein:
the switch component comprises a first micro switch, a second micro switch, and a monitoring switch; and
the interlocking device further comprises a second lever rotatably mounted at the interlocking bracket, wherein the second lever comprises a first rotary arm provided with a first cooperation portion and a second rotary arm provided with a second cooperation portion and a third cooperation portion, the first rotary arm and the second rotary arm being sequentially arranged around a rotation axis of the second lever in a second direction,
wherein the first door hook is adapted to move in a door-closing direction to abut against the first drive arm to drive the first lever to rotate in the first direction and trigger the monitoring switch, and then abut against the first cooperation portion and drive the second lever to rotate in the second direction, allowing the third cooperation portion to trigger the second micro switch after the first micro switch is triggered by the second cooperation portion.
